(19) United States
(12) Patent Application Publication
(10) Pub. No.: US 2015/0312693 A1
(43) Pub. Date: Oct. 29, 2015

(54) PHASE-UNIFIED LOUDSPEAKERS: SERIES CROSSOVERS

(71) Applicant: William E. Collins, Swansea, IL (US)

(72) Inventor: William E. Collins, Swansea, IL (US)

(21) Appl. No.: 14/259,593

(22) Filed: Apr. 23, 2014

(51) Int. Cl. H04S 7/00

(52) U.S. Cl. CPC H04S 7/30; H04S 2400/01

(57) ABSTRACT

Complimentary series crossover circuits to reduce phase distortion in loudspeaker groups, typically pairs, are described. In the fundamental embodiment, each loudspeaker possesses two drivers, a woofer and a tweeter. The “effective third-order” crossover on the right-hand loudspeaker remains “symmetric,” but the “effective third-order” crossover on the left-hand loudspeaker is rendered “asymmetric,” as described. Other embodiments apply this principle to higher crossover orders and greater numbers of drivers. This technology is applied to the series filter in 2.5-way, 3.5-way, etc. loudspeakers using otherwise conventional series/parallel crossovers. This technology can be combined with other circuits like a Zobel, typically used for impedance correction. Some configurations of “phase-unified” loudspeakers require that a Zobel is applied to all drivers except the tweeter. Accordingly a rule combining effective crossover order and handedness is established.

### BACKGROUND OF THE INVENTION

1. Field of the Invention

The present invention relates to complimentary series crossover circuits to reduce phase distortion in loudspeaker groups.

2. Brief Description of the Prior Art

Illustrative prior art crossover designs are disclosed in U.S. Pat. No. 3,457,370 to Boner, U.S. Pat. No. 4,031,321 to Bakgaard, U.S. Pat. No. 4,198,540 to Cizek, U.S. Pat. No. 4,897,879 to Geluk, U.S. Pat. No. 5,937,072 to Combest and U.S. Pat. No. 6,381,334 to Alexander, who has had more than one patent granted concerning series crossovers. Additional background information is found in High Performance Loudspeakers, sixth ed., Martin Colloms, Wiley, 2005 and Loudspeaker Design Handbook, seventh ed., Vance Dickason, Amateur Audio Press, 2006.

The series loudspeaker crossover sounds better than the more popular and versatile parallel loudspeaker crossover. A loudspeaker with a series crossover is more dynamic and has a more seamless response between drivers than a loudspeaker with a parallel crossover. A series crossover circuit is better balanced reactively and makes the load seen by the amplifier more resistive to allow for greater power transfer during the dynamic moments in music. A loudspeaker with a series crossover also has superior transient response. Drivers crossed over with a series circuit stay more in phase, providing sharper leading edges and more transient attack. Moreover a series crossover stabilizes the active impedance of drivers at the crossover point so that they share power more predictably and increase the Doppler effect.

Parallel crossovers are often more expensive than their series counterparts. The main crossover elements in parallel crossovers are applied in series to their respective drivers so that these elements are directly in the signal path and necessitate exceptional quality. For instance, a capacitor of the highest quality for loudspeaker applications can cost several hundred dollars or more. Many loudspeaker designers feel that the capacitor in series with the tweeter is the single most important element in the entire crossover. An inductor of the highest quality for loudspeaker applications can cost a hundred dollars, given the high current cost of copper. Accordingly a high quality capacitor and inductor can cost as much as a decent bookshelf loudspeaker. In contrast, the main crossover elements in series crossovers are applied in parallel with their respective drivers so that these elements are not in the signal path and often need not be of exceptional quality.

Previous loudspeaker design typically fails to account for the prospective interference effects between the two speakers, one on the left and the other on the right, comprising stereo sound reproduction. These two combine to form a “loudspeaker system,” which also includes, but is not limited to, a quadraphonic or stereo system. Since the output of these speakers combine to produce a stereo image, interference is likely. To demonstrate this concept simply, two-way loudspeakers will be used. In addition to the interference and phase effects between the woofer and tweeter in either loudspeaker system for the right or left channels, interference and phase effects are possible between the right tweeter and the left woofer as well as between the left tweeter and the right woofer. These concepts can be extended to sound reproduction in more than two channels like quadraphonic reproduction or home theater. The discussion of phase and interference in loudspeaker design can seem abstruse though these effects are quite audible.

The human ear hears sounds ranging from 20 Hz to 20,000 Hz. Accordingly loudspeakers systems capable of full-range sound reproduction are in demand in the audio market. Multiple drivers are used to extend the frequency response and power handling of a loudspeaker system with each driver reproducing specific frequencies. Thus a loudspeaker system can have woofers, tweeters and midranges, with tweeters reproducing higher frequencies, woofers reproducing lower frequencies and midranges reproducing the frequencies in between. A woofer, midwoofer, midrange, upper midrange, tweeter or supertweeter can be called a “driver”. The typical two-way loudspeaker has a woofer or tweeter for drivers. Accordingly a 2.5-way loudspeaker is a modern design with a woofer, midwoofer and tweeter. Modern designs can use a midwoofer and a tweeter, but for the sake of simplicity, this will also be referred to as a woofer and a tweeter henceforward unless otherwise noted. A three-way loudspeaker has a woofer, midrange and tweeter. Each of the drivers is selected because it performs best in a specific portion of the frequency spectrum, and a crossover circuit is applied to tailor driver response in this portion. The crossover accomplishes this typically by attenuating driver response where undesired.

The overwhelming majority of crossover circuits connect the drivers in parallel, but the present art refers to crossover circuits connecting the drivers in series. Accordingly subsequent references to crossover circuits or crossovers refer to series circuits unless otherwise stated. The simplest series crossover, 1^{st} order electrical, nonetheless possesses a quasisecond order aspect that protects drivers from overload more than parallel crossover circuits that are 1^{st} order electrical. Drivers connected in series in a loudspeaker system diminish some interference and phase effects. The applicant will define the nouns “crossover network,” “crossover circuit,” or “crossover,” as referring to the network apportioning the different frequency bands of the input signal to the different drivers for the entire loudspeaker. The noun “crossover filter,” or “filter” refers to the smaller network apportioning the given frequency band of the input signal to the single driver in the entire loudspeaker.

The frequency at which an audio crossover circuit delivers signals to two drivers operating in adjacent frequency ranges is called the crossover frequency. A crossover circuit attenuates the response of a driver at the crossover frequency at a rate called the crossover slope. Crossover slopes are calculated in dB of attenuation per octave, with steeper slopes displaying more attenuation. Slope steepness is primarily determined by the number of capacitors and inductors used. For example, passive crossover circuits in two-way loudspeaker systems having crossover slopes of 6 dB/octave generally have one inductor L or capacitor C for each filter in the circuit. These circuits are called 1^{st} order electrical crossovers. In these circuits, a capacitor is connected in parallel with the woofer and an inductor is connected in parallel with the tweeter typically. The quasisecond order nature of such a circuit occurs because the drivers are connected in series so that each crossover element acts on each driver to some extent. In other words, every element in the crossover loads every other element, increasing the number of variables and the difficulty in implementing series crossovers successfully. This challenge nonetheless produces a filter that attenuates response at a maximum slope approaching 12 dB/octave as frequency moves farther away from the crossover point.

Crossover slopes of 12 dB/octave in two-way loudspeaker systems generally have a one L and one C for each filter in the crossover circuit, to total two inductors and two capacitors in the circuit. The latter crossover circuits are called 2^{nd} order electrical or half-section networks, but have a quasithird order nature. Driver polarity can depend on the placement of the crossover elements. A transformer can be incorporated into series crossover networks to increase slopes to at least 2^{nd} order though there are 2^{nd}, 3^{rd} and 4^{th}, etc. order electrical series crossover topologies using traditional crossover elements.

Drivers without a filter applied nevertheless roll off frequencies with characteristic slopes. The typical woofer rolls off high frequencies at approximately 12 dB/octave and the typical tweeter reaches full output at approximately 6 dB/octave from resonance, characteristics that are used in the determination of “effective” crossover orders, which refer to the slope of the roll off in frequency response that a driver filtered by a crossover circuit actually displays. This is distinguished from the slope of the filter in an electrical crossover circuit.

Loudspeaker drivers nonetheless reproduce waves, and simultaneous reproduction from more than one driver at a given frequency produces interference effects. When two drivers of different size and shape are mounted on a conventional planar baffle, the depths of these drivers differ so that the fronts of these drivers' voice coils lie in different planes. For instance, a tweeter cone is typically significantly shallower than a woofer cone. Accordingly when a tweeter and woofer reproduce the same frequency, the distances of the corresponding sound waves to the listener's ear differ, inducing interference. A crossover circuit reduces these interference effects, but introduces its own interference effects. A crossover circuit between a woofer and a tweeter rolls the woofer response off at the crossover frequency, but gradually increases the tweeter response as the crossover frequency is approached. The woofer and tweeter responses at the crossover frequency are therefore out-of-phase to some extent. At frequencies at which the crossed over woofer and tweeter responses overlap substantially, these responses are also out-of-phase to some extent.

Interference effects sound unpleasant. Boner's original crossovers were 2^{nd} order electrical parallel and accordingly introduced anomalies in frequency response whether the drivers were connected in-phase or out-of-phase, a deficiency characteristic of even—order electrical crossovers. Out-of-phase 2^{nd} order electrical crossovers reproduce the human voice with a nasal quality to many listeners, inaccurate reproduction often encountered with other anomalies like excessively low mechanical damping factor. Accordingly he introduced impedance-correction networks into these circuits. Most, if not all, series crossover circuits and approaches can include impedance-compensation circuits to smooth impedance and improve phase behavior. These circuits can be applied across individual drivers as appropriate or across an entire loudspeaker.

Techniques have been proposed to improve the frequency response and phase behavior of loudspeaker systems. The interference effects between multiple drivers can be conveyed as a pair of drivers operating in-phase or out-of-phase. The more drivers there are in a given loudspeaker, the more possible driver pairs exist and consequently the more out-of-phase responses are possible. An example of a loudspeaker configuration diminishing untoward phase effects is the d'Appolito configuration in which a specific driver configuration on the mounting baffle combined with a specific crossover type are applied. Polar response figures reveal the benefits of the popular d'Appolito configuration. However, driver and crossover configurations can be varied to some extent to yield nonetheless the characteristic d'Appolito phase behavior. Alternatively a loudspeaker can be configured with a stepped baffle so that the drivers are time-aligned. This configuration often reproduces more three-dimensional stereo images than conventional configurations. Another loudspeaker configuration diminishing untoward phase effects is the line array, in which a loudspeaker contains many drivers, tweeters as well as midranges and woofers, to reproduce stabler stereo images than conventional configurations.

Circuits with approximately infinite crossover slopes can also be used, typically applying many sequential crossover sections to each driver in a system. Interference between drivers in a consecutive pair is reduced because there is little overlap in their frequency response. These systems can be enhanced by coupling adjacent inductors to increase slopes at diminished cost though the sheer number of crossover elements in these systems can be considered expensive. Furthermore active crossovers can be used, but often at greater expense.

One can compare loudspeaker systems, one form of transducer, to other transducers to disclose additional deficient approaches. For instance, a cassette deck is a transducer that transforms magnetic energy into electrical energy, but is notorious for deficient high frequency response, a limitation that can be remedied by using configurations for noise reduction like Dolby. Dolby noise reduction disassembles and reassembles the input signal, but is nonetheless audible, often making instruments, e.g. piano, that produce a wide range of frequencies sound phasey or like they are in a can. Phasey reproduction reveals the limitations of “cut-and-paste” algorithms like Dolby. Accuracy in the disassembly and reassembly of the input signal is paramount, but not guaranteed. Some modern loudspeaker crossover designs similarly tamper with the input signal.

It should be mentioned that loudspeakers for the two channels in a home stereo system nonetheless operate in parallel so that the use of parallel crossovers produces a parallel effect overall. The same does not hold for series crossovers. Loudspeakers for the two channels in a home stereo system still operate in parallel if series crossovers are used, but produce a series/parallel effect overall. The present art exploits the latter effect in virtually phase-unified loudspeakers, which use series/parallel crossovers.

The present art reduces phase and interference effects in sound reproduction and moderates lobing error between the loudspeakers comprising a loudspeaker system. The vertical polar response of a loudspeaker reveals lobe structure. Loudspeakers reproduce a spectrum of frequencies and lobe structure strongly depends on frequency. An increase in crossover order decreases driver overlap and thus lobing error, henceforth abbreviated as “lobing”. Lobing nonetheless remains at high crossover orders. Moreover the lobe structures of the loudspeakers comprising a loudspeaker system interact.

The present invention typically applies to the prior art of paired loudspeakers using crossover circuits. It is an object of the present invention to reduce phase distortion and reduce interference effects compared to prior art series crossovers and the like.

Another object of the present invention is to incorporate the concept of symmetry complemented by asymmetry for effective crossover orders in a pair of stereo loudspeakers to reduce phase distortion without significantly increasing cost.

A further object of the present invention is to incorporate the concept of handedness to distinguish effective odd-numbered crossover orders from effective even-numbered crossover orders and from prior art. This concept is also used in conjunction with specified polarity.

A still further object of the present invention is to apply phase-unified technology to series/parallel crossovers.

### SUMMARY OF THE INVENTION

The vertical polar response (VPR) of the present embodiment reveals coupling between the two loudspeakers as compared to a pair of loudspeakers in the prior art. If the respective loudspeakers for the right and left channels have the same lobe structure, there is lobing and possible interference between the channels. If the respective loudspeakers for the right and left channels have complimentary lobe structures, lobing and possible interference between the channels is reduced and possibly eliminated. This reduction would occur regardless of crossover order though lobing depends on such. For instance, as crossover order increases, driver overlap and thus lobing decrease. However a phase angle remains between two drivers that are crossed over because the response of one driver rises while the response of the other driver falls at the crossover frequency and adjacent frequencies.

Below the baffle step frequency ν_{b}, reproduction becomes omnidirectional and lobing decreases so that the vertical polar response approaches a perfect sphere. The tweeter dominates reproduction in the upper two octaves so that VPR approaches a perfect hemisphere. However reproduction near ν_{b} lobes substantially. Therefore selecting a crossover frequency near ν_{b} optimizes phase-unification, as will be discussed below.

The effective third-order crossover on the right-hand loudspeaker remains symmetric, but the effective third-order crossover on the left-hand loudspeaker is rendered asymmetric in an example of the present art, as described. However, the loudspeaker system is only part of a stereo system reproducing, or producing, sound. A receiver, integrated amplifier or separate components combined to function as such applies a full frequency spectrum of audio signals across the input of a loudspeaker. A power supply, such as an integrated amplifier or the like, amplifies audio signals from an audio signal source, such as a compact disc player or other digital source. The preferred audio crossover circuit passes audio signals from an audio signal source to each loudspeaker in a loudspeaker group, typically a pair, to reduce phase distortion. This crossover circuit includes more than one filter and those skilled in the art will appreciate that a plurality of filter networks may be provided for a plurality of drivers. A resistor R can be appropriately applied to each driver so that the frequency response of each loudspeaker is approximately flat. In this example, each loudspeaker possesses two drivers, a woofer and a tweeter. The two drivers are connected out-of-phase and the negative terminal of the tweeter is connected to the negative terminal of the power supply for each channel. Ordinarily it is of little consequence if drivers crossed over in series are connected in-phase or out-of-phase. The applicant, however, has determined that phase-unified loudspeakers with series crossovers rely on a series crossover element applied to a given driver via the connection between out-of-phase drivers, a feature the drawings demonstrate.

As previously mentioned, the typical woofer rolls off high frequencies at approximately 12 dB/octave and the typical tweeter rolls off low frequencies at approximately 6 dB/octave from resonance. Accordingly if a 1^{st} order electrical filter is applied to the right-hand woofer, then the total attenuation is

−6 dB-12 dB

and the woofer effectively rolls off at 18 dB/octave, an effective third-order filter. Furthermore if a 2^{nd} order electrical filter is applied to the tweeter in the right-hand loudspeaker, then the total attenuation on the right-hand tweeter is

−12 dB-6 dB

and the tweeter also effectively rolls off at 18 dB/octave. Such a woofer and tweeter are filtered with a symmetric effective third-order crossover because the effective crossover slopes are the same for the two drivers. A symmetric effective third-order crossover can also be called a third-order acoustic crossover, but the latter notation will not be used in this application. In a two-way loudspeaker, a “symmetric” “effective n^{th} order” crossover has the higher order electrical crossover filter applied to the tweeter.

However the effective third-order crossover on the left-hand loudspeaker is rendered asymmetric. If a 2^{nd} order electrical filter is applied to the left-hand side (LHS) woofer, then the total attenuation is

−12 dB-12 dB

and the woofer effectively rolls off at 24 dB/octave. If nevertheless a 1^{st} order electrical crossover is applied to the LHS tweeter, then the total attenuation is

−6 dB-6 dB

and the tweeter effectively rolls off at 12 dB/octave. Accordingly this is an asymmetric effective third-order crossover because the effective crossover slopes for the two drivers differ. In a two-way loudspeaker, an asymmetric “effective n^{th} order” crossover has the higher order electrical crossover filter applied to the woofer. However the average attenuation for the two drivers in the left-hand loudspeaker is

(12+24)dB/2

or 18 db/octave, the same as the right-hand loudspeaker and also effective third-order.

Other embodiments apply this principle to higher crossover orders and greater numbers of drivers. For example, in a loudspeaker system that possesses three drivers, a woofer, a midrange and a tweeter, the effective third-order crossover on the right-hand loudspeaker remains symmetric, and the effective third-order crossover on the left-hand loudspeaker remains asymmetric, as previously described. Accordingly a rule combining effective crossover order and handedness is established. Odd effective crossover orders possess symmetry in the right-hand loudspeaker system ordinarily.

Even effective crossover orders however ordinarily possess symmetry in the left-hand loudspeaker system. For example, in a loudspeaker system that possesses two drivers, a woofer and a tweeter, the effective fourth-order crossover on the right-hand loudspeaker is rendered asymmetric, as described, but the effective fourth-order crossover on the left-hand loudspeaker is now symmetric. In this example like the previous example, the two drivers are connected out-of-phase and the negative terminal of the tweeter is connected to the negative terminal of the power supply for each channel. Accordingly if a 2^{nd} order electrical filter is applied to the left-hand woofer, then the total attenuation is

−12 dB-12 dB

and the woofer effectively rolls off at 24 dB/octave, an effective fourth-order filter. If nevertheless a 3^{rd} order electrical filter is applied to the LHS tweeter, then the total attenuation is

−6 dB-18 dB

and the tweeter also effectively rolls off at 24 dB/octave. Such a woofer and tweeter are filtered with a symmetric effective fourth-order crossover and roll off with the same effective slope. In addition, if a 3^{rd} order electrical filter is applied to the right-hand-side (RHS) woofer, then the total attenuation is

−18 dB-12 dB

and the woofer effectively rolls off at 30 dB/octave. Furthermore if a 2^{nd} order electrical filter is applied to the tweeter in the RHS loudspeaker, then the total attenuation is

−12 dB-6 dB

and the tweeter effectively rolls off at 18 dB/octave. The effective fourth-order crossover on the right-hand loudspeaker is rendered asymmetric, as previously described, where the average attenuation for two drivers in the RHS loudspeaker is

(30+18)dB/2

or 24 db/octave, the same as the left-hand loudspeaker and also effective fourth-order. Again, in a two-way loudspeaker, an asymmetric “effective n^{th} order” crossover has the higher order electrical crossover filter applied to the woofer. There can be some discussion of whether or not, unfiltered woofers typically rolloff high frequencies at 12 dB/octave and unfiltered tweeters typically rolloff low frequencies at 6 dB/octave. For instance, unfiltered woofers could possibly typically rolloff high frequencies at 18 dB/octave and unfiltered tweeters typically rolloff low frequencies at 12 dB/octave. This discussion is not indulged because the salient feature used to phase-unify loudspeakers is that unfiltered woofers typically rolloff high frequencies at a slope that is 6 dB/octave steeper than the slope at which unfiltered tweeters typically rolloff low frequencies.

This technology can be combined with other circuits. For instance, an RL circuit can be applied in series to a woofer typically in front of the crossover proper to attenuate the baffle step that increases woofer response as the reproduced wavelength approaches the width of the loudspeaker baffle. Such circuits are popular with higher order crossovers.

This technology can also be combined with auxiliary circuits. For instance, a Zobel is a circuit typically used for impedance correction on a woofer or midrange. Woofers, midwoofers, midranges and upper midranges display a rise in impedance and a reduction in output as frequency increases. The voice coils for these drivers are ordinarily large enough to exhibit substantial inductance. Furthermore these drivers are heavier and slower than tweeters and subject to cone breakup modes as frequency increases. A Zobel flattens the impedance and smooths the rolloff of these drivers as frequency increases. A Zobel circuit thus thwarts the peakiness in falling woofer response that cone-breakup modes cause. A Zobel can also be called a phase-correction circuit and consists of a resistor in series with a C, with the Zobel applied in parallel with the driver of interest. The values of the Zobel resistor and capacitor, henceforward designated by R_{z} and C_{z} respectively, are given by

R_{z}=1.25R, (1)

C_{z}=Lₑ/R_{z}² (2)

where Rₑ is the DC resistance of a given driver and Lₑ is the inductance of the driver's voice coil. The values chosen for R_{z} and C_{z} should equal or exceed the values calculated from eqs. (1) and (2) respectively.

Many configurations of phase-unified loudspeakers require that a Zobel is applied to all drivers except the tweeter. Many series crossover networks already do so because nearly all crossover elements in series crossovers act to some extent on all drivers. The figures that follow use RC Zobel circuits though presumably LCR circuits, typically applied to tweeters, will also work, where appropriate. LCR circuits can be rendered in parallel or in series to form notch filters that tame output peaks or resonant peaks in impedance. Circuits to correct the baffle step can also be used and are popular with higher order crossovers.

Active crossover networks and those applying digital signal processing can be combined with passive crossover networks to realize the present invention. Below shows how to phase-unify loudspeakers virtually using active crossovers and the capacitors, resistors, op amps and power amplifiers therein. Active crossovers can be more awkward for loudspeaker design because they typically use three or more elements to substitute for one L or C in a passive crossover. However, somewhat analogous to parallel crossovers, sequential sections can be added to increase the order of active crossover networks. One can use this principle to develop higher effective orders in active crossovers.

Sometimes the present invention improves reproduction considerably when only applied to one crossover frequency in a loudspeaker system with more than two drivers. This simplification is made more effective when the present invention is applied to a crossover frequency in the range of about 500 to 2000 Hz, a frequency range corresponding to typical frequencies for the baffle step. The value of the baffle-step frequency depends upon the geometry and dimensions of the loudspeaker enclosure and can be calculated for a wide variety of such with software such as “Edge”. The value of ν_{b} decreases as the enclosure width increases for a rectangular parallelepiped enclosure. For example ν_{b} is 1125 Hz if such an enclosure is 11″ wide, but increases to 1500 Hz if this enclosure is 9″ wide. A crossover frequency in the range of about 500 to 2000 Hz is recommended to phase-unify two-way loudspeakers with a rectangular parallelepiped enclosure of typical dimensions.

Phase-unified loudspeakers have approximately the same crossover frequency. However properly designed crossovers tailor the crossover frequency and type of circuit to the different drivers in the loudspeaker. Technically a crossover frequency is the frequency at which the frequency response of a driver reproducing lower frequencies intersects the frequency response of a driver reproducing higher frequencies when the drivers' output curves are plotted on a figure for frequency response. Crossover equations often do not designate such a crossover frequency, but designate ν_{f}, the frequency at which the output of a given driver is ordinarily reduced 3 dB. Accordingly ν_{f} for the woofer in a two-way loudspeaker system might differ from ν_{f} for the tweeter in this system, with the crossover frequency for the entire system ordinarily falling somewhere in between. Investigations have demonstrated that two octaves constitutes the largest difference between each crossover frequency for the RHS and LHS loudspeakers to maximize phase-unification. Another name for ν_{f} is the filter frequency.

A number of embodiments accordingly give pairs of loudspeaker systems of various sizes and crossover designs to render smoother polar response which can reduce phase effects to improve imaging and reproduction significantly. These principles can also be applied to devices such as stereo headphones which use more than one driver per channel and cross these drivers over with series circuits, open-air headphones in particular. Such headphones can be considered as simply a pair of miniature loudspeakers. Phase-unified loudspeakers work in conjunction with subwoofers because subwoofers operate and are crossed over in the frequency range where output is omnidirectional.

### BRIEF DESCRIPTION OF THE DRAWINGS

Numerous other objects, features and advantages of the invention should now become apparent upon a reading of the following detailed description taken in conjunction with the accompanying drawings, in which:

FIG. 1 shows a 1^{st} order crossover circuit for a two-way loudspeaker system in accordance with the prior art;

FIG. 2 shows a 2^{nd} order crossover circuit for a two-way loudspeaker system in accordance with the prior art;

FIG. 3 shows a 3^{rd} order crossover circuit for a two-way loudspeaker system in accordance with the prior art;

FIG. 4 shows a 4^{th} order crossover circuit for a two-way loudspeaker system in accordance with the prior art;

FIG. 5 shows the effective third-order crossover circuit for a two-way loudspeaker system in accordance with the prior art;

FIG. 6 shows the effective third-order crossover circuit for a two-way loudspeaker system, in accordance with the first alternative embodiment of the present invention. Note that the negative terminal of the tweeter is connected to the negative terminal of the power supply;

FIG. 7 shows the effective third-order crossover circuit for a two-way loudspeaker system, with a Zobel circuit applied to the woofer, in accordance with the preferred embodiment of the present invention;

FIG. 8 shows the effective third-order crossover circuit for a two-way loudspeaker system, with a Zobel circuit and a notch filter applied to the woofer, in accordance with the second alternative embodiment of the present invention;

FIG. 9 shows the effective third-order crossover circuit for a two-way loudspeaker system, with a modified Zobel circuit using higher values of resistance and capacitance to damp the entire woofer subdivision applied to the left-hand-side woofer, in accordance with the third alternative embodiment of the present invention;

FIG. 10 shows the effective third-order crossover circuit for a two-way loudspeaker system, with a Zobel circuit applied to the woofer and a twister circuit applied across both drivers, in accordance with the fourth alternative embodiment of the present invention;

FIG. 11 shows the effective third-order crossover circuit for a two-way loudspeaker system, with a Zobel circuit applied to the woofer, but increasing the capacitor in parallel with the woofers and placing a suitable resistor in series with this capacitor to correct for the baffle step, in accordance with the fifth alternative embodiment of the present invention;

FIG. 12 shows an equivalent effective third-order crossover circuit for a two-way loudspeaker system, with a Zobel circuit applied to the woofer, in accordance with the sixth alternative embodiment of the present invention. Note that the handedness of the electrical crossover circuits has been switched compared to FIGS. 6-11 because the positive terminal of the tweeter is connected to the negative terminal of the power supply;

FIG. 13 shows the effective fourth-order crossover circuit for a two-way loudspeaker system;

FIG. 14 shows the effective fourth-order crossover circuit for a two-way loudspeaker system, in accordance with the seventh alternative embodiment of the present invention. Note that the negative terminal of the tweeter is connected to the negative terminal of the power supply. Also note that the handedness of the electrical crossover circuits has been switched compared to FIG. 13 because the crossover is even-ordered;

FIG. 15 shows the effective fourth-order crossover circuit for a two-way loudspeaker system, with a Zobel circuit applied to the woofer, in accordance with the eighth alternative embodiment of the present invention;

FIG. 16 shows the effective fourth-order crossover circuit for a two-way loudspeaker system, with a Zobel circuit applied to the woofer. Any shunt capacitor or inductor is connected in series to an attenuating resistor before being placed parallel to any driver, in accordance with the ninth alternative embodiment of the present invention;

FIG. 17 shows the effective fourth-order crossover circuit for a two-way loudspeaker system, with a Zobel circuit applied to the woofer, but increasing the capacitor in parallel with the woofers and placing a suitable resistor in series with this capacitor to correct for the baffle step, in accordance with the tenth alternative embodiment of the present invention;

FIG. 18 shows an effective fifth-order crossover circuit for a two-way loudspeaker system in accordance with the prior art;

FIG. 19 shows shows the effective fifth-order crossover circuit for a two-way loudspeaker system, in accordance with the eleventh alternative embodiment of the present invention. Note that the negative terminal of the tweeter is connected to the negative terminal of the power supply;

FIG. 20 shows an equivalent effective fifth-order crossover circuit for a two-way loudspeaker system, with a Zobel circuit applied to the woofer, in accordance with the twelfth alternative embodiment of the present invention;

FIG. 21 shows the effective fifth-order crossover circuit for a two-way loudspeaker system, noting that a Zobel circuit is applied to the right-hand-side (RHS) woofer. A modified Zobel circuit is applied to the left-hand-side (LHS) woofer. Furthermore a larger value is used on the 1^{st} shunt capacitor, which is damped with a suitable resistor, applied to each woofer, all to correct the baffle step, in accordance with the thirteenth alternative embodiment of the present invention;

FIG. 22 shows an equivalent effective second-order crossover circuit for a two-way loudspeaker system, in accordance with prior art. Note that the negative terminal of the tweeter is connected to the negative terminal of the power supply;

FIG. 23 shows an equivalent effective second-order crossover circuit for a two-way loudspeaker system, with a Zobel circuit applied to the RHS woofer. A larger capacitor replaces C_{z} on the LHS woofer to correct for the baffle step, in accordance with the fourteenth alternative embodiment of the present invention;

FIG. 24 shows an equivalent effective second-order crossover circuit for a two-way loudspeaker system, with a modified Zobel circuit applied to the RHS woofer. A larger capacitor replaces C_{z} on the LHS woofer to correct for the baffle step, in accordance with the fifteenth alternative embodiment of the present invention;

FIG. 25 shows a 1^{st} order crossover circuit for a three-way loudspeaker system in accordance with the prior art;

FIG. 26 shows a 2^{nd} order crossover circuit for a three-way loudspeaker system in accordance with the prior art;

FIG. 27 shows the effective third-order crossover circuit for a three-way loudspeaker system, in accordance with the prior art;

FIG. 28 shows the effective third-order crossover circuit for a three-way loudspeaker system, in accordance with the sixteenth alternative embodiment of the present invention. Note that the negative terminal of the tweeter is connected to the negative terminal of the power supply;

FIG. 29 shows the effective third-order crossover circuit for a three-way loudspeaker system, with Zobel circuits applied to the midrange and to the woofer, in accordance with the seventeenth alternative embodiment of the present invention;

FIG. 30 shows an equivalent effective third-order crossover circuit for a three-way loudspeaker system, with Zobel circuits applied to the midrange and woofer, in accordance with the eighteenth alternative embodiment of the present invention. Note that the handedness of the electrical crossover circuits has been switched compared to FIG. 24 or 25 because the positive terminal of the tweeter is connected to the negative terminal of the power supply;

FIG. 31 shows the effective third-order crossover circuit for a three-way loudspeaker system, with the crossover between the woofer and midrange in accordance with present invention to constitute the nineteenth alternative embodiment thereof. The crossover between either midrange and tweeter is in accordance with prior art, here 1^{st} order electrical for the sake of simplicity. Note that the negative terminal of the tweeter is connected to the negative terminal of the power supply;

FIG. 32 shows the effective third-order crossover circuit for a three-way loudspeaker system, with the crossover between the woofer and midrange in accordance with present invention to constitute the twentieth alternative embodiment thereof. A Zobel circuit is applied to each woofer. The crossover between either midrange and tweeter is in accordance with prior art, here 1^{st} order electrical for the sake of simplicity;

FIG. 33 shows the effective third-order crossover circuit for a three-way loudspeaker system, with the crossover between the midrange and tweeter in accordance with present invention to constitute the twenty-first alternative embodiment thereof. Zobel circuits are applied to the midrange and woofer. The crossover between either midrange and tweeter is in accordance with prior art, here 1^{st} order electrical for the sake of simplicity;

FIG. 34 shows the effective third-order crossover circuit for a three-way loudspeaker system, with the crossover between the midrange and tweeter in accordance with present invention to constitute the twenty-second alternative embodiment thereof. Note that the handedness of the electrical crossover circuits has been switched compared to FIGS. 31-33 because the positive terminal of the tweeter is connected to the negative terminal of the power supply. Zobel circuits are applied to the midrange and woofer. The crossover between either midrange and tweeter is in accordance with prior art, here 1^{st} order electrical for the sake of simplicity;

FIG. 35 shows an effective third-order crossover circuit for a series/parallel 2.5-way loudspeaker system in accordance with the prior art;

FIG. 36 shows the effective third-order crossover circuit for a series/parallel 2.5-way loudspeaker system, in accordance with the twenty-third alternative embodiment of the present invention;

FIG. 37 shows the effective third-order crossover circuit for a 2.5-way loudspeaker system, with a Zobel circuit applied to the midwoofer, in accordance with the twenty-fourth alternative embodiment of the present invention;

FIG. 38 shows the effective third-order crossover circuit for a two-way loudspeaker system with the same prospective drivers as the 2.5 way in FIGS. 35-37, in accordance with the first alternative embodiment of the present invention;

FIG. 39 shows the effective third-order crossover circuit for a two-way loudspeaker system with the same prospective drivers as the 2.5 way in FIGS. 35-37, in accordance with the third alternative embodiment of the present invention. Accordingly Zobel circuits are applied to the entire woofer subdivision for either loudspeaker as described;

FIG. 40 shows the effective third-order crossover circuit for a three-way loudspeaker system, with the crossover between the woofer and midrange in accordance with present invention to constitute the twenty-fifth alternative embodiment thereof. A Zobel circuit is applied to each woofer. The crossover between either midrange and tweeter is in accordance with prior art, here 1^{st} order electrical for the sake of simplicity. Note that an active crossover is applied to the tweeter;

FIG. 41 shows the effective third-order crossover circuit for a three-way loudspeaker system, with the crossover between the midrange and tweeter in accordance with present invention to constitute the twenty-sixth alternative embodiment thereof. Zobel circuits are applied to the midrange and woofer. The crossover between either midrange and tweeter is in accordance with prior art, here 1^{st} order electrical for the sake of simplicity. Note that an active crossover is applied to the tweeter;

FIG. 42 defines the driver subunits constituting the typical line-array loudspeaker. Driver subunit LA C consists of 4 identical drivers, but driver subunit LA D consists of 9 identical drivers;

FIG. 43 shows the effective third-order crossover circuit for a two-way line-array loudspeaker system, in accordance with the twenty-seventh alternative embodiment of the present invention. Note that the negative terminal of the tweeter is connected to the negative terminal of the power supply;

FIG. 44 shows the effective third-order crossover circuit for a two-way line-array loudspeaker system, with a Zobel circuit applied to the woofer, in accordance with the twenty-eighth alternative embodiment of the present invention;

FIG. 45 shows the effective fourth-order crossover circuit for a two-way line-array loudspeaker system, in accordance with the twenty-ninth alternative embodiment of the present invention. Note that the negative terminal of the tweeter is connected to the negative terminal of the power supply;

FIG. 46 shows the effective third-order crossover circuit for a two-way line-array loudspeaker system, in accordance with the thirtieth alternative embodiment of the present invention. Note that the driver subunits are connected in parallel. Also note that the negative terminal of the tweeter is connected to the negative terminal of the power supply;

FIG. 47 shows the effective third-order crossover circuit for a two-way line-array loudspeaker system, with a Zobel circuit applied to the woofer, in accordance with the thirty-first alternative embodiment of the present invention. Note that the driver subunits are connected in parallel;

FIG. 48 shows the effective fourth-order crossover circuit for a two-way line-array loudspeaker system, in accordance with the thirty-second alternative embodiment of the present invention. Note that the driver subunits are connected in parallel. Also note that the negative terminal of the tweeter is connected to the negative terminal of the power supply;

FIG. 49 shows the vertical polar response for a two-way loudspeaker with a 1^{st} order electrical crossover and either normal or reverse polarity (reproduced from prior art, Loudspeaker Design Cookbook, 2006);

FIG. 50 shows the vertical polar response at ν_{b} for a two-way loudspeaker with an effective third-order crossover according to the present invention. The RHS crossover is symmetric (solid line), but the LHS crossover is asymmetric (dotted line);

FIG. 51 shows the vertical polar response at ν_{b} for a two-way loudspeaker with an effective fourth-order crossover according to the present invention. The RHS crossover is asymmetric (dashed line), but the LHS crossover is symmetric (solid line); and

FIG. 52 shows the vertical polar response at ν_{b} for a two-way loudspeaker with an effective second-order crossover according to the present invention. The RHS crossover is asymmetric (dashed line), but the LHS crossover is symmetric (solid line).

### DETAILED DESCRIPTION

Two-Way Phase-Unified Loudspeakers with Passive Crossovers

Phase-unified loudspeakers with series crossovers, which will henceforth be abbreviated to “series phase-unified loudspeakers,” include, but are not restricted to stereophonic, home theater and quadraphonic loudspeaker systems. It is assumed that the same loudspeaker configuration is used for both loudspeakers comprising a stereo system of series phase-unified loudspeakers, a definition extending to include drivers that are stereo imaged. Furthermore each loudspeaker has two or more drivers, including at least one driver reproducing lower frequencies and at least one driver reproducing higher frequencies. Ordinarily each loudspeaker in the pair would also possess the same cabinet, bass loading, drivers, for which a definite polarity is selected; the same crossover; and the same loudspeaker configuration. All drivers for a given loudspeaker are connected out-of-phase unless otherwise noted. Also it is understood that the right channel of the integrated amplifier or the like is connected to the RHS loudspeaker and the left channel of the integrated amplifier or the like is connected to the LHS loudspeaker, a condition more for clarification than for phase-unification.

Not only are a woofer, midwoofer, midrange, upper midrange or tweeter each called a driver, there are many types of each driver. For instance, tweeters include, but are not limited to electrostatic, cone, ribbon and dome tweeters. There are soft dome tweeters and hard dome tweeters. Soft dome tweeters include, but are not limited to tweeters with cloth or polymer domes while hard dome tweeters are often coated with metals like aluminum, beryllium or titanium. There are soft dome midranges and hard dome midranges. There are midranges with paper, polymer or metal cones. Cone-breakup modes sound particularly harsh for the latter. Some of these midranges can be used as midwoofers. There are even diamond-coated tweeters and midranges. Woofers include, but are not limited to woofers with paper, polypropylene, Kevlar or metal cones. There are woofers with cones specially slitted via computer design to tame cone-breakup modes.

Loudspeaker drivers come in a variety of impedances, typically 4 to 16Ω. Power supplies ordinarily prefer to drive impedances of 4 to 8Ω although some amplifiers can drive loudspeakers with impedances as low as 2Ω. Loudspeakers with impedances over 16Ω significantly reduce the power that a power supply can provide to them. The impedance of a driver depends on frequency so that the impedance of a finished loudspeaker containing more than one driver also depends on frequency. In general, a loudspeaker with a series crossover prefers to use drivers closely matched in impedance.

Phase-unification does not depend on loudspeaker orientation, as long as all loudspeakers in a phase-unified system point towards the listener(s). Included in this definition is both loudspeakers comprise a pair that faces the same direction, a direction opposite the listener(s), situated midway between loudspeakers, but an appreciable distance from them. Some audiophiles prefer to “toe in” both loudspeakers slightly towards the listener(s) who are situated as before. The conventional orientation for a loudspeaker is the tweeter is at the top of the loudspeaker and the woofer is at the bottom although more esoteric loudspeaker configurations like d'Appolito or line arrays do not follow convention. For instance, if such a listener is 8 feet from the fronts of such conventionally oriented loudspeakers, it is suggested for substantial phase-unification that the listener's ears be approximately 1 foot above the tweeter axes. Pointing any loudspeaker in a loudspeaker system away from the listener(s) disrupts phase-unification appreciably.

Loudspeaker configurations include stereo-imaged, d'Appolito, time-aligned and line arrays. For instance, a pair of stereo-imaged loudspeakers typically place the tweeter of one loudspeaker toward an uppermost corner of the front baffle, but place the tweeter of the other loudspeaker so that at least its tweeter configuration is the stereo, or mirror, image of the first loudspeaker. The popular d'Appolito, or WTW, configuration is most often applied to a loudspeaker with two woofers and one tweeter. The woofers are placed towards the top and bottom of the front baffle and the tweeter is placed in between: namely WTW. Time-aligned configurations use a stepped, or sometimes sloped, front baffle and exploit the different physical configurations of different drivers. For example, a tweeter is smaller and shallower than a woofer typically. Accordingly when such a tweeter and woofer are mounted on a conventional planar front baffle, the front of the tweeter voice coil is in front of the front of the woofer voice coil: the two drivers are not time-aligned. Stepping the front baffle so that the fronts of the tweeter voice coil and woofer voice coil lie in the same plane time-aligns these drivers and the loudspeaker.

Typically line arrays contain a plurality of each driver and align each type of driver along the same vertical line. The plurality of each driver in a line array sustains the same, or similar, impedance as each individual driver. To accomplish this, each driver is connected in particular series-parallel arrangements, typically to total three or four drivers. For any configuration, a sensible layout of the drivers on the baffles is suggested.

In the present art, crossovers are calculated to produce reasonably flat frequency response for both loudspeakers constituting phase-unified loudspeakers in accordance with the prior art. Accordingly drivers connected in series typically have similar impedances, somewhat restricting the number of driver combinations suitable for a loudspeaker with a series crossover. For all embodiments, the crossover frequency(s) for the one channel approximately equal(s) that for other channels. The two loudspeakers in a phase-unified system have approximately the same crossover frequency within a two-octave range. The human ear hears over a 10-octave range so that crossover frequencies differing by one or two octaves are approximately equivalent. The present art phase-unifies loudspeaker reproduction irrespective of driver type, fabrication or impedance. The present art phase-unifies loudspeaker reproduction for different baffle configurations and combinations thereof.

Two-Way Phase-Unified Loudspeakers with Passive Crossovers

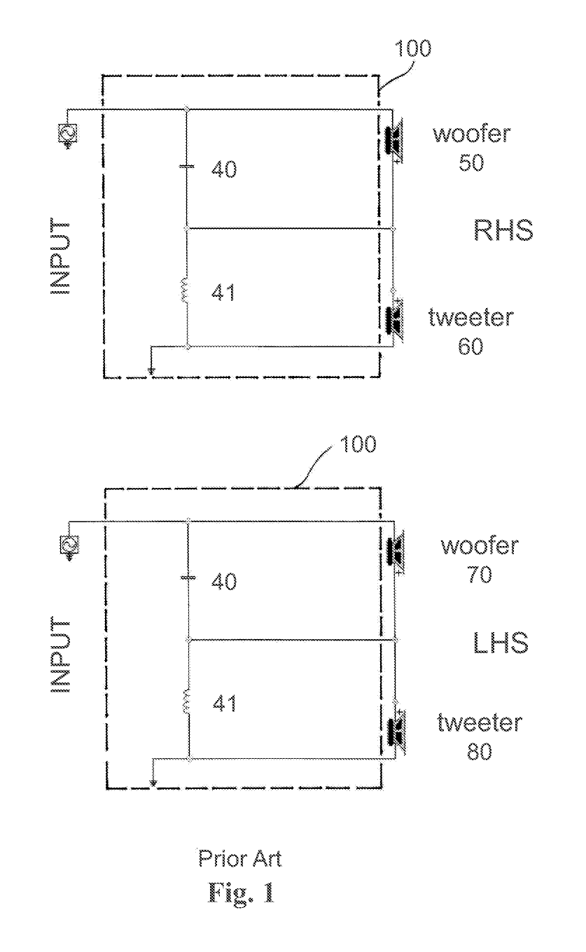

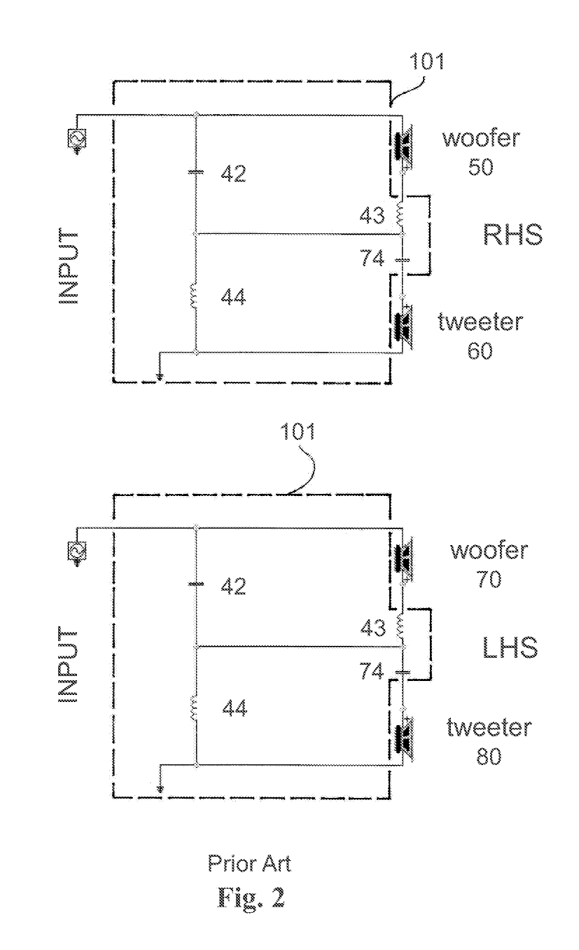

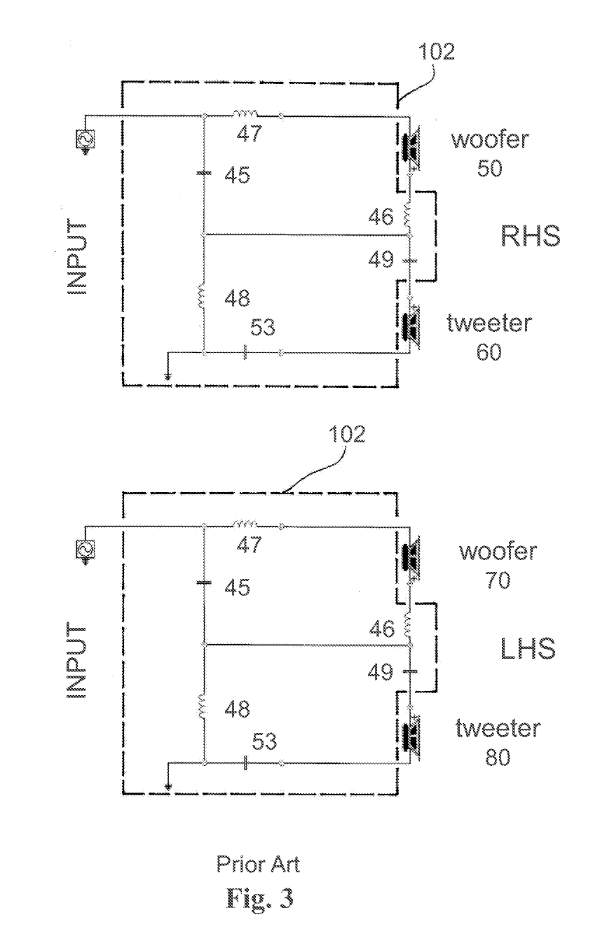

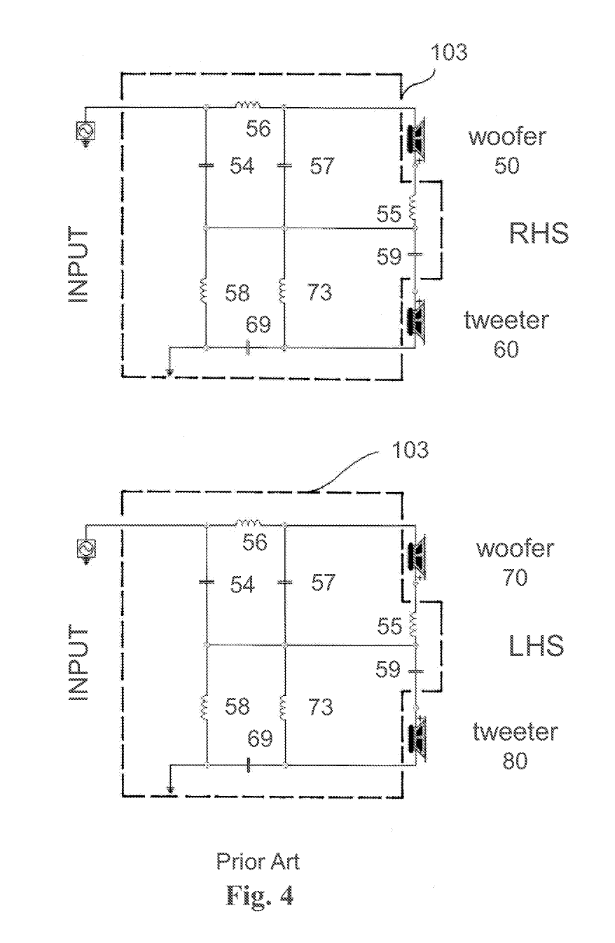

FIGS. 1-4 depict the prior art, 1^{st}-4^{th} order electrical crossovers respectively. The figures depicting crossover schematics use a rectangle to depict a resistor rather than the more conventional symbol typically used. In FIG. 1, a capacitor 40 is connected in parallel with woofer 50 and an inductor 41 is connected in parallel with tweeter 60 to form a 1^{st} order electrical crossover 100 and analogously 40 is connected in parallel with woofer 70 and 41 is connected in parallel with tweeter 80. In FIG. 2, an inductor 43 is connected in series as shown with woofer 50, which also has a capacitor 42 connected in parallel with it, and a capacitor 74 is connected in series as shown with tweeter 60, which has an inductor 44 connected in parallel with it to form a 2^{nd} order electrical crossover 101. Analogously 43 is connected in series as shown with woofer 70, with 42 connected in parallel, and 74 is connected in series as shown with tweeter 80, with 44 connected in parallel. A 3^{rd} order electrical crossover network 102 adds an element to the circuit applied to each driver. FIG. 3 correspondingly shows inductors 46 and 47 connected in series respectively as shown to the positive and negative terminals of woofer 50, which also has a capacitor 45 connected in parallel. Capacitors 49 and 53 are connected in series respectively as shown to the positive and negative terminals of tweeter 60, which has an inductor 48 connected in parallel. The 3^{rd} order electrical crossover network for the LHS is the same as the RHS crossover network like FIGS. 1 and 2. FIG. 4 depicts a 4^{th} order electrical crossover network 103. Inductor 55 is thus connected in series as shown to the positive terminal of woofer 50, which also has a capacitor 54 connected in parallel with it, followed by inductor 56 connected in series to the negative terminal of 50 and another capacitor 57 connected in parallel. Capacitor 59 is connected in series as shown to the positive terminal of tweeter 60, which has an inductor 58 connected in parallel. Capacitor 69 is connected in series to the negative terminal of 80, followed by another inductor 73 is connected in parallel. Again the LHS crossover network is the same as the RHS crossover network like FIGS. 1-3.

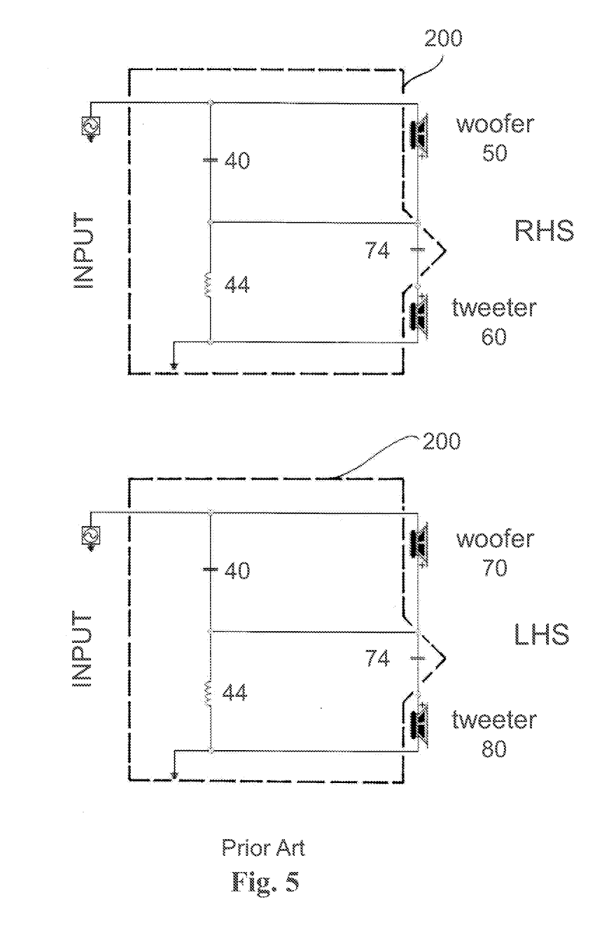

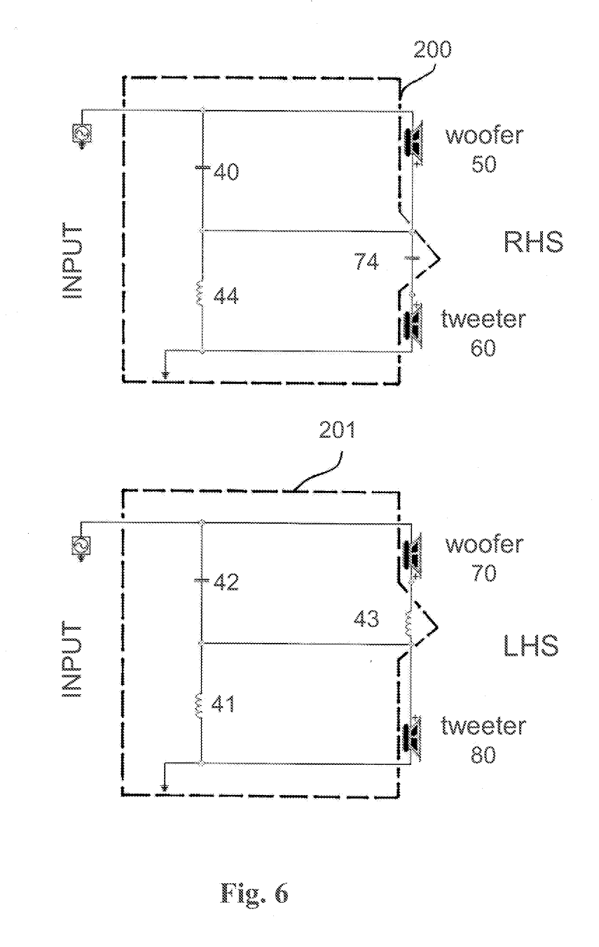

Background on the prior art clarifies discussion of the present art. Like FIGS. 1-4, the LHS effective third-order crossover network 200 in the prior art is the same as the RHS crossover network. FIG. 5 therefore shows a capacitor 40 connected in parallel with woofer 50 and an inductor 44 is connected in parallel with tweeter 60, which also has a capacitor 74 connected in series with it. FIG. 5 thus constitutes a “symmetric” effective third-order crossover for a two-way loudspeaker: namely, a 1^{st} order electrical crossover filter has been applied to the woofer, but a 2^{nd} order electrical crossover filter has been applied to the tweeter. The RHS crossover network for the present art is consequently in accordance with the prior art, but FIG. 6 shows that the LHS crossover network is not in accordance. FIG. 6 shows a capacitor 40 connected in parallel with woofer 50 and an inductor 44 is connected in parallel with tweeter 60, which also has a capacitor 74 connected in series with it. Also an inductor 43 is therefore connected in series with woofer 70, which also has a capacitor 42 connected in parallel with it, and an inductor 41 is connected in parallel with tweeter 80. This constitutes a series “asymmetric” effective third-order crossover for a two-way loudspeaker 201, which is rarely encountered and moreover has never before been complemented with a series“symmetric” effective third-order crossover for the two-way loudspeaker in the right channel. A 2^{nd} order electrical crossover filter has thus been applied to the left-hand woofer, but a 1^{st} order electrical crossover filter has been applied to the left-hand tweeter.

Crossover component values are calculated according to the conventional equations for defining the half-power, or −3 dB point, (i.e. attenuation) frequency ν_{f} for designing electrical filters of a given order. For example, for a 1^{st} order electrical filters (FIG. 1), e.g. Butterworth, the equations are

C=1/(2πZν_{f}) (3)

L=Z/(2πν_{f}) (4)

where L is the inductor, C is the capacitor and Z is the driver impedance at ν_{f} used in the crossover network that eqs. (3)-(6) describe. Nearly all odd-ordered electrical filters are Butterworth filters and are relatively insensitive to horizontal driver offset. Even-ordered electrical filters are named differently depending on their damping and are sensitive to horizontal driver offset. The convention for ν_{f} differs for even-ordered electrical filters because the damping differs. For instance, ν_{f} for a 2^{nd} order electrical LinkwitzRiley filter is the frequency that attenuates driver response 6 dB. The conventional equations for designing a 2^{nd} Butterworth electrical crossover (FIG. 2) are

C=√2/(2πZν_{f}) (5)

L=Z/(2πν_{f}√2) (6)

and are used to calculate crossover component values where warranted. Other crossover formulae can be used to either increase damping (e.g. Linkwitz-Riley) or decrease damping (e.g. Chebychev), as the user deems fit. The negative terminals of the tweeters are connected to the negative terminals of the power supply in phase-unified loudspeakers, unless otherwise noted. In FIG. 6 and other embodiments of the present invention, capacitors, resistors and inductors used are typically numbered differently to indicate the right versus the left channel. This convention is warranted because a given circuit element used in the crossover network for the RHS loudspeaker is typically not equal in value to that element used in the crossover network for the LHS loudspeaker. For example, in FIG. 6, the value of capacitor 40 is given by eq. (3), but the value of capacitor 43 is given by eq. (5). Thevenin equivalences apply, as demonstrated below for crossovers with higher effective orders. In FIGS. 1-24, the two-way loudspeaker for the right channel has a woofer 50 and a tweeter 60 connected in series and the two-way loudspeaker for the left channel has a woofer 70 and a tweeter 80, also connected in series.

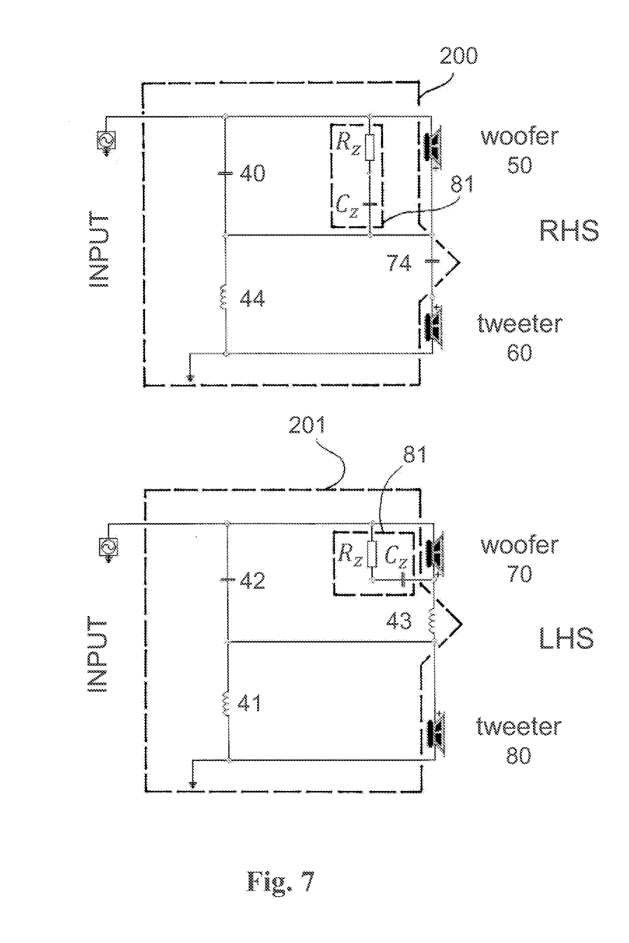

Complimentary crossover networks are therefore used in the RHS and LHS loudspeakers to phase-unify their reproduction. A symmetric effective crossover for the loudspeaker in one channel and an asymmetric effective crossover of the same order for the loudspeaker in the other channel comprise said complimentary crossover networks, phase-unifying reproduction in accordance with handedness rules that are given below. Ordinarily an effective crossover can be 3^{rd} order or of a higher order, which is theoretically unlimited, simply depending upon the number of crossover elements used. FIG. 7 shows the effective third-order crossover circuit for a two-way loudspeaker system, with an impedance correction circuit typically called a “Zobel” applied to the woofer, in accordance with the preferred embodiment of the present invention: a capacitor C_{z} and resistor R_{z} are connected in series to form Zobel 81, which is connected in parallel with woofer 50 and similarly connected to woofer 70. Alternative embodiments use auxiliary circuits, circuit shortcuts, more drivers and/or different effective crossover orders. For instance, FIG. 6 shows the crossover network without a Zobel, to form the first alternative embodiment of the present invention. Although most parallel phase-unified two-way loudspeakers apply a Zobel circuit to the woofer, the first alternative embodiment will phase-unify some loudspeakers, particularly those using woofers not heavily subject to cone breakup and peaked response at higher frequencies.

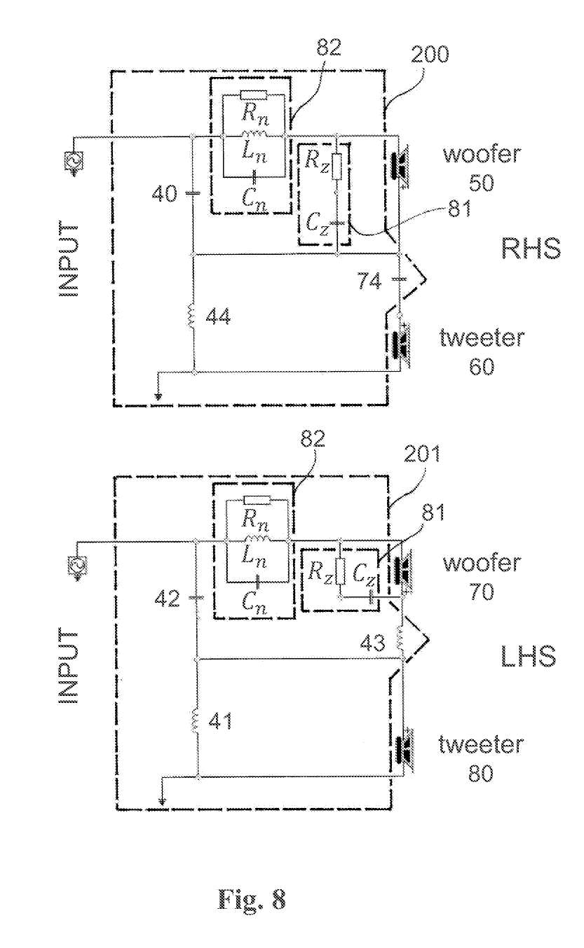

Note that in addition to the Zobel circuit, a notch filter can also be applied to the woofer to compensate for a peak in response and form the second alternative embodiment of the present invention (FIG. 8). A notch filter 82 ordinarily consists of a resistor, inductor and capacitor connected in parallel, respectively Rₙ, Lₙ and Cₙ in FIG.8 with values calculated from conventional formulae, taking care to mitigate possible, severe phase effects. The notch filter is then applied in series to the drivers of interest, 50 and 70 in FIG. 8, after the crossover elements that constitute low-pass, bandpass or high-pass filters proper. More than one configuration for a notch filter, a circuit very sensitive to phase effects, is available. A heavily ringing, resonant peak in the impedance of a tweeter or other driver is nonetheless scotched with an LCR (elements connected in series) circuit applied parallel to that driver, again after the low-pass, bandpass or high-pass filters proper. Occasionally the application of a notch filter to a driver changes the net slope of a low-pass, bandpass or high-pass filter, an effect that must be taken in consideration with the present invention.

An inductor connected in parallel with a driver forms a 1^{st} order electrical high-pass filter in accordance with eq. (4). However a capacitor connected in parallel to the inductor, either before the inductor or between the inductor and driver, forms a bandpass filter rolling off driver response with 6 dB/octave slopes. In this bandpass filter, equations (3) and (4) define ν_{f} for the two crossover elements and therefore the range of frequencies that the driver will reproduce at full output.

According to the Thevenin equivalences, a capacitor connected in series with a driver forms a 1^{st} order electrical high-pass filter in accordance with eq. (3). However in addition, an inductor connected in series with the driver forms a bandpass filter rolling off driver response with 6 dB/octave slopes. In this bandpass filter, equations (3) and (4) again define ν_{f} for the two crossover elements and therefore the range of frequencies that the driver will reproduce at full output. The section on phase-unified 3-way loudspeakers below applies bandpass filters.

Notch filter construction differs from bandpass filter construction. For instance, in one type of notch filter, an inductor is connected in parallel with a driver. In addition, a capacitor is connected in series with the inductor, and implicitly in parallel with the driver. This forms a notch, as opposed to a peak, in the driver response. The addition of a resistor in parallel with the crossover elements comprising this notch filter enables one to control the amount of current flowing across the notch filter. For example, at infinite resistance, no current flows across this filter. The notch filter is typically applied to stop the ringing that can occur at a driver's resonance frequency. Thus the value of the inductor, capacitor and resistor in the notch filter depend on the electrical and mechanical damping factors of the driver as well as on its DC resistance and resonance frequency.

In another type of notch filter, an inductor is connected in series with a driver. In addition, a capacitor is connected in parallel with the inductor, and implicitly in series with the driver. This forms a notch, as opposed to a peak, in the driver response. The addition of a resistor in parallel with the crossover elements comprising this notch filter enables one to control the amount of current flowing across the notch filter. For example, at zero resistance, no current flows across this filter. This notch filter is often applied to eradicate the peak in a driver's frequency response that can occur due to cone breakup modes. Thus the value of the inductor, capacitor and resistor in this notch filter depend on the frequency at which this peak arises.

Additional topologies for notch filters are available. For instance, a notch filter can be formed when an inductor is connected in series to a woofer or midrange. A capacitor is connected in parallel to this inductor, but a resistor is connected in series to the capacitor to form an RC circuit across the inductor. This inductor experiences the conventional rolloff of approximately 6 dB/octave, but the capacitor displays a rolloff that can be varied depending on the application of infinite to zero resistance. This reasoning can be extended to tailor the rolloff slope for individual reactive elements in a filter. A resistor can be put across an inductor or capacitor connected in series with a driver to attenuate the rolloff slope, as desired, from 6 dB/octave to 0 dB/octave. A resistor can be connected in series to an inductor or capacitor connected in parallel with a driver to attenuate the rolloff slope continuously from 6 dB/octave to 0 dB/octave.

These concepts can be incorporated into suitable electrical filters to combine rolling off and notching actions. For example, a Cauer elliptic filter rolls off driver response, also functions as a notch filter to an appreciable extent and can be applied to the present art to constitute additional alternative embodiments. Cauer elliptic filters have independently adjustable rolloff and notch functions, but also possess considerable phase effects. These filters are further distinguished because for a given electrical order, they roll off with substantially greater slopes than the slopes of their less sophisticated counterparts. For example, the slope of a 4^{th} order electrical Cauer elliptic filter is substantially greater than the 24 dB/octave slope that a 4^{th} order electrical Butterworth or Bessel filter exhibits. Care must therefore be taken to measure the effective crossover slope that a Cauer elliptic filter elicits and to use this slope to implement the present art. Ordinarily these filters are limited to higher crossover orders and are relatively undamped, which can cause some drivers to ring.

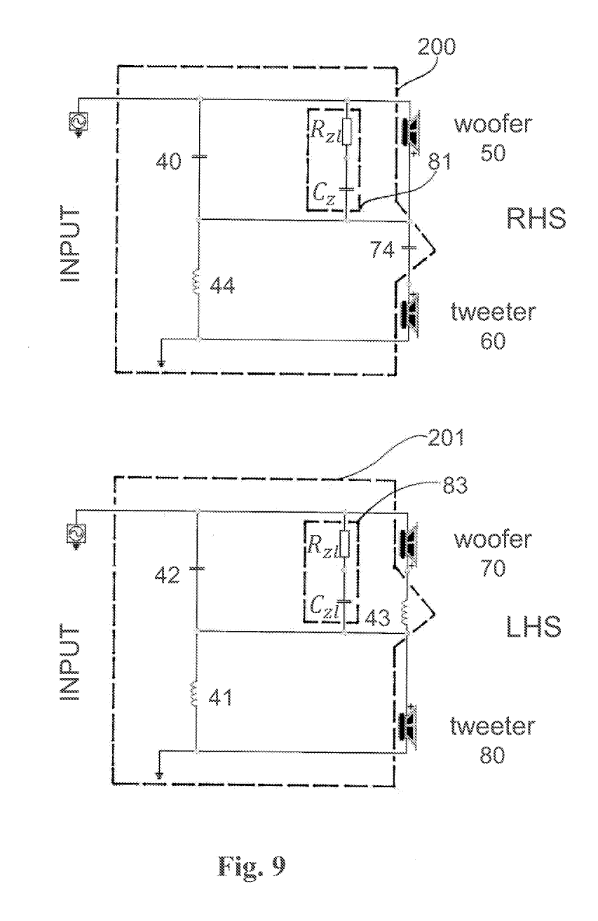

A woofer Zobel can serve different purposes in a series crossover. For instance, the third alternative embodiment of the present invention applies a woofer Zobel to the entire woofer subdivision of the crossover (as demonstrated for the LHS woofer in FIG. 9), to damp this subdivision rather than merely the woofer. In this case, one connects C_{zl} and R_{zl} in series to form a more robust Zobel circuit 83, which one applies to the LHS woofer to demonstrate, though C_{z} and R_{zl} are applied to the RHS woofer. R_{zl} replaces R_{z} so that the same amount of current flows across both woofer Zobels. To calculate, C_{zl} is roughly twice C_{z} and R_{zl} is roughly 1.25 times C_{z}.

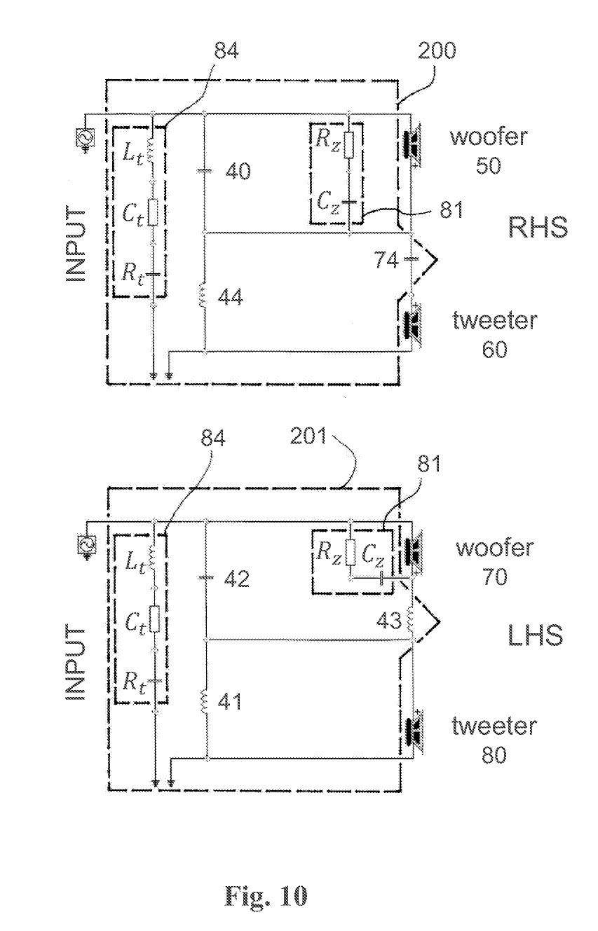

The fourth alternative embodiment of the present invention applies a “twister” circuit to any of the previous embodiments, as shown applied to the preferred embodiment in FIG. 10. A twister circuit corrects the impedance of an entire loudspeaker system consisting of multiple drivers and is applied across the negative and positive terminals of the system. A twister circuit 84 consists of a resistor, inductor and capacitor in series, respectively Rₜ, Lₜ and Cₜ in FIG. 10 with values calculated from conventional formulae.

A twister circuit ordinarily comprises a notch filter tuned to the impedance peak for a 2-way loudspeaker, a frequency that falls near νₓ. A twister circuit thus corrects the impedance of an entire 2-way loudspeaker so that the amplifier has an easier load to drive and driver performance near νₓ is smoother. In 3-way or better loudspeakers consisting of multiple drivers, a twister circuit can still be applied, but one must choose which νₓ to tune this circuit to. In the present art, this would typically be the crossover frequency nearest ν_{b}.

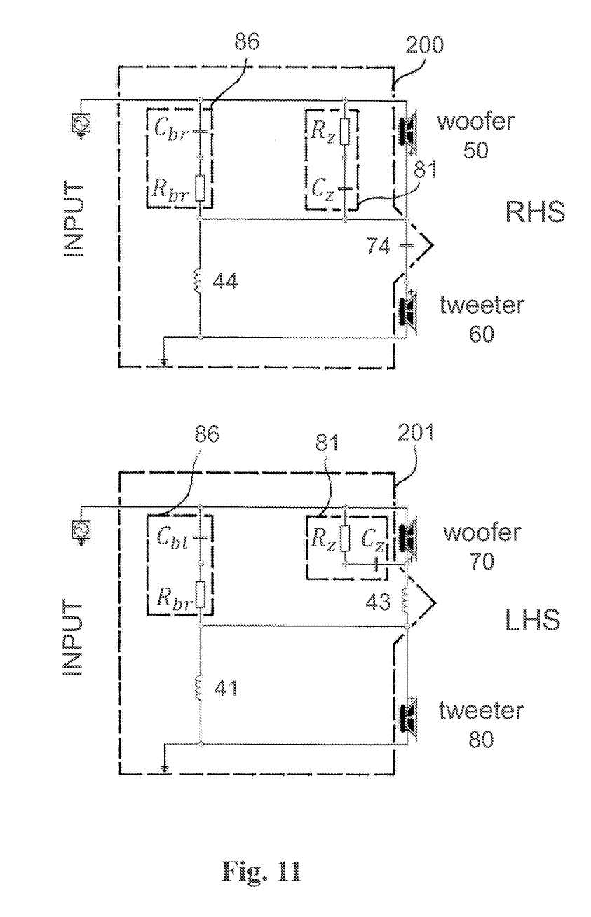

The fifth alternative embodiment of the present invention applies an RC circuit to diminish the baffle step response of the woofer (FIG. 11). The frequency for the baffle step depends on the width of the loudspeaker enclosure and is calculated conventionally. At ν_{b}, the woofer response increases up to 6 dB, to bloat reproduction somewhat. The RC circuit 86 that typically corrects for the baffle step consists of an inductor C_{bl} and resistor R_{br} in series and is typically applied in parallel to the woofer 70 before any other crossover elements. In FIG. 11, 86 replaces 40 on 50 and 42 on 70. However now the value of C_{bl} is given by the value of inductor set for one-third of the baffle-step frequency, using the Butterworth formula for a 1^{st} order low-pass electrical filter. This filter rolls off high frequencies at 6 dB/octave so that the value of R_{br} is given by whatever slope one chooses between 0-6 dB/octave to correct the baffle step. Baffle-step correction is particularly useful for higher crossover orders. A larger shunt capacitor C_{br}, damped by the resistor R_{br}, is applied to 50 to correct the baffle step, forming the RC circuit 86. The value of C_{br} in 86 is also given by eq. (3), where the frequency used is one-third of ν_{b}, but is distinct from C_{bl} for tailoring purposes. The filter slopes applied to 50 and 70 differ. An alternative circuit to correct the baffle step is available. This RL circuit consists of a inductor and resistor in parallel and is connected in series with the woofer, or driver, of interest.

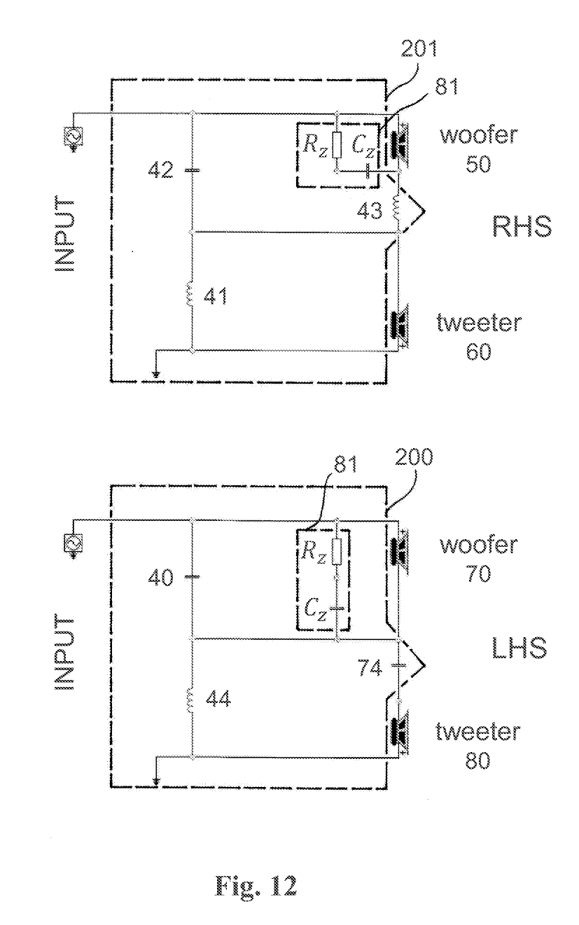

The sixth alternative embodiment of the present invention reverses the tweeter connections so that the positive terminal of the power supply is connected to the negative terminal of the tweeter to change the handedness so that the “asymmetric” effective third-order crossover is now applied to the loudspeaker system for the right channel and the “symmetric” effective third-order crossover to the loudspeaker system for the left channel (FIG. 12). For example, now an inductor 43 is connected in series with RHS woofer 50, which also has capacitor 42 ordinarily connected in parallel, and an inductor 41 is connected in parallel with the tweeter 60. Accordingly the right-hand loudspeaker has a 2^{nd} order electrical crossover filter applied to the woofer, but a 1^{st} order electrical filter applied to the tweeter. A series circuit of C_{z} and R_{z} is applied in parallel to both woofers for impedance correction.

The LHS two-way loudspeaker now has a capacitor 40 is connected in parallel with woofer 70 and a capacitor 44 is connected in series with tweeter 80, which also has an inductor 74 connected in parallel with it. This constitutes a symmetric effective third-order crossover for a two-way loudspeaker 200: namely, a 1^{st} order electrical crossover filter has been applied to the woofer, but a 2^{nd} order electrical crossover filter has been applied to the tweeter. The circuit shortcuts and auxiliary circuits applied to previous embodiments can be adapted and applied to the sixth alternative embodiment.

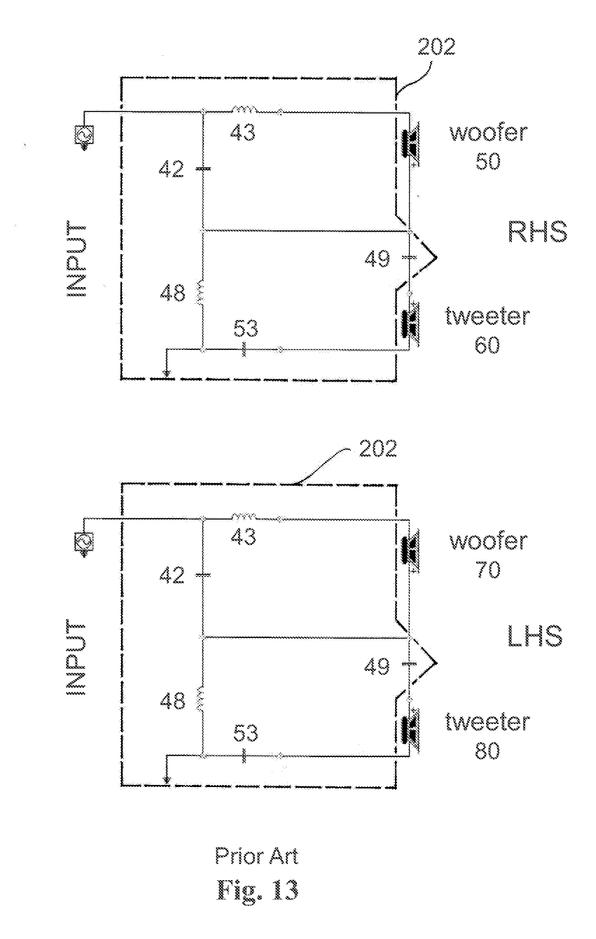

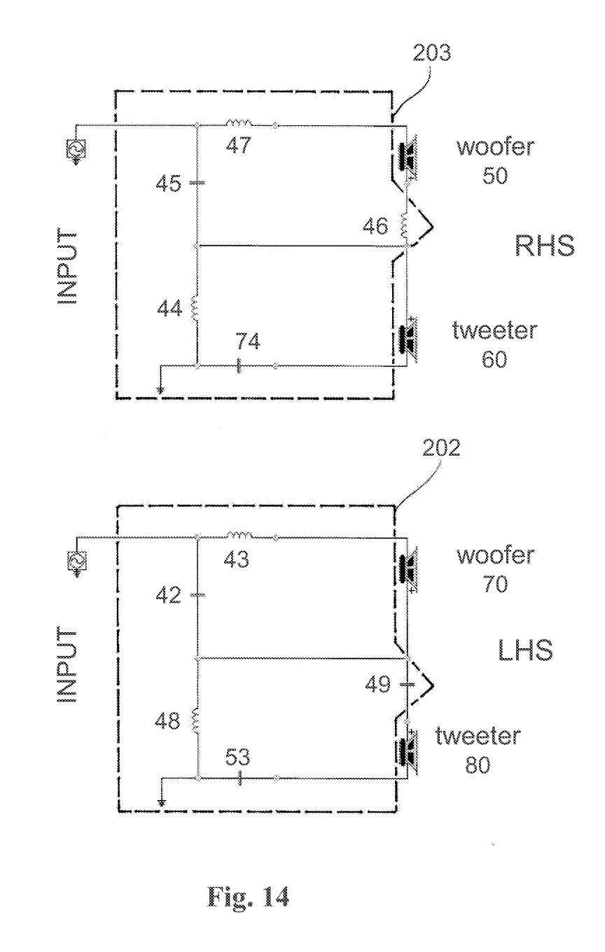

The handedness changes when the effective crossover orders are even for phase unification. FIG. 13 provides the schematic for an effective fourth-order crossover in the prior art, which applies a 2^{nd} order electrical crossover filter to the woofer, but a 3^{rd} order electrical crossover filter to the tweeter to constitute a series “symmetric” effective fourth-order crossover for a two-way loudspeaker 202. FIG. 14 provides the schematics for a phase-unified effective fourth-order crossover and the seventh alternative embodiment of the present invention. An inductor 46 is connected in series with woofer 50, which also has capacitor 45 connected in parallel and another inductor 47 connected in series as shown. Also a capacitor 74 is connected in series with tweeter 60, which also has an inductor 44 connected in parallel. This constitutes a series “asymmetric” effective fourth-order crossover for a two-way loudspeaker 203: namely, a 3^{rd} order electrical crossover filter has been applied to the woofer, but a 2^{nd} order electrical crossover filter has been applied to the tweeter. An inductor 43 is connected in series with woofer 70 as shown and a capacitor 42 connected in parallel. A capacitor 49 is connected in series with tweeter 80, which also has an inductor 48 connected in parallel and another capacitor 53 connected in series as shown. Capacitor and inductor values are calculated according to the conventional formulae for designing 2^{nd} and 3^{rd} order electrical filters (FIGS. 2 and 3 respectively), e.g. Bessel and Butterworth. Again other filter formulae can be used to either increase damping (e.g. Linkwitz-Riley) or decrease damping (e.g. Chebychev), as the user deems fit.

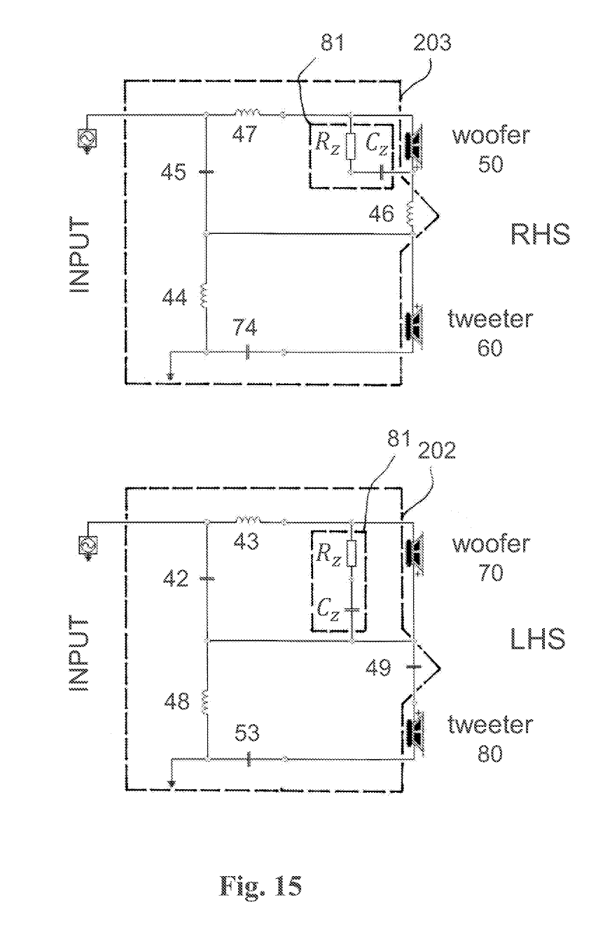

FIG. 15 portrays the eighth alternative embodiment of the present invention, in which Zobel circuits are applied to the woofers in a phase-unified loudspeaker system applying an effective fourth-order crossover. The circuit shortcuts and auxiliary circuits applied to previous embodiments can be adapted and applied to the seventh or eighth alternative embodiments of the present art, including changing tweeter polarity.

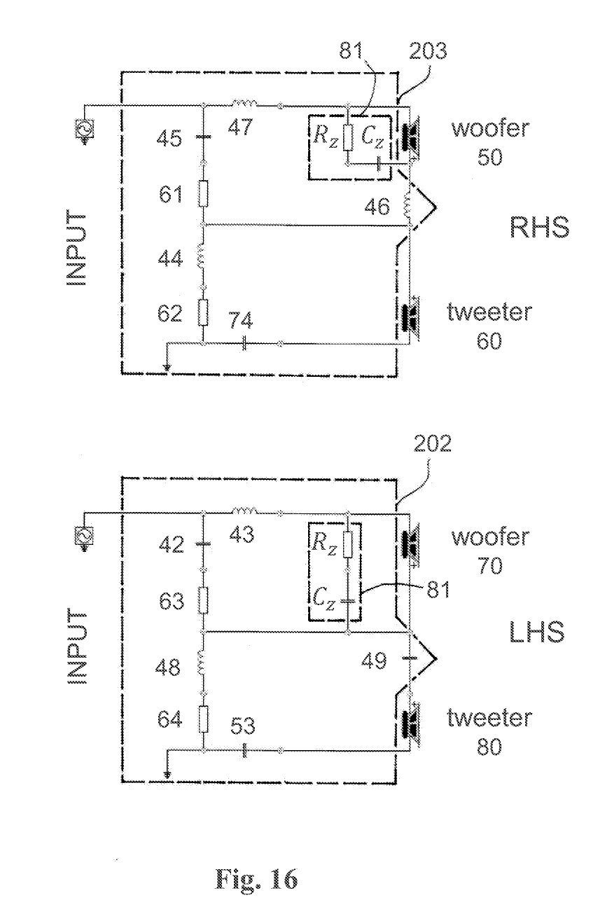

The ninth alternative embodiment of the present invention applies attenuating resistors to attenuate phase unification. FIG. 16 consequently shows the attenuating resistor 61 connected in series to 45 and the attenuating resistor 62 connected in series to 44 in the RHS crossover. One sets 61 equal to the impedance of 50 at ν_{f} to attenuate the slope of this RC circuit connected in parallel to 50 from 6 to 3 dB/octave. Similarly one sets 63 equal to the impedance of 60 at ν_{f} to attenuate the slope of this RL shunt connected to 60 from 6 to 3 dB/octave. The attenuating resistor 63 is connected in series to 42 and the attenuating resistor 64 connected in series to 48 in the LHS crossover. These concepts can be generalized to apply attenuating resistors in parallel to the reactive series elements connected in series applied to each driver in the electrical filters in FIG. 16, but are not shown. The same woofer is used for 50 and 70; ordinarily the two woofers have the same impedance and 61 equals 63. The same tweeter is used for 60 and 80; ordinarily the two tweeters have the same impedance and 62 equals 64. The values of attenuating resistors can be varied between zero and infinity to provide filter slopes of 6-0 dB/octave, respectively over that leg of the respective filter. The relationship of 61 to the impedance of 50 should equal the relationship of 63 to the impedance of 60 to attenuate phase unification smoothly. The relationship of 62 to the impedance of 70 should equal the relationship of 64 to the impedance of 80 to attenuate phase unification smoothly. Similar relationships should hold between attenuating resistors connected in parallel to the reactive series elements connected in series applied to a given driver. A reduction of phase unification is not recommended, but is possible in the present art.

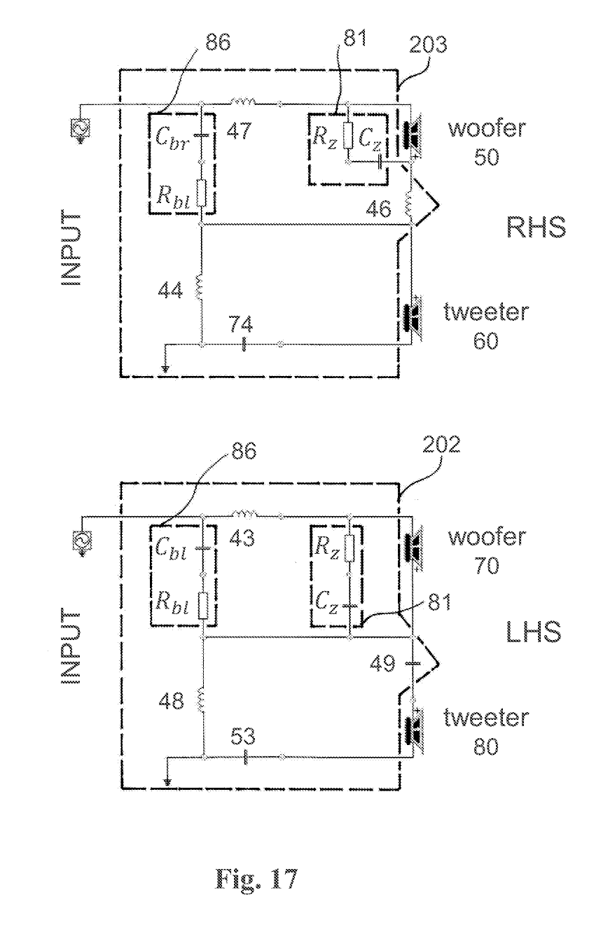

The tenth alternative embodiment of the present invention corrects the baffle step. FIG. 17 thus shows 86, containing a resistor R_{bl} connected in parallel to C_{br} in the RHS crossover, with one-third of ν_{b} determining the value of C_{br} according to eq. (3). One selects a slope to correct the baffle step to determine the value of R_{bl}. The Butterworth formula for a 3^{rd} order electrical filter gives the value of 47, the second inductor applied directly to 50.

A similar approach is applied in order to correct the baffle step in the LHS crossover. To tune the slope of baffle-step correction, R_{bl} is therefore connected in series to C_{bl}, which is now determined by one-third of ν_{b}, according to eq. (3) to form an RC circuit that corrects the baffle step 86. Again C_{br} and C_{bl} differ for crossover tailoring purposes.

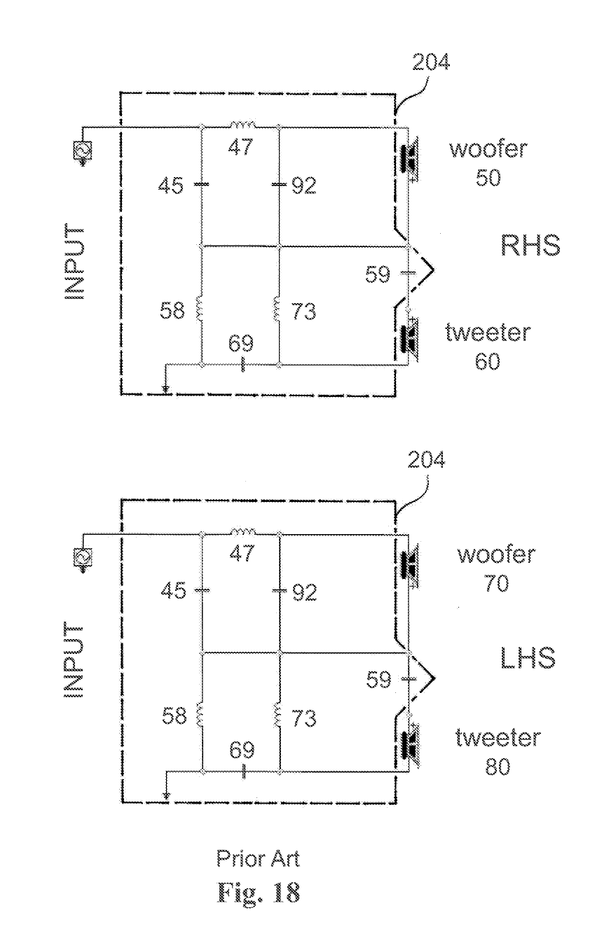

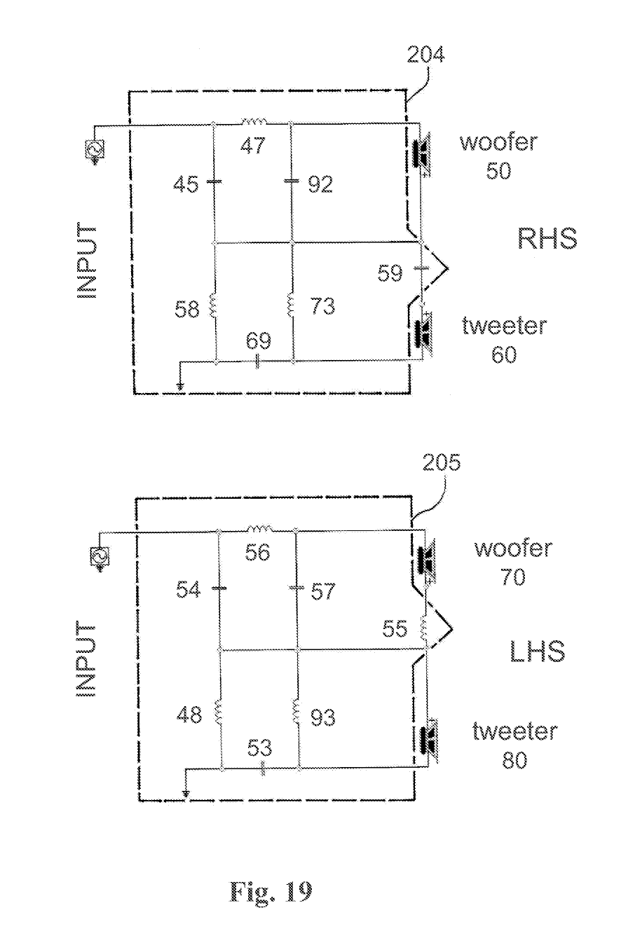

The handedness for odd effective crossover orders stays the same to phase-unify. Accordingly the “effective fifth-order” crossover on the right-hand loudspeaker remains “symmetric”, but the “effective fifth-order” crossover on the left-hand loudspeaker is rendered “asymmetric,” as described (FIG. 19). FIG. 18 depicts the prior art, wherein a capacitor 45 is connected in parallel with woofer 50, with an inductor 47 is connected in series, to be followed by another capacitor 92 connected in parallel with woofer 50. A capacitor 59 is connected in series with tweeter 60, which has an inductor 58 connected in parallel, followed by another capacitor 69 connected in series with tweeter 60, which is followed by another inductor 73 in parallel. This constitutes a symmetric effective fifth-order crossover for a two-way loudspeaker 204: namely, a 3^{rd} order electrical crossover filter has been applied to the woofer, but a 4^{th} order electrical crossover filter has been applied to the tweeter.

A phase-unified “effective fifth-order” crossover exemplifies the eleventh alternative embodiment of the present invention. The crossover network for the RHS channel is symmetric and is the same as the network that FIG. 18 describes. However, the crossover network for the LHS two-way loudspeaker is asymmetric effective fifth-order 205. FIG. 19 consequently describes a capacitor 54 connected in parallel with woofer 70, followed by an inductor 56 connected in series with 70, in turn followed by another capacitor 57 connected in parallel. Another inductor 55 is connected in series with 70 as shown. An inductor 48 is connected in parallel with tweeter 80, followed by a capacitor 53 connected in series with tweeter 80 and another inductor 93 connected in parallel. Accordingly the left-hand loudspeaker has a 4^{th} order electrical crossover filter applied to the woofer, but a 3^{rd} order electrical crossover filter applied to the tweeter.

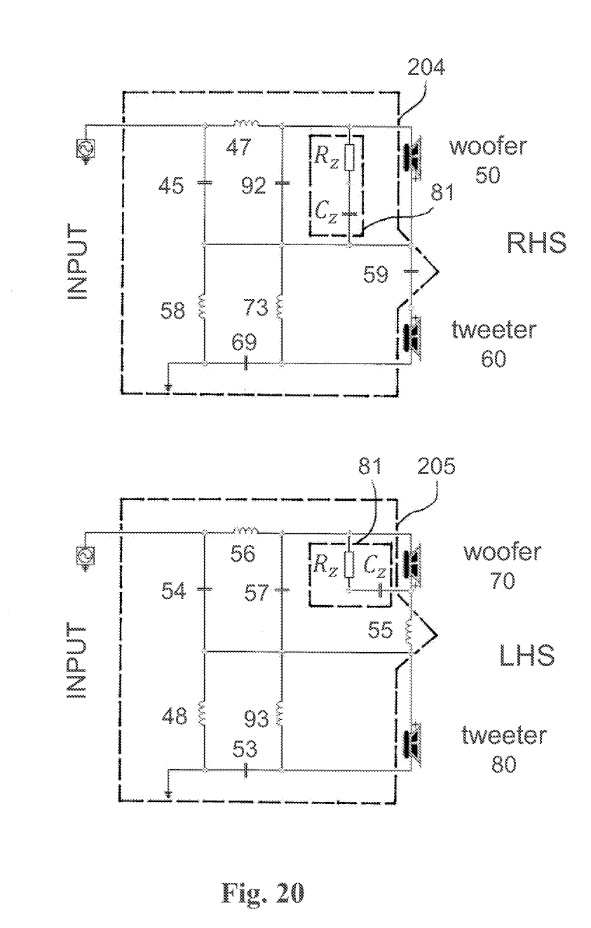

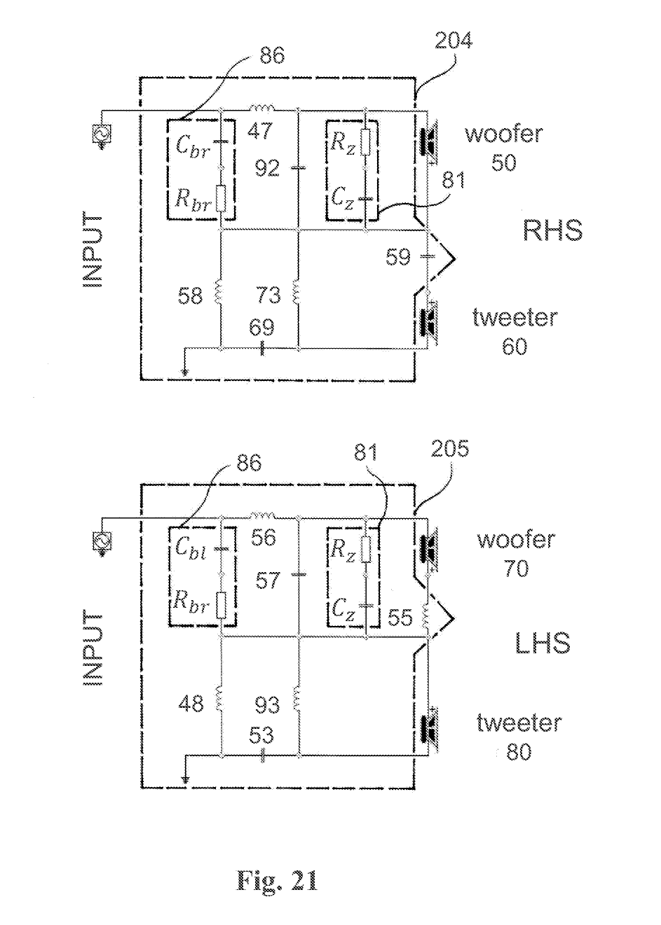

The application of circuit 81 to each woofer often facilitates phase-unification (FIG. 20) and comprises the twelfth alternative embodiment of the present invention. The thirteenth alternative embodiment of the present invention simply uses the LHS woofer Zobel 83 to damp the entire woofer subdivision of the crossover: namely, C_{zl} and R_{zl}. Furthermore FIG. 21 corrects the baffle step with 86 by replacing 45 with C_{br} and R_{br} connected in series and by replacing 54 with C_{bl} and R_{br} connected in series. The value of R_{br} determines the respective correction slopes. For FIGS. 19-21, capacitor and inductor values are calculated according to the conventional formulae for designing 3^{rd} and 4^{th} order electrical filters (FIGS. 3 and 4 respectively), e.g. Bessel and Butterworth. The circuit shortcuts and auxiliary circuits applied to previous embodiments can be adapted and applied to the tenth, eleventh or twelfth alternative embodiments, including changing tweeter polarity. FIGS. 18-21 apply Thevenin equivalences to replace the first series inductor 46 applied to 50 with the second parallel capacitor 92; FIG. 18 does the same to 70. Thevenin equivalences are also used to replace the first series capacitor 49 applied to 60 with the second parallel inductor 93, except for FIG. 18.

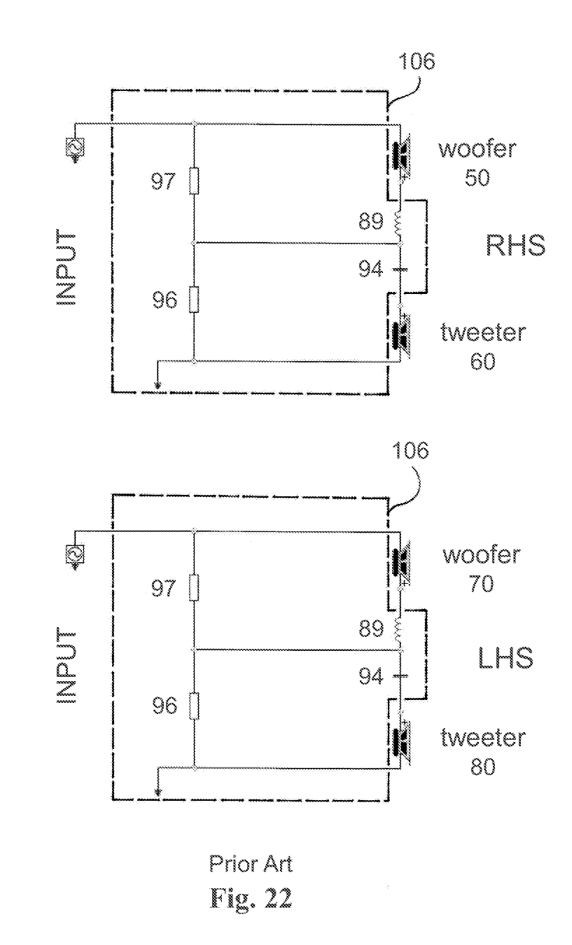

An effective second-order version of the present art is available, but has very limited applications. Thevenin equivalences are used in FIG. 22 to form an alternative 106 to the 1^{st} order electrical series crossover for a two-way loudspeaker given in FIG. 1. In FIG. 22, a first inductor 89 is connected in series with woofer 50 and a first capacitor 94 is connected in series with tweeter 60. Loading resistors 97 and 96 are connected in parallel to 50 and 60 respectively as shown, and 50 and 60 are connected in series. The values of 97 and 96 can be varied between the respective driver impedance and multiples thereof to proportion the amount of current between the driver and resistor. In FIG. 22, the LHS loudspeaker has the same crossover as the RHS loudspeaker.

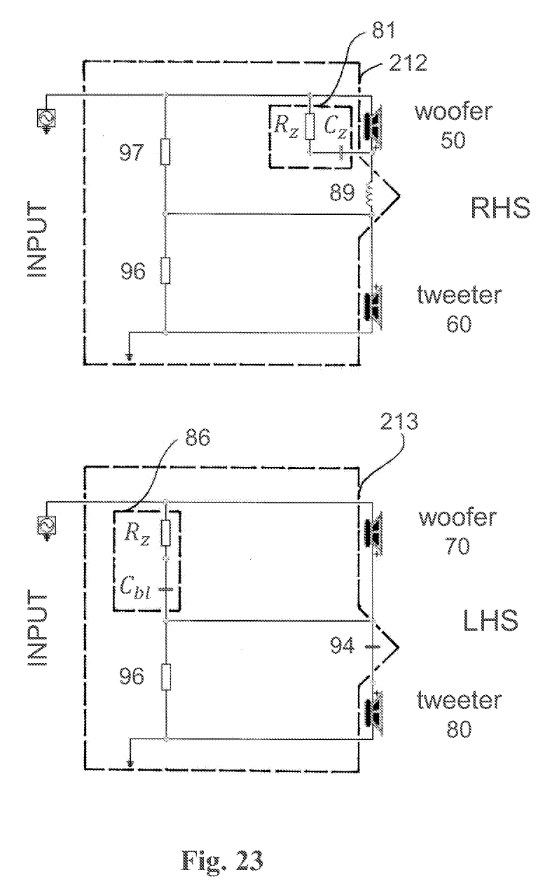

FIG. 23 shows the simple crossover for the fourteenth alternative embodiment, wherein the negative terminal of the tweeter is connected to the negative terminal of the power supply for each channel. For example, FIG. 23 displays a first inductor 89 connected in series to 50 in the RHS loudspeaker to form an asymmetric effective second-order crossover network for a two-way loudspeaker 212: namely, a 1^{st} order filter has been applied to the woofer, but no filter has been applied to the tweeter. Also a Zobel 81 and a loading resistor 97 are connected in parallel to 50 as shown. The fourteenth alternative embodiment is completed when a first capacitor 94 connected in series to 80 in the LHS loudspeaker to form a symmetric effective second-order crossover network for a two-way loudspeaker 213: namely, no filter has been applied to the woofer, but a 1^{st} order filter has been applied to the tweeter. In addition, a Zobel is connected in parallel to 70, but C_{bl} replaces C_{z} to transform 81 into 86, the baffle-correction circuit.

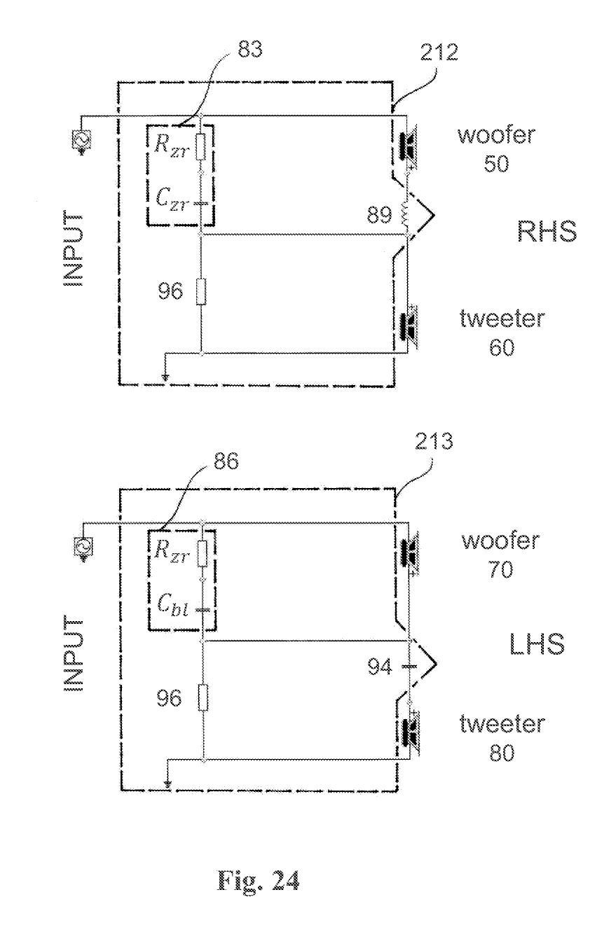

The fifteenth alternative embodiment connects a modified Zobel 83 across 50 as shown in FIG. 24. This alternative embodiment replaces R_{z} with R_{zr}, where R_{zr} is 1.25R_{z}. Accordingly this alternative embodiment also uses R_{zr} in 86.

The asymmetric effective second-order crossover network reveals one of the major limitations on the fourteenth, fifteenth and related alternative embodiments. Unfiltered tweeters used in high-fidelity loudspeakers, by and large, have severely limited power-handling, a major rationale for tweeter filters. Outstanding power-handling for an unfiltered tweeter is 10 W. However high-fidelity loudspeakers can handle upwards of 200 W depending on the application so that this embodiment ordinarily cannot play very loud.

Other limitations on the fourteenth, fifteenth and related alternative embodiments include the severe restrictions on woofer and tweeter properties. For instance, these alternative embodiments use filters to determine the rolloff slope, not νₓ. Accordingly the natural rolloff of the woofer and tweeter selected to implement these embodiments typically need to occur at a frequency nearly equal to νₓ to provide flat frequency response and accurate reproduction. Furthermore νₓ needs to be reasonably close to ν_{b}. Auxiliary circuits can be used with these alternative embodiments to form still more alternative embodiments. Midranges and other drivers can be incorporated to form N-way loudspeakers and develop even more alternative embodiments.

A loudspeaker designer can nonetheless introduce lobing into the VPR of a loudspeaker with the improper application of auxiliary circuits into the crossover. Care must therefore be taken to diminish such lobing. Accordingly it is recommended that if a given auxiliary circuit, e.g. a notch filter, is applied to a RHS driver, then the same auxiliary circuit is applied to the same LHS driver. Possible exceptions include Zobels and twister circuits. For instance, if one Zobel simply corrects impedance and the other Zobel has additional application, as in FIGS. 23, 24 and others, the Zobels can use different capacitor values, but the same resistor value. If a twister circuit is applied to a given νₓ, more care is demanded that this νₓ for the RHS and LHS is nearly equal.

Three-Way to N-Way Phase-Unified Loudspeakers with Passive Crossovers

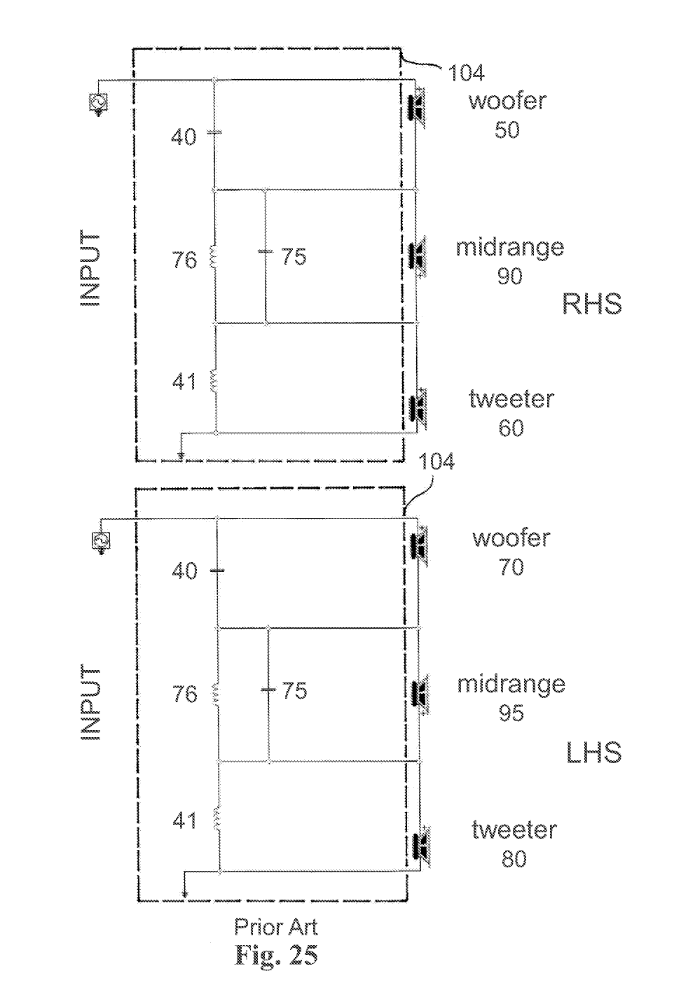

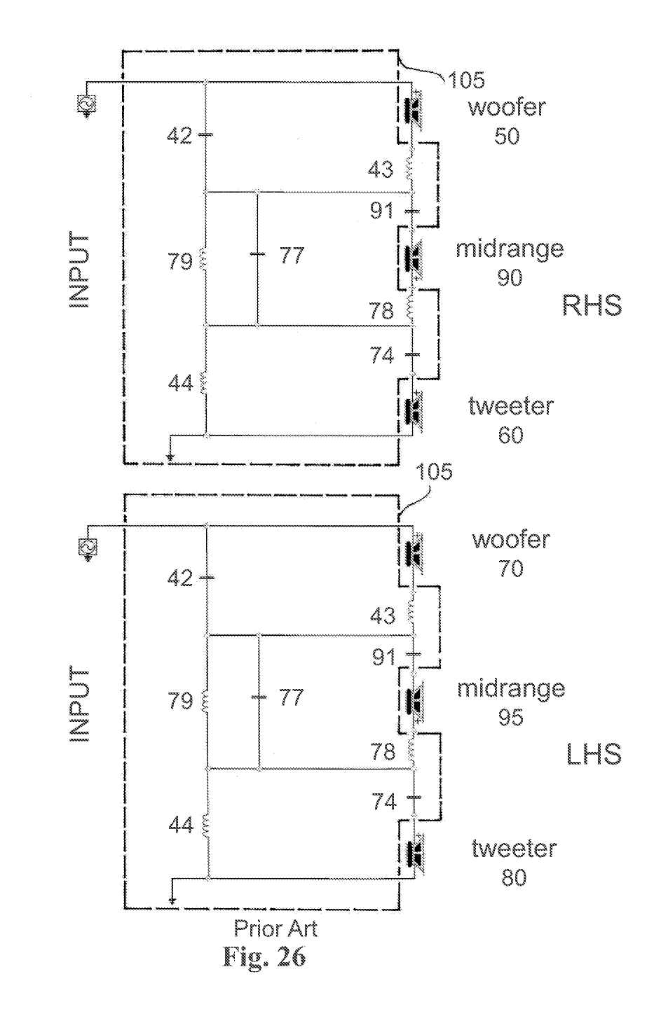

FIGS. 25 and 26 depict 1^{st} and 2^{nd} order electrical crossover networks respectively, 104 and 105, for three-way loudspeakers in the prior art. In FIG. 25, a capacitor 40 is connected in parallel with woofer 50 and an inductor 41 is connected in parallel with tweeter 60 and analogously 40 is connected in parallel with woofer 70 and is connected in parallel with tweeter 80. In addition, a capacitor 75 and an inductor 76 are separately connected in parallel to midrange 90 as shown. The RHS crossover circuit is the same as the LHS crossover circuit. In FIG. 26, a capacitor 42 connected in parallel with woofer 50, which also has an inductor 43 is connected in series with it, and an inductor 44 is connected in parallel with tweeter 60, which has a capacitor 74 connected in series. In addition, a capacitor 77 and an inductor 79 are each connected in parallel with midrange 90, which also has a capacitor 91 and an inductor 78 connected in series with it, all as shown. In FIG. 26, the RHS crossover circuit is also the same as the LHS crossover circuit.

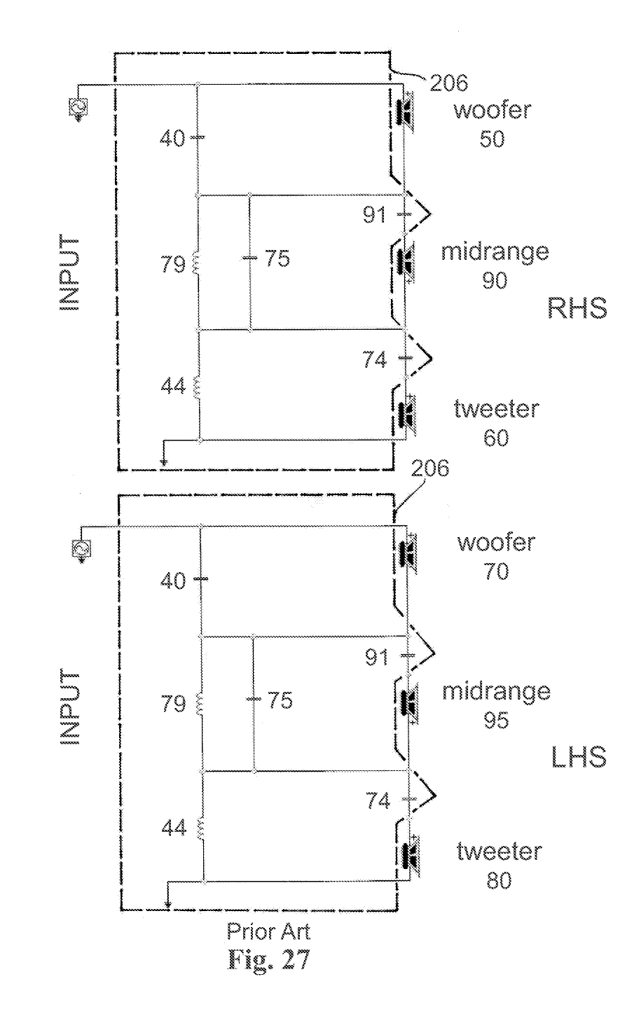

FIG. 27 depicts the effective 3^{rd} order crossover network for three-way loudspeakers according to the prior art. Accordingly a capacitor 40 is connected in parallel with woofer 50 and an inductor 44 is connected in parallel with tweeter 60. In addition, a capacitor 75 and an inductor 79 are each in parallel to midrange 90 as shown. A capacitor 91 connected in series with midrange 90 and a capacitor 74 is connected in series with tweeter 60, as shown. This constitutes a “symmetric” effective third-order crossover for a three-way loudspeaker 206: namely, a 1^{st} order electrical crossover filter has been applied to the woofer, but a 2^{nd} order electrical filter has been applied to the tweeter. In addition, a 1^{st} order electrical crossover filter has been applied to the midrange to rolloff the high frequencies, and a 2^{nd} order electrical filter has been applied to the midrange to attenuate the low frequencies. The RHS crossover circuit is the same as the LHS crossover circuit.

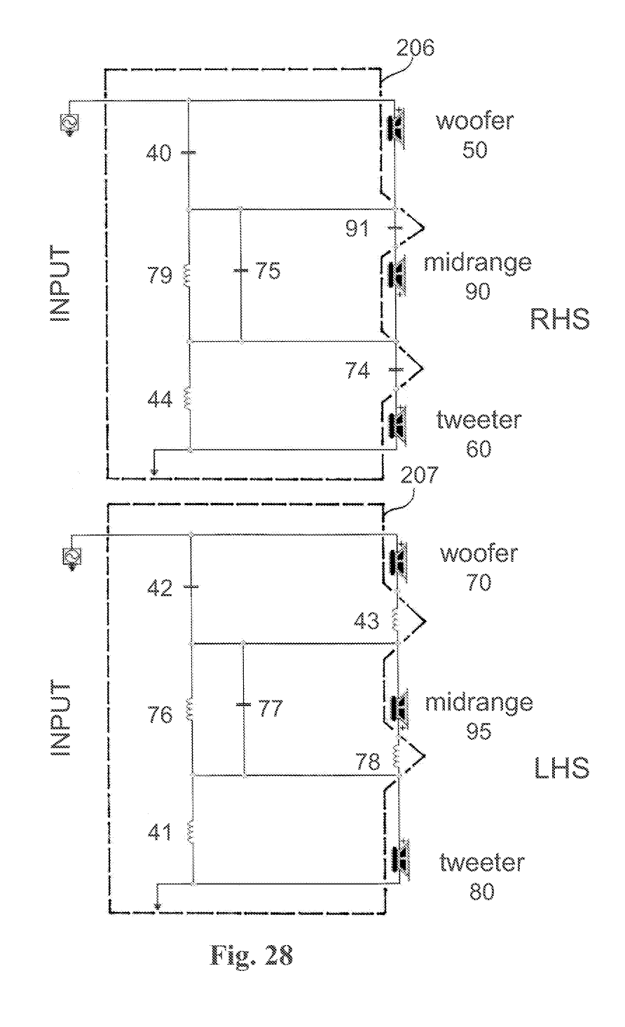

FIG. 28 depicts a phase-unified effective 3^{rd} order crossover network for three-way loudspeakers according to the sixteenth alternative embodiment of the present invention. The right channel has the same crossover circuit as FIG. 27, but the crossover circuit for the left channel differs. As a consequence, a capacitor 42 is connected in parallel with woofer 70, which also has an inductor 43 connected in series with it; a capacitor 77 and an inductor 76 are each connected in parallel with midrange 95, which also has an inductor 78 connected in series; and an inductor 41 is connected in parallel with tweeter 80. This constitutes an “asymmetric” effective third-order crossover for a three-way loudspeaker 207. A 2^{nd} order electrical crossover filter has been applied to the woofer, but a 1^{st} order electrical filter has been applied to the tweeter. In addition, a 2^{nd} order electrical crossover circuit has been applied to the midrange to rolloff the high frequencies, and a 1^{st} order electrical crossover circuit has been applied to the midrange to attenuate the low frequencies. For the right-hand loudspeaker, a capacitor 40 is connected in parallel with woofer 50; a capacitor 75 and an inductor 79 are each connected in parallel with midrange 90, which also has a capacitor 91 connected in series; and an inductor 44 is connected in parallel with tweeter 60, which also has a capacitor 74 connected in series with it, all as shown.

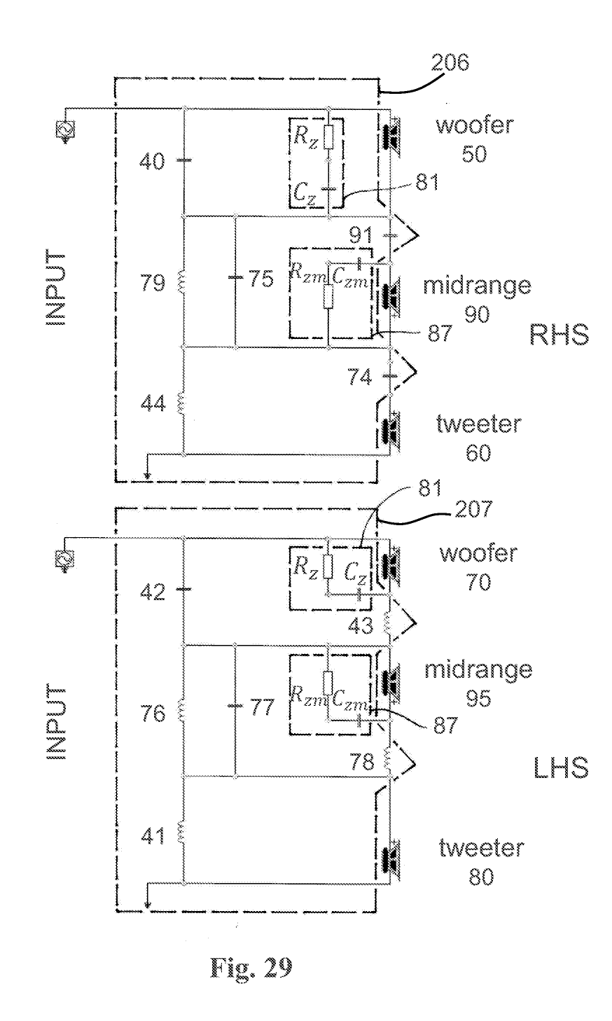

Applying Zobel circuits to the woofers and midranges often improves the efficacy of phase-unification and furnishes the seventeenth alternative embodiment of the present invention (FIG. 29). The voice coil inductance and DC resistance of the midrange differ from those of the woofer such that the values of the capacitor C_{zm} and resistor R_{zm} used in the midrange Zobel circuit 87 typically differ from C_{z} and R_{z} used in 81. The capacitor C_{zm} and resistor R_{zm} are connected in series to form 87, which is connected in parallel with midrange 90 and similarly connected to midrange 95. Occasionally one can phase-unify a three-way loudspeaker without Zobels or with only a Zobel applied to the woofer though the latter alternative embodiment is not shown here.

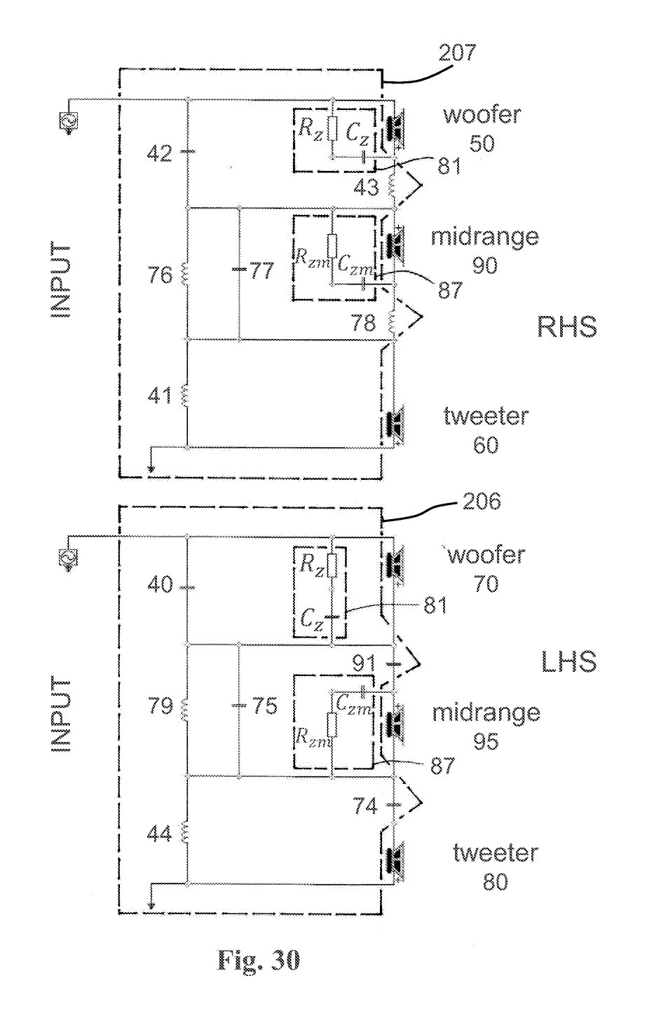

The eighteenth alternative embodiment of the present invention reverses the tweeter connections so that the positive terminal of the power supply is connected to the negative terminal of the tweeter to change the handedness so that the “asymmetric” effective third-order crossover is now applied to the loudspeaker system for the right channel and the “symmetric” effective third-order crossover to the loudspeaker system for the left channel (FIG. 30). Accordingly, a capacitor 42 is connected in parallel with woofer 50, which also has an inductor 43 connected in series with it. A capacitor 77 and an inductor 76 are each connected in parallel with midrange 90, which also has an inductor 78 connected in series. An inductor 41 is connected in parallel with tweeter 60. For the left-hand loudspeaker, a capacitor 40 is connected in parallel with woofer 70 and a capacitor 75 and an inductor 79 are each connected in parallel with midrange 95, which also has a capacitor 91 connected in series. Finally an inductor 44 is connected in parallel with tweeter 60, which also has a capacitor 74 connected in series with it, as shown. Zobel circuits are applied to both woofers and midranges as described for the seventeenth alternative embodiment. The circuit shortcuts and auxiliary circuits applied to previous embodiments can be adapted and applied to the fifteenth, sixteenth or seventeenth alternative embodiments to develop still more alternative embodiments, including changing tweeter polarity. Thevenin equivalences apply. The previous ideas and figures should also enable one to develop and modify effective third-, fourth-, fifth-, sixth-, etc. order crossover networks for two, three, fourth, fifth, etc.-way loudspeakers in accordance with previous embodiments of the present invention.

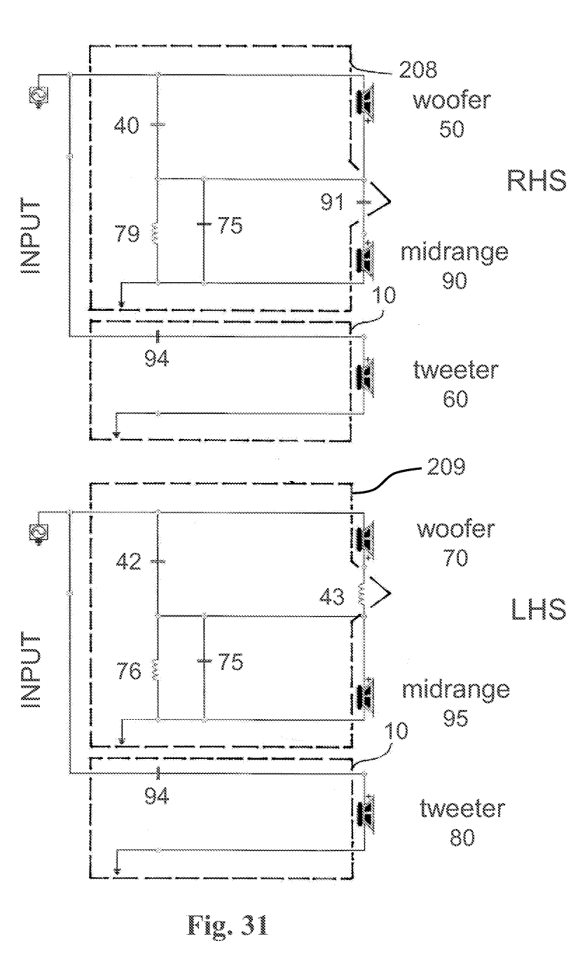

Sometimes the present art need only be applied to one crossover point in a loudspeaker system with more than two drivers to improve reproduction considerably. FIGS. 31-34 demonstrate this concept in a three-way system. In FIG. 31, the woofer-midrange crossover is phase-unified, but the midrange-tweeter crossover is not, forming the nineteenth alternative embodiment of the present invention. In FIG. 31, a capacitor 40 is connected in parallel with woofer 50 and a capacitor 75 and an inductor 79 are connected separately in parallel to midrange 90 as shown. Also a capacitor 91 is connected in series to midrange 90, all to form a “symmetric” effective third-order crossover between the midrange and woofer in a loudspeaker system 208, to distinguish this from 200. Capacitor 94 is connected in series with tweeter 60, which has the same polarity as 90. This part of the crossover network is the same for the both the RHS and LHS loudspeakers. A capacitor 42 is connected in parallel with woofer 70, which has an inductor 43 connected in series. Furthermore for the LHS loudspeaker, a capacitor 75 and an inductor 76 are connected separately in parallel with midrange 95. This forms an “asymmetric” effective third-order crossover between the midrange and woofer in a loudspeaker system 209, to distinguish this from 201. First order electrical filters are recommended for crossover frequencies other than the phase-unification frequency to minimize untoward phase effects. A series first order electrical low-pass filter is applied to all midranges in FIGS. 31-34; eq. (4) also gives the value of 75. A parallel first order electrical high-pass filter 10 is applied to all tweeters in FIGS. 31-34; eq. (3) also gives the value of 94. Though this crossover order is not necessary, it can diminish the lobing encountered with even order crossovers.

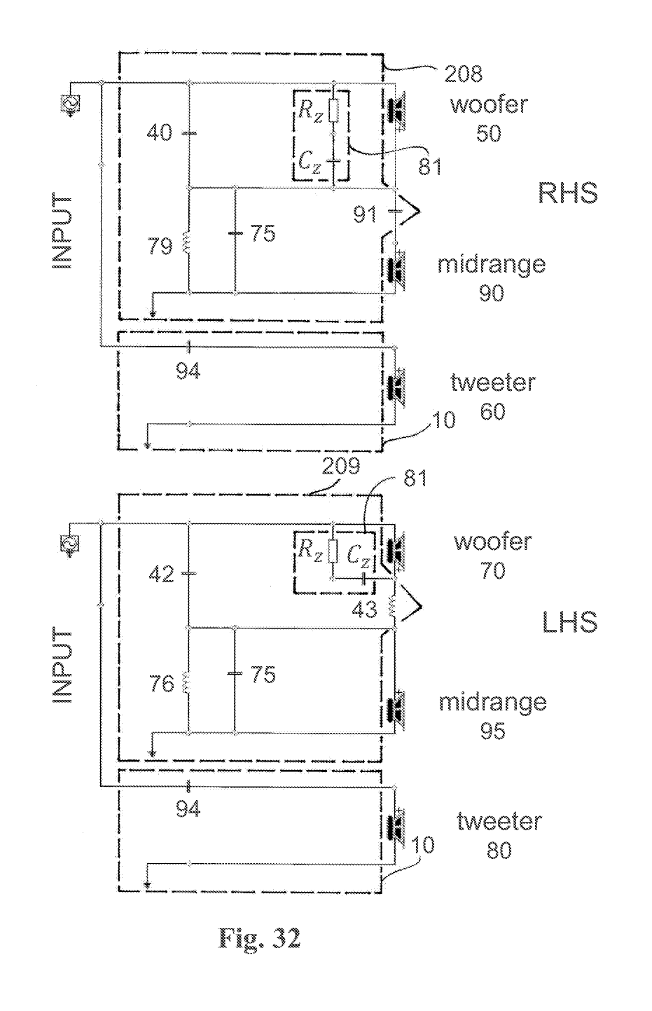

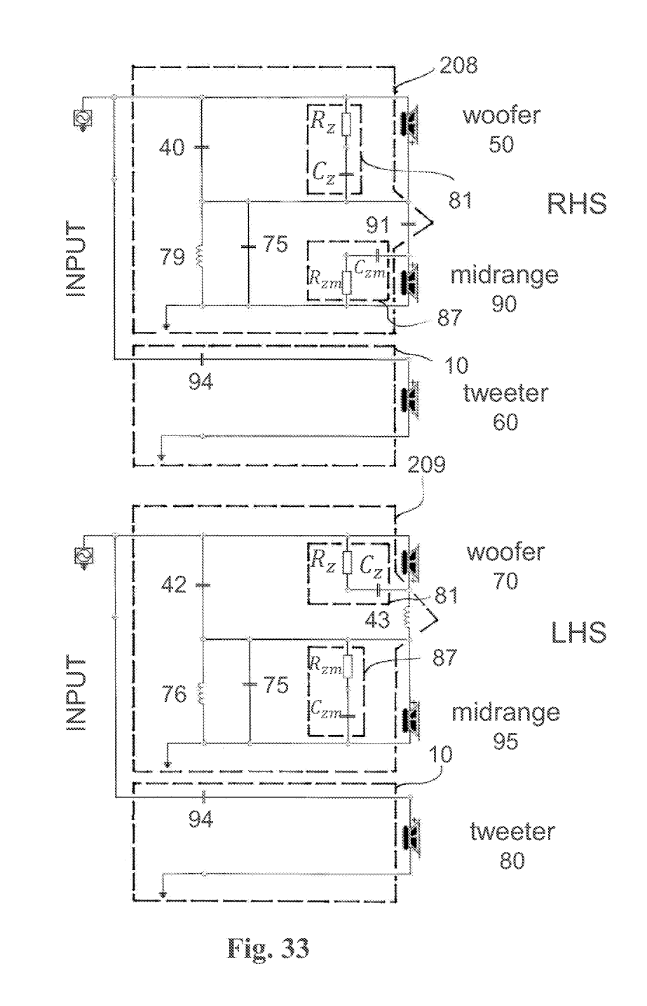

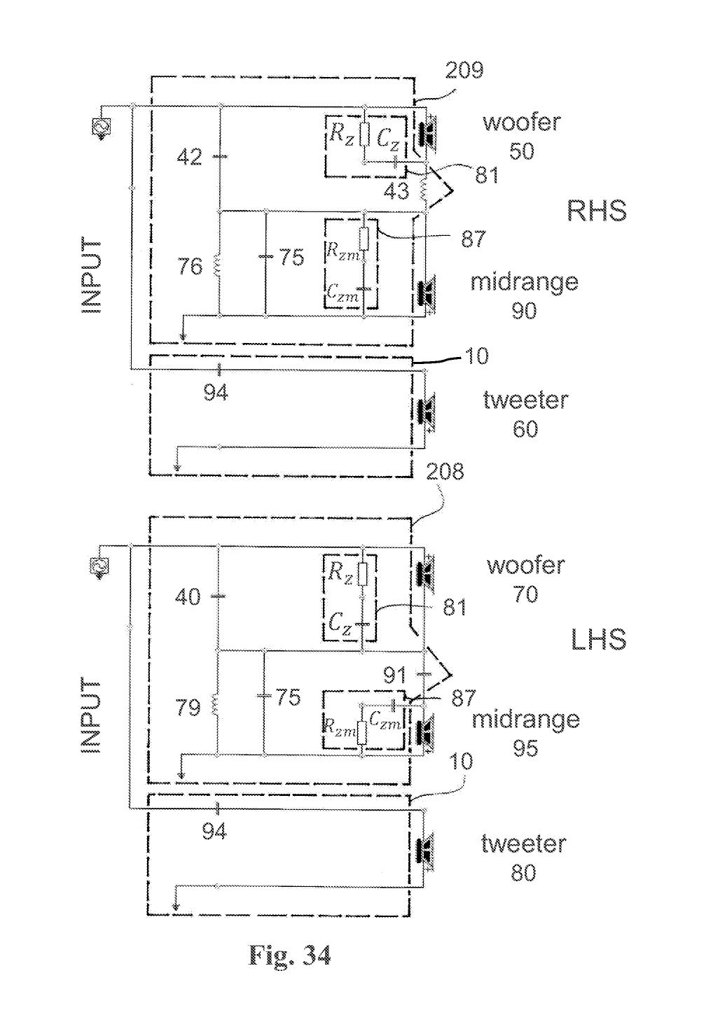

FIGS. 32 and 33 implement the aforementioned impedance-compensation circuits and combinations with this simplification to provide additional alternative embodiments of the present invention. For instance, the twentieth alternative embodiment applies the circuit 81 to each woofer (FIG. 32). In addition, the twenty-first alternative embodiment applies the circuit 87 to each midrange also (FIG. 33). The twenty-first alternative embodiment of the present invention connects the positive terminal of the power supply to the negative terminal of the tweeter to change the handedness so that the “asymmetric” effective third-order crossover is now applied to the loudspeaker system for the right channel and the “symmetric” effective third-order crossover to the loudspeaker system for the left channel (FIG. 34). The aforementioned shortcuts and auxiliary circuits can be applied to the nineteenth, twentieth, twenty-first and twenty-second alternative embodiments to develop more alternative embodiments. Phase-unification of merely one crossover frequency among multiple crossover frequencies is made more effective when the present invention is applied to a crossover point in the range of about 500 to 2000 Hz, as expected because these are the frequencies wherein the baffle step develops. At lower frequencies, loudspeaker output is essentially omnidirectional. However, when the baffle step starts, loudspeaker output becomes confined to the hemisphere in front of the loudspeaker and manifests lobing behavior. This principle can be extended to loudspeakers with higher crossover orders, three or more drivers, and greater than one phase unification frequency.

Drivers performing at the frequency extremes of the audio spectrum exhibit nearly ideal polar response in a loudspeaker system. Thus the present invention improves reproduction when only applied to one crossover point in a loudspeaker system with more than two drivers. The baffle step introduces significant lobing into the polar response of a driver manifesting the baffle step. However, in a loudspeaker, the woofer has nearly perfect polar response well below the baffle step and the tweeter has nearly perfect polar response for the uppermost two octaves, far removed from the baffle step. Accordingly a N-way loudspeaker with ν_{f} for the woofer or tweeter well-removed from ν_{b} would nonetheless phase-unify reproduction as long as phase-unification technology is applied to the νₓ nearest to ν_{b}.

Different effective crossover orders will phase-unify to some extent if the orders are both odd or both even. Furthermore this relationship can hold even if the right-hand side and left-hand side loudspeakers have different numbers of drivers. For instance, an effective 2^{nd} order two-way RHS system (RHS from FIG. 23) will phase-unify appreciably with an effective 4^{th} order two-way LHS system (LHS from FIG. 15). “Effective second-, fourth-, fifth-, sixth-, etc. order” three-way systems can be designed accordingly as well as fourth-, fifth-, sixth-, etc. way versions of the aforementioned systems to produce still additional alternative embodiments, particularly considering the addition of auxiliary circuits and the incorporation of circuit shortcuts.

2.5-Way to N.5-Way Phase-Unified Loudspeakers with Passive Crossovers

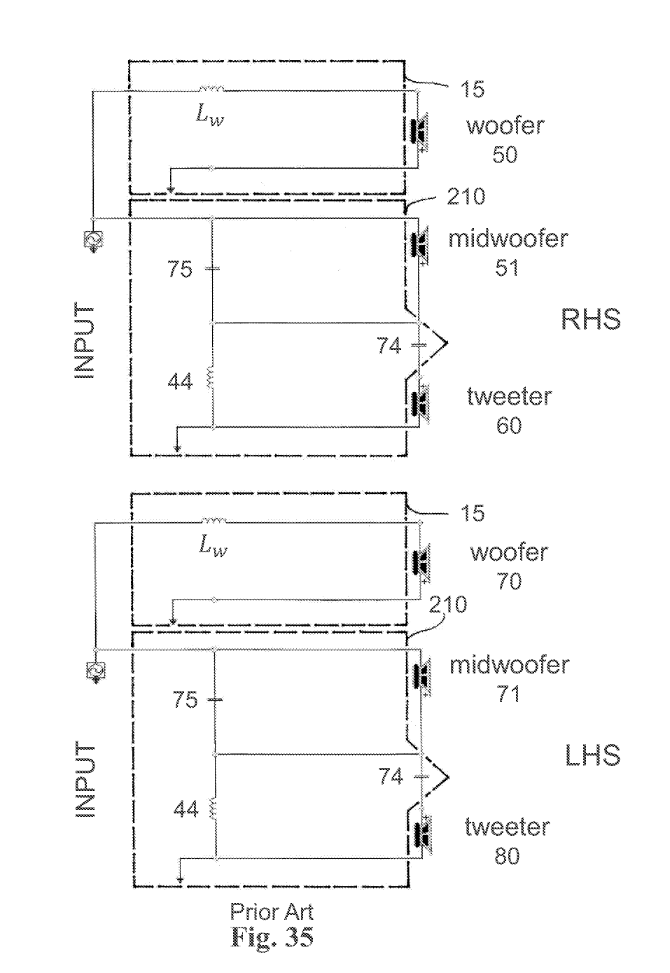

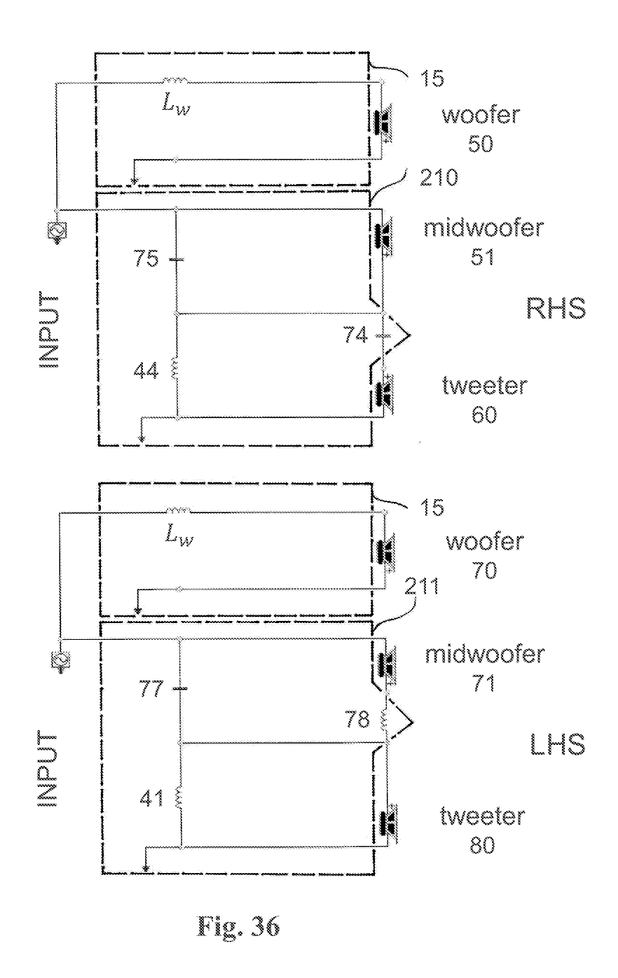

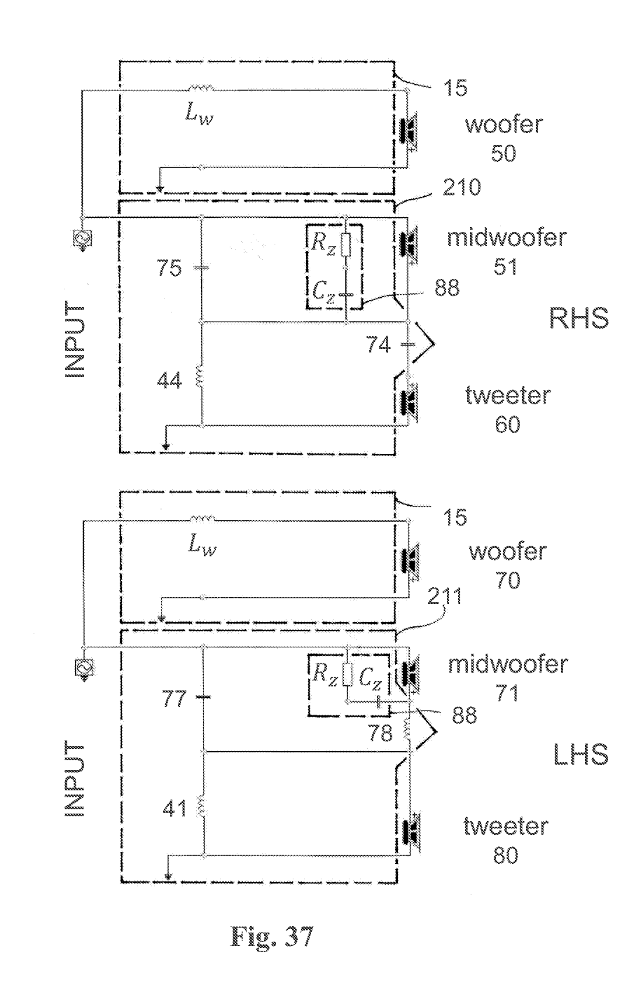

FIG. 36 shows the circuit schematic for the twenty-third alternative embodiment of the present invention: namely, the phase-unified effective third-order crossover for a 2.5-way loudspeaker system. Thus the 2.5-way loudspeaker for the right channel has a midwoofer 51 and tweeter 60 connected in series and the 2.5-way loudspeaker for the left channel has a midwoofer 71 and tweeter 80, also connected in series. Woofer 50 and woofer 70, however, are connected in parallel in the respective loudspeakers. Conventional 2.5-way loudspeakers have either parallel or series/parallel crossover circuits because in the latter, the woofer and midwoofer reproduce the same frequencies over a substantial range, unlike conventional series crossovers where the response overlap between different drivers is significantly smaller. The woofer and midwoofer are the same drivers. In a 2.5 way, the tweeter is nevertheless ordinarily crossed over to the midwoofer, with the woofer is rolled off at a lower frequency to provide bass boost and to correct for the baffle step. Accordingly in the twenty-third alternative embodiment of the present invention, an inductor L_{w} is connected in series with woofer 50 and a capacitor 74 is connected in series with tweeter 60, which also has an inductor 44 connected in parallel with it. A capacitor 75 is connected in parallel with midwoofer 51. This constitutes a “symmetric” effective third-order crossover between the midwoofer and tweeter in a 2.5-way loudspeaker in accordance with the prior art 210: namely, a 1^{st} order electrical crossover filter has been applied to the midwoofer, but a 2^{nd} order electrical filter has been applied to the tweeter. In FIG. 36, this crossover circuit is the same as the circuit in the prior art (FIG. 35). In FIG. 36, the crossover for the left-hand loudspeaker has an inductor L_{w} connected in series with woofer 70 and an inductor 41 is connected in parallel with tweeter 80. A capacitor 77 is connected in parallel with midwoofer 71, which also has an inductor 78 connected in series with it. This constitutes an “asymmetric” effective third-order crossover between the midwoofer and tweeter in a 2.5-way loudspeaker. A 2^{nd} order electrical crossover filter has been applied to the left-hand midwoofer, but a 1^{st} order electrical filter has been applied to the left-hand tweeter. Capacitor and inductor values are calculated as given by eqs. (3)-(6). The woofer crossover frequency is about 2.5 octaves below the baffle step frequency if a 1^{st} order electrical filter is used as shown in FIGS. 35 and 36. Different crossover orders can be selected for the midwoofer so that different crossover orders and frequencies are more suitable for the woofer. For example, the woofer crossover frequency is about 1.5 octaves below ν_{b} if a 2^{nd} order electrical filter is used. The principle is to apply an electrical filter to each woofer so that the output of the woofer for a given channel is about 12 dB below the output of the midwoofer for that channel. Circuit shortcuts and auxiliary circuits can be applied to the twenty-third alternative embodiment of the present invention for 2.5-way systems as previously demonstrated to develop more alternative embodiments; this includes Thevenin equivalences and changing tweeter polarity. For example, Zobels can be applied to all drivers although a Zobel on the midwoofer is often all that is needed to form the twenty-fourth alternative embodiment of the present invention (FIG. 37). The Zobel applied to the midwoofer is designated as 88 for purposes of clarification although the circuit is the same as 81. A parallel first order electrical low-pass filter 15 is applied to all woofers in FIGS. 35-37; eq. (4) also gives the value of L_{w}. “Effective fourth-, fifth-, sixth-, etc. order” 2.5-way systems can be designed accordingly as well as 3.5-, 4.5-, 5.5-, etc. way versions of the aforementioned systems to produce still additional alternative embodiments, particularly considering the addition of auxiliary circuits and the incorporation of circuit shortcuts.

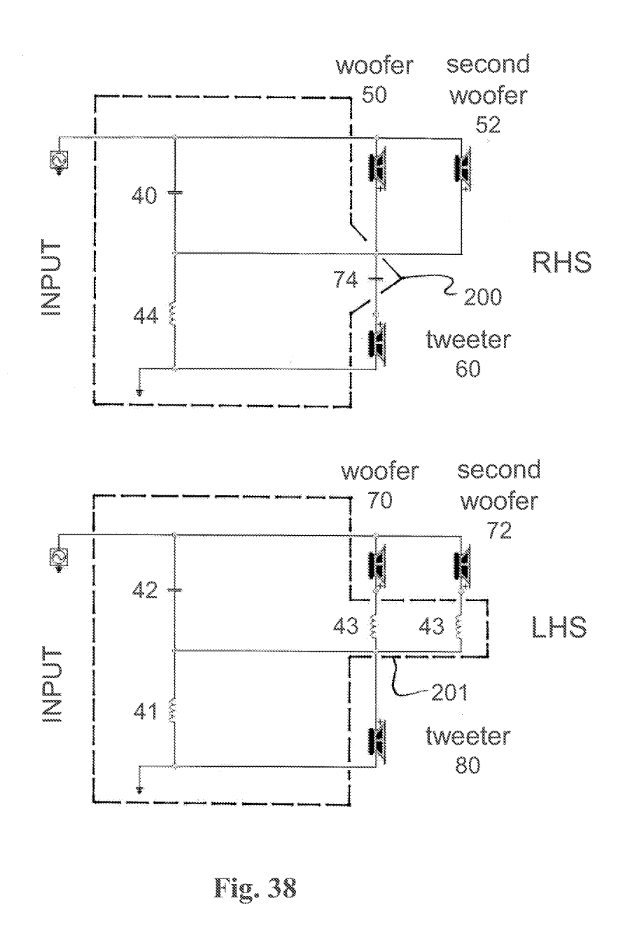

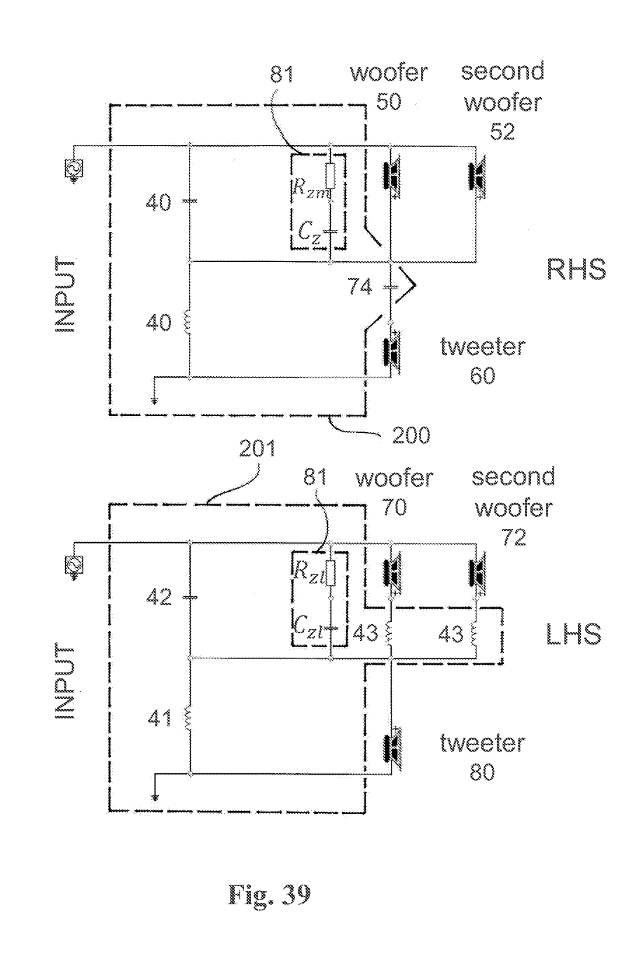

For the sake of discussion, a two-way loudspeaker can be built using two woofers and a tweeter, ostensibly resembling a 2.5-way. FIG. 38 depicts such a two-way, which is another manifestation of the first alternative embodiment of the present art (FIG. 6). In FIGS. 38 and 39, the two-way loudspeaker for the right channel has a woofer 50 and a tweeter 60 connected in series and the two-way loudspeaker for the left channel has a woofer 70 and a tweeter 80, also connected in series. The RHS loudspeaker also has a second woofer 52 connected in parallel to 50 and the LHS loudspeaker also has a second woofer 72 connected in parallel to 70. Accordingly the impedance and inductance of the woofer subdivision in either loudspeaker are halved. A tweeter impedance that matches the impedance of the woofer subdivision is preferred.

FIG. 39 applies Zobels to such a two-way, which is another manifestation of the third alternative embodiment of the present art (FIG. 9). Consequently the woofer Zobel 83 is applied to the entire woofer subdivision of the crossover (as demonstrated for the LHS woofer in FIG. 9), to damp this subdivision rather than merely the woofer. Note that for either loudspeaker, one Zobel circuit is applied to two woofers connected in parallel, with these two woofers subsequently connected in series to the tweeter. According to the laws of adding impedances, C_{z} doubles and R_{z} is halved, compared to the values calculated for the Zobel circuit applied to one woofer. In this case, one applies C_{zl} and R_{zl} across the LHS woofers, but C_{z} and R_{z} across the RHS woofers to demonstrate. To calculate, C_{zl} is roughly twice C_{z} and R_{zl} is roughly 1.25 times C_{z}. Finally FIGS. 38 and 39 handle baffle-step correction in a different manner than FIGS. 35-37. Accordingly FIGS. 38 and 39 use larger values of 40 and 43 respectively to correct for the baffle step.

Two-Way Phase-Unified Loudspeakers with Passive and Active or Digital Crossovers Combined

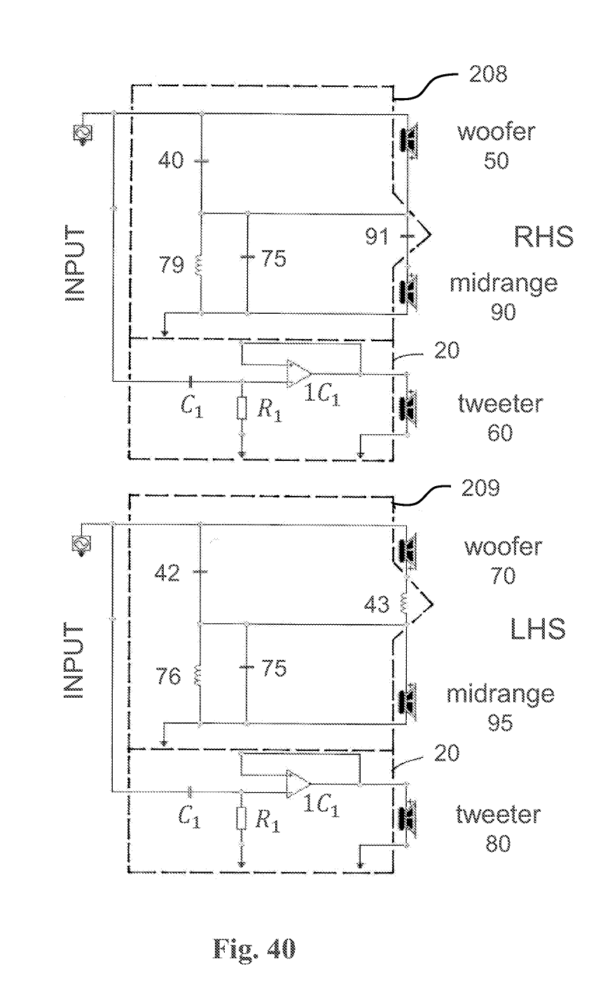

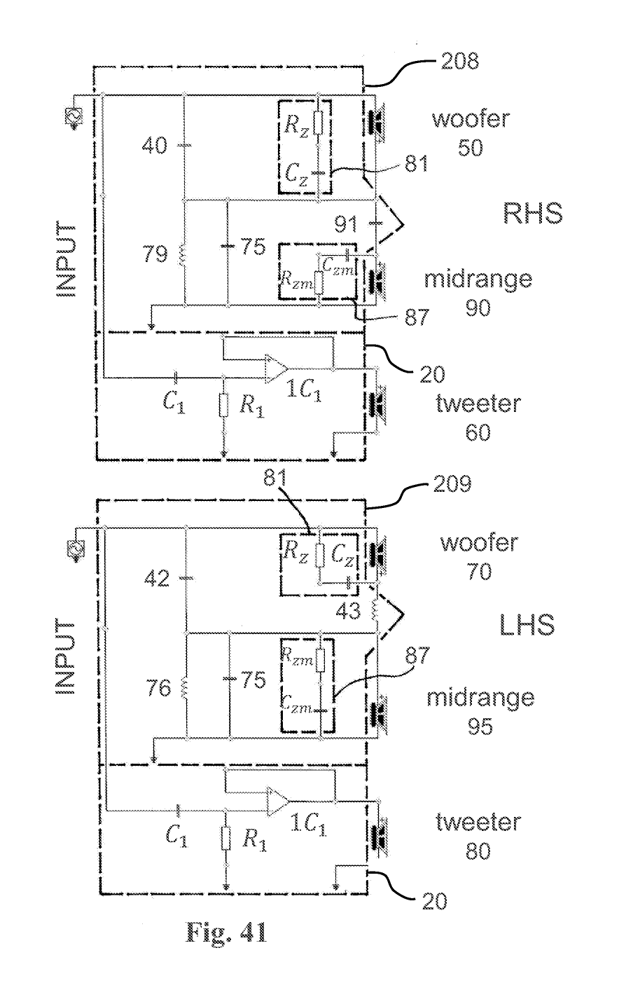

Series crossovers cannot be easily implemented with active crossovers or those based on digital signal processing (DSP). Virtual phase-unified loudspeakers nonetheless use series/parallel crossovers and can realize their parallel moiety with active or DSP. These developments can be applied to FIGS. 31-37. For instance, one can replace the passive filter 10 on the tweeters in FIG. 32 with an active filter 20 to form FIG. 40 and replace 10 on the tweeters in FIG. 33 with 20 to form FIG. 41 to constitute additional alternative embodiments.

Active crossover circuits ordinarily contain more elements than their passive counterparts. In the figures that follow, the optional equalization or delay circuit often found between the power amp and the actual filter in active crossover circuits is omitted for clarity. Similarly omitted are the power amp and the gain/sensitivity control matching. The Butterworth formula to determine R₁ and C₁, respectively the values of the resistor and capacitor used in the high-pass filter of a 1^{st} order electrical active crossover is

C₁=1/(2πR₁ν_{f}) (7)

FIG. 40 depicts such a filter applied to 60 and 80 to form the twenty-fifth alternative embodiment of the present invention, but is otherwise the same as FIG. 32. FIG. 41 depicts the active 1^{st} order electrical high-pass filter 20 applied to tweeters 60 and 80 to form the twenty-sixth alternative embodiment of the present invention, but is otherwise the same as FIG. 33, which applies Zobels to both the woofer and midrange. If higher order filters are desired, the Sallen-Key configuration, popular for over 50 years, can implement either an active 2^{nd} order electrical high- or low-pass filter. If an active 1^{st} order electrical low-pass filter were applied to each woofer in FIG. 37, the low-pass equivalent to eq. (7) should be used. Sequential sections can be added to increase the order of active crossover networks. For example, sequential 2^{nd} order Sallen-Key low- or high-pass filters can be connected in series to form still higher even-ordered electrical low- or high-pass filters respectively. Like all even-ordered electrical low- or high-pass filters, one can vary component values to vary ν_{f} and the damping. Sequential 1^{st} order active low- or high-pass filters can be connected in series to form still higher odd-ordered electrical low- or high-pass filters respectively.

Active crossover networks assuage many of the problems with driver reactivity, including tweeter ringing and unsteady woofer impedance, that their passive counterparts have. Active crossover networks nonetheless manipulate phase, time delay, resonance and crossover shaping, contouring and equalization in an easier manner than their passive counterparts. Zobel circuits can be implemented with a

R−j/(ωC)

active equivalent circuit in the twenty-fifth and twenty-sixth alternative embodiments of the present invention. High- and low-frequency equalization circuits can also be connected to an op amp to tailor driver response. Active crossovers can also implement notch filters and more sophisticated designs like Cauer elliptic filters. Shelving actions can be realized. Furthermore the circuit shortcuts and auxiliary filters applied to previous embodiments can be adapted and applied to the twenty-fifth and twenty-sixth alternative embodiments to develop more alternative embodiments, including changing tweeter polarity. These principles can be extended to loudspeakers with higher active crossover orders, two or more drivers, and greater than one phase unification frequency.

Aforementioned passive electronic and active electronic crossovers in the present art can be combined to form series/parallel phase-unified loudspeakers with composite crossovers. To form still more composite crossovers in the present art, crossovers consisting of passive and active components can be combined with digital signal processing or any type of DSP circuitry therewith. DSP can be used to implement any crossovers with slopes corresponding to the prior or present art. DSP can also be used to implement crossovers with slopes of 84 dB/octave or even higher. Popular DSP units include the DBX Dolby Lake Contour DSP or the Behringer DCX2496.

Line-Array Phase-Unified Loudspeakers with Passive Crossovers

The present art can be applied to line-array loudspeakers. Line-array loudspeakers use multiple identical drivers for each frequency band to increase efficiency and power handling. Furthermore multiple small woofers provide the same bass impact as one large woofer, but with superior transient response. Line-array loudspeakers provide stereo images that are more stable than those from more conventional designs. The configuration for line-array loudspeakers is nearly always stereo-imaged.

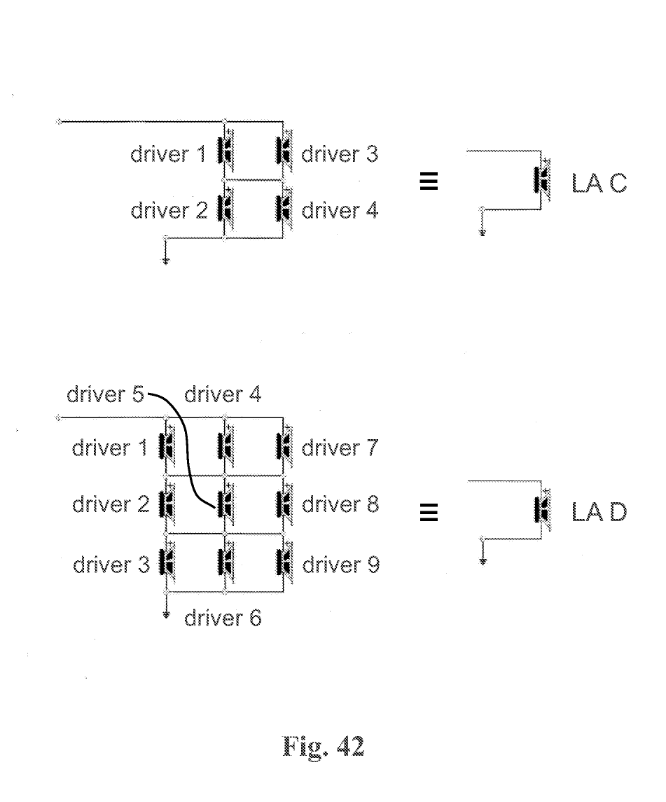

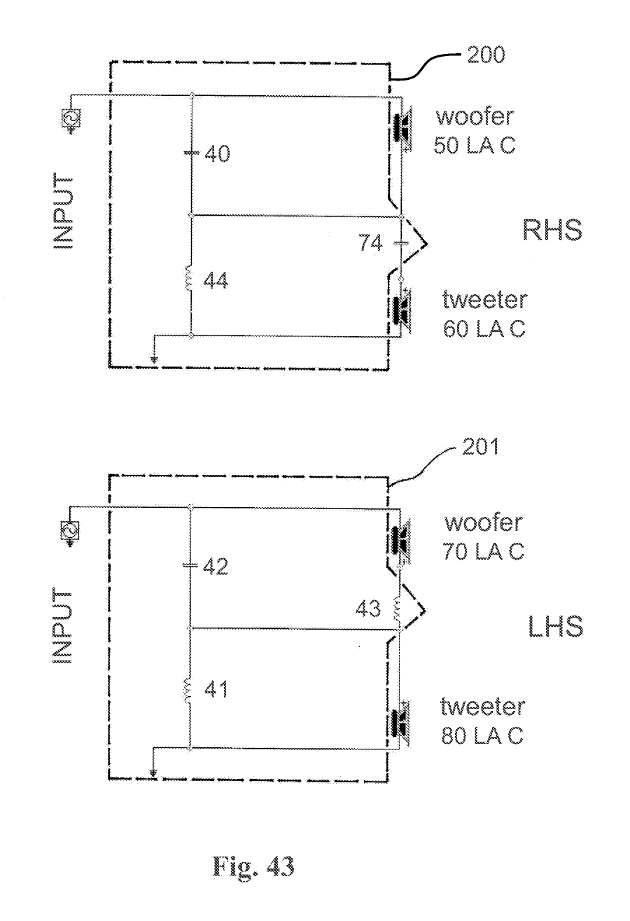

FIG. 42 shows the typical driver arrays that constitute line arrays. The constituent driver subunits are connected in series and in parallel to provide the same impedance as a single driver subunit. For example, take a line array consisting of one four-driver arrangement. Two drivers are connected in series to form a “driver section”. Two driver sections are thus connected in parallel to form a series-parallel arrangement comprised of four drivers, but with the same impedance as an individual driver. LA D provides the same impedance though with driver sections consisting of 3 individual drivers to form a series-parallel arrangement comprised of nine total drivers. Series-parallel arrangements exhibiting 50, 67, 75, 125, 133%, etc. of the impedance of a single driver subunit can also be employed as needed. Although LA C and D consist of 4 and 9 driver subunits respectively, LA C and D can themselves be repeatedly connected to form line-array loudspeakers with more than 30 drivers handling each frequency band. When a driver array is used in FIGS. 43-48 instead of single driver, the driver name and number are followed by the appropriate definition given in FIG. 42. For example, when a 4 driver subunit is instead of the woofer in the RHS loudspeaker, the appropriate symbol in FIG. 42 is used and the subunit is indicated as “woofer 50 LA C”.

FIG. 43 provides the twenty-seventh alternative embodiment of the present invention and shows a capacitor 40 connected in parallel with woofer 50 LA C and an inductor 44 is connected in parallel with tweeter 60 LA C, which also has a capacitor 74 connected in series with it. FIG. 43 thus constitutes a series “symmetric” effective third-order crossover for a two-way loudspeaker: namely, a 1^{st} order electrical crossover filter has been applied to the woofer, but a 2^{nd} order electrical crossover filter has been applied to the tweeter. The RHS crossover network for the present art is consequently in accordance with the prior art, but FIG. 43 shows that the LHS crossover network is not in accordance. An inductor 43 is therefore connected in series with woofer 70 LA C, which also has a capacitor 42 connected in parallel with it, and an inductor 41 is connected in parallel with tweeter 80 LA C. This constitutes a series “asymmetric” effective third-order crossover for a two-way loudspeaker 201. A 2^{nd} order electrical crossover filter has thus been applied to the left-hand woofer, but a 1^{st} order electrical crossover filter has been applied to the left-hand tweeter. Thevenin equivalences apply, as demonstrated below for crossovers with higher effective orders. In FIGS. 43-45, the two-way loudspeaker for the right channel has a woofer 50 and a tweeter 60 connected in series and the two-way loudspeaker for the left channel has a woofer 70 and a tweeter 80, also connected in series.

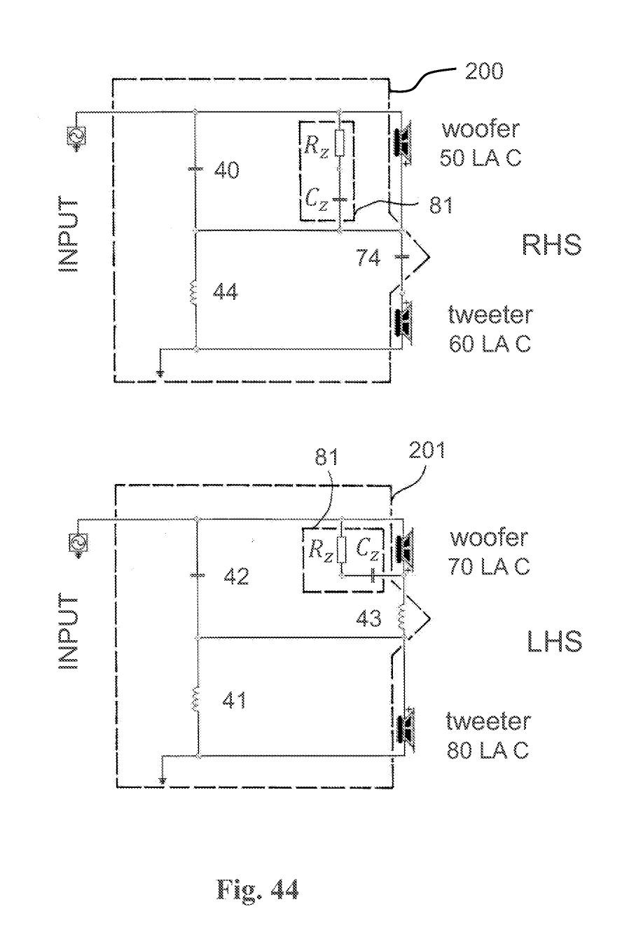

Complimentary crossover networks are therefore used in the RHS and LHS line-array loudspeakers to phase-unify their reproduction. A symmetric effective crossover for the line-array loudspeaker in one channel and an asymmetric effective crossover of the same order for the line-array loudspeaker in the other channel comprise said complimentary crossover networks, phase-unifying reproduction in accordance with the aforementioned handedness rules. Ordinarily an effective crossover can be 3^{rd} order or of a higher order, which is theoretically unlimited, simply depending upon the number of crossover elements used. FIG. 44 shows the twenty-eighth alternative embodiment, constituting an effective third-order crossover circuit for a two-way line-array loudspeaker system, in which a Zobel 81 is connected in parallel with woofer 50 and similarly connected to woofer 70. Alternative embodiments use auxiliary circuits, circuit shortcuts, more drivers and/or different effective crossover orders. For instance, FIG. 43 shows the crossover network without a Zobel, to form the twenty-seventh alternative embodiment of the present invention. Although most parallel phase-unified two-way loudspeakers apply a Zobel circuit to the woofer, the twenty-seventh alternative embodiment will phase-unify some loudspeakers, particularly those using woofers not heavily subject to cone breakup and peaked response at higher frequencies.

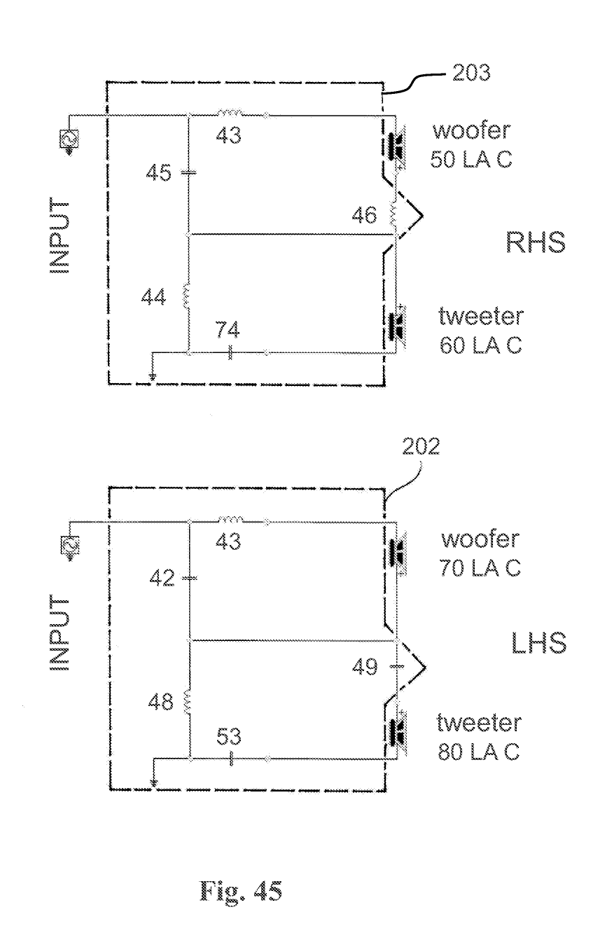

The handedness changes when even effective crossover orders are used to phase-unify line-array loudspeakers. FIG. 45 provides the schematic for an effective fourth-order crossover in the prior art, which applies a 2^{nd} order electrical crossover filter to the woofer, but a 3^{rd} order electrical crossover filter to the tweeter to constitute a series symmetric effective fourth-order crossover for a two-way loudspeaker 202. FIG. 45 provides the schematics for a phase-unified effective fourth-order crossover and the twenty-ninth alternative embodiment of the present invention. An inductor 46 is connected in series with woofer 50 LA C, which also has capacitor 45 connected in parallel and another inductor 47 connected in series as shown. Also a capacitor 74 is connected in series with tweeter 60 LA C, which also has an inductor 44 connected in parallel. This constitutes a series asymmetric effective fourth-order crossover for a two-way loudspeaker 203: namely, a 3^{rd} order electrical crossover filter has been applied to the woofer, but a 2^{nd} order electrical crossover filter has been applied to the tweeter. An inductor 43 is connected in series with woofer 70 LA C as shown and a capacitor 42 connected in parallel. A capacitor 49 is connected in series with tweeter 80 LA C, which also has an inductor 48 connected in parallel and another capacitor 53 connected in series as shown. Capacitor and inductor values are calculated according to the conventional formulae for designing 2^{nd} and 3^{rd} order electrical filters, e.g. respectively Bessel and Butterworth. Other filter formulae can be used to either increase damping (e.g. Linkwitz-Riley) or decrease damping (e.g. Chebychev), as the user deems fit.

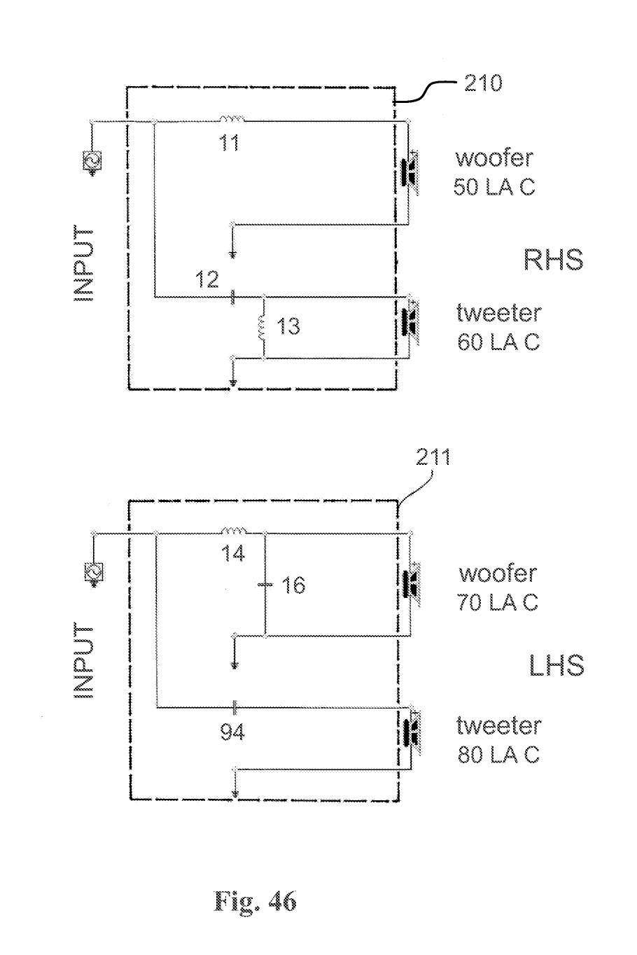

Parallel crossovers can also be phase-unified. FIG. 46 therefore shows the thirtieth alternative embodiment of the present invention. In FIG. 46, 11 is the first inductor connected in series to 50 LA C, 12 is the first capacitor connected in series to 60 LA C and 13 is the first inductor connected in parallel to 60 LA C for the RHS crossover network in the present art. FIG. 46 thus constitutes a parallel symmetric effective third-order crossover for a two-way loudspeaker 210: namely, a 1^{st} order filter has been applied to the woofer, but a 2^{nd} order filter has been applied to the tweeter. FIG. 46 also shows that in the LHS crossover, a first series inductor 14 is connected to woofer 70 LA C, which also has a first parallel capacitor 16 connected, and a first series capacitor 94 is connected to tweeter 80 LA C. This constitutes a parallel asymmetric effective third-order crossover for a two-way loudspeaker 211. A 2^{nd} order filter has thus been applied to the LHS woofer, but a 1^{st} order filter has been applied to the LHS tweeter.

Crossover component values are calculated according to the conventional equations defining the half-power, or −3 dB point, (i.e. attenuation) frequency ν_{f} for designing electrical filters of a given order. For example, for parallel 1^{st} order electrical filters, e.g. Butterworth, the equations (3) and (4) depict capacitor and inductor values respectively. The convention for ν_{f} also differs for parallel even-ordered electrical filters because the damping differs. The conventional equations for designing a parallel 2^{nd} Butterworth electrical filter are

C=l/(2πZν_{f}√2) (8)

L=Z√2(2πν_{f}) (9)

and are used to calculate crossover component values where warranted. Other filter equations can be used to either increase damping (e.g. Linkwitz-Riley) or decrease damping (e.g. Chebychev), as the user deems fit. The negative terminals of the tweeters are connected to the negative terminals of the power supply in phase-unified loudspeakers, unless otherwise noted. In FIG. 46 and other embodiments of the present invention, capacitors, resistors and inductors used are typically numbered differently. This convention is warranted because a given crossover element used in the crossover network for the RHS loudspeaker is typically not equal in value to that element used in the crossover network for the LHS loudspeaker. For example, in FIG. 46, the value of the first series inductor applied to 50 LA C is given by eq. (4), but the value of the first series inductor applied to 70 LA C is given by eq. (8). In FIGS. 46-48, the two-way loudspeaker for the right channel has a woofer 50 LA C and a tweeter 60 LA C connected in parallel and the two-way loudspeaker for the left channel has a woofer 70 LA C and a tweeter 80 LA C, also connected in parallel.

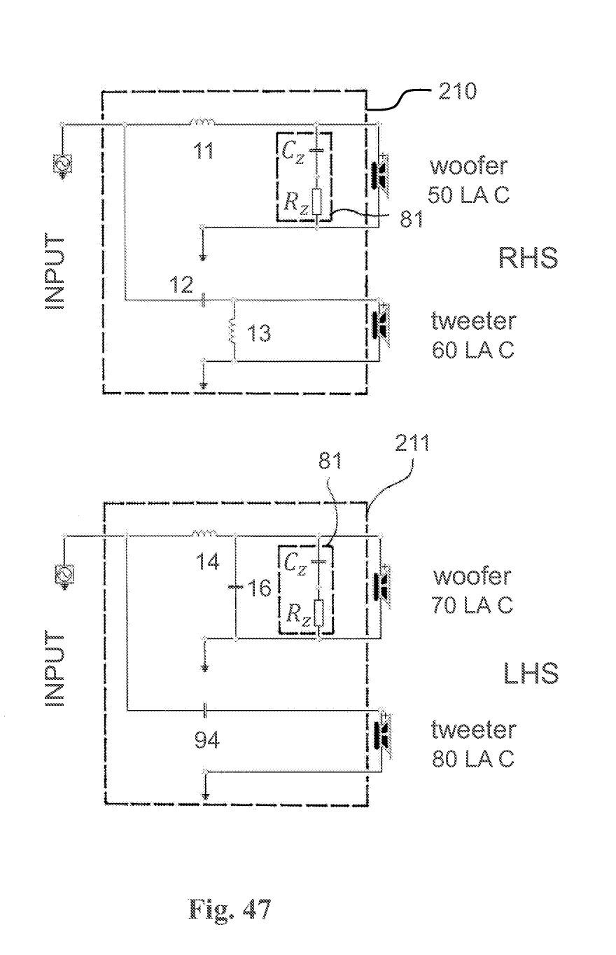

FIG. 47 shows the effective third-order crossover for a two-way loudspeaker system, with a Zobel network applied to the woofer, in accordance with the thirty-first embodiment of the present invention: a capacitor C_{z} and resistor R_{z} are connected in series to form the Zobel 81, which is connected in parallel with woofer 50 LA C and similarly connected to woofer 70 LA C. Alternative embodiments use auxiliary circuits, circuit shortcuts, more drivers and/or different effective crossover orders. Although most parallel phase-unified two-way loudspeakers apply a Zobel circuit to the woofer, the thirtieth alternative embodiment will phase-unify some loudspeakers, particularly those using woofers not heavily subject to cone breakup and peaked response at higher frequencies.

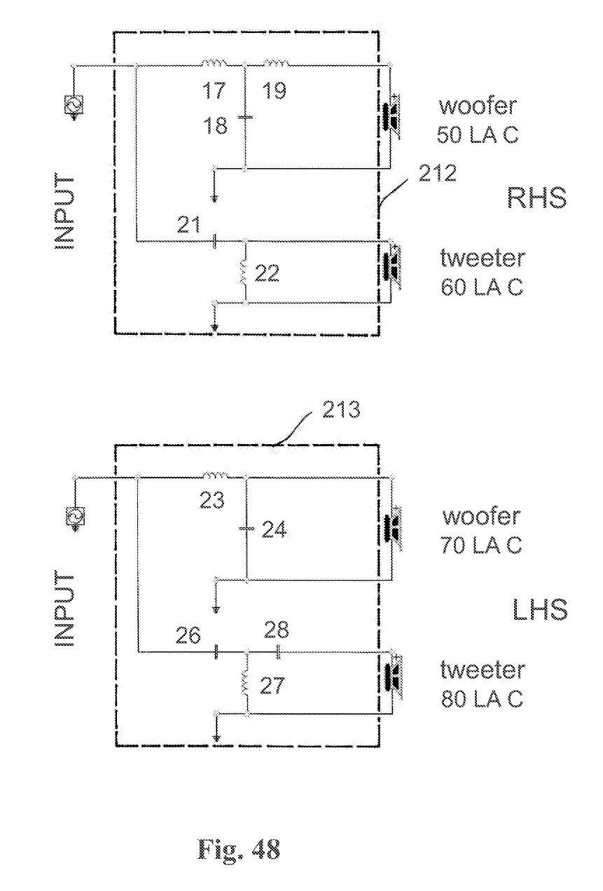

The handedness changes when the effective crossover orders are even for phase -unified parallel crossovers. FIG. 48 provides the schematics for a parallel phase-unified effective fourth-order crossover and the thirty-second alternative embodiment of the present invention. Therefore the first inductor connected in series to 50 LA C is 17 and the first capacitor connected in series to 60 LA C is 21. The first capacitor connected in parallel to 50 LA C is 18, the second inductor connected in series to 50 LA C is 19 and the first inductor connected in parallel to 60 LA C is 22. This constitutes a parallel asymmetric effective fourth-order crossover for a two-way loudspeaker 212: namely, a 3^{rd} order filter has been applied to the woofer, but a 2^{nd} order filter has been applied to the tweeter. In addition, the first inductor connected in series to 70 LA C is 23 and the first capacitor connected in series to 80 LA C is 26. The first capacitor connected in parallel to 70 LA C is 24, the first inductor connected in parallel to 80 LA C is 27 and the second capacitor connected in series to 80 LA C is 28 in a parallel symmetric effective fourth-order crossover for a two-way loudspeaker 213. Capacitor and inductor values are calculated according to the conventional equations for designing 2^{nd} and 3^{rd} order electrical filters, e.g. Bessel and Butterworth.

“Effective fifth-, sixth-, seventh-, etc. order” two-way line-array loudspeaker systems can be phase-unified applying previous developments and form still more alternative embodiments. Also third-, fourth-, fifth-, sixth-, etc. way versions of the aforementioned systems produce even more alternative embodiments, particularly considering the addition of auxiliary circuits and the incorporation of circuit shortcuts. Series or parallel crossovers can be used. Furthermore one can virtually phase-unify line-array loudspeaker systems. Finally line-array loudspeaker systems can use single drivers for designated frequency bands. For example, a three-way line-array loudspeaker can use line arrays to reproduce the high and midrange frequencies, but a single woofer to reproduce the low frequencies. Employing the d'Appolito configuration, a two-way line-array loudspeaker can use a single tweeter to reproduce the high frequencies, but a line array to reproduce the remaining frequencies. These and analogous loudspeaker systems can be phase-unified and virtually phase-unified using the aforementioned principles.

### Vertical Polar Responses of Two-Way Phase-Unified Loudspeakers

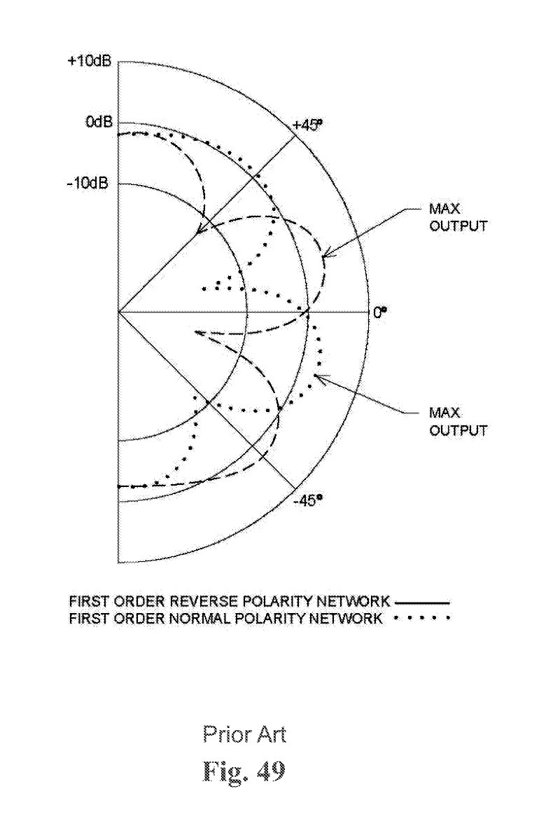

FIGS. 49-52 show vertical polar responses for the prior and present art to distinguish the acoustics of the latter. These figures basically depict the vertical cross-section of a given loudspeaker's response into the hemisphere in front of the loudspeaker. The figures provide output levels from a given loudspeaker, ranging from approximately −10 dB to +10 dB. The vertical cross-section of the hemisphere in front of a given loudspeaker forms a semicircle as these figures show, and the angles are enumerated from −90 degrees to +90 degrees to facilitate appraising the tilt in the VPR. The loudspeaker in these figures points to the right with the tweeter towards the top of the front baffle and the woofer towards the bottom. A driver, often a woofer, operating well below ν_{b} would exhibit outstanding vertical polar response, which would approximate a semicircle along the 0 dB level if centered at the woofer in FIGS. 49-52. The main divergence from outstanding VPR is lobing, behavior where the VPR fluctuates between levels above and below 0 dB due to the interference between drivers. The greater the VPR extrema, the greater the lobing.

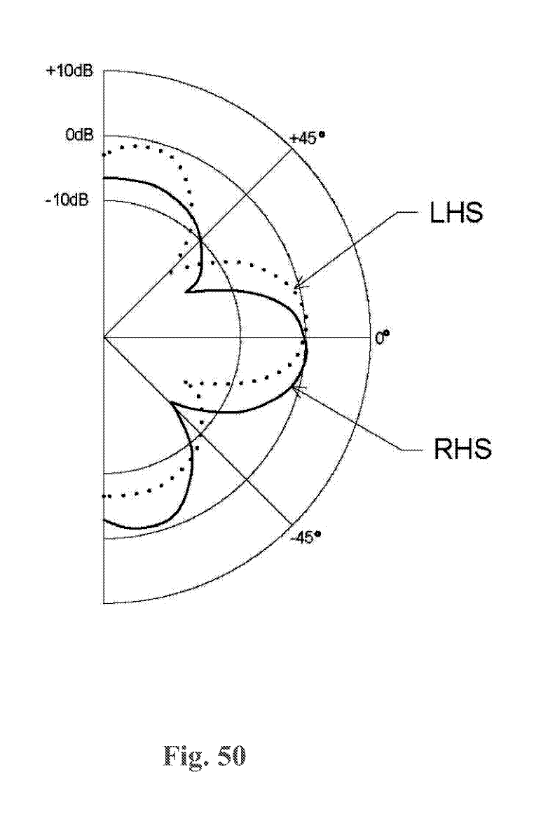

The present art will be depicted with the negative terminal of the tweeter connected to the negative terminal of the power supply for this discussion. To resume, a two-way with a 1^{st} order electrical crossover in the prior art has a downward tilt in its vertical polar response, but reversing tweeter polarity tilts the response upward (FIG. 49). An analysis of an effective third-order crossover in the present art reveals the RHS channel for a two-way has a symmetric crossover and displays a vertical polar response at ν_{b} that tilts slightly downward (FIG. 50). This crossover applies a slope of 18 dB/octave to each driver, a slope reflective of a 3^{rd} order crossover, an odd order. Of the two RHS drivers, the tweeter displays the higher VPR output. The LHS channel for this loudspeaker system has an asymmetric effective third-order crossover in the present art and displays a vertical polar response that tilts slightly, albeit upward. In contrast, this crossover applies a slope of 12 dB/octave to the tweeter, but of 24 dB/octave to the woofer, slopes reflective of respective 2^{nd} and 4^{th} order electrical crossovers, even orders. Of the two LHS drivers in this loudspeaker with an asymmetric effective third-order crossover, the woofer displays the higher VPR output. The polar responses of the two channels fit together to phase-unify reproduction, facilitated by the effective crossover orders modifying lobe structures as shown. When the lobe amplitude in the RHS VPR increases, the lobe amplitude in the LHS VPR typically decreases and vice-versa. The application of attenuating resistors (VPRs not shown) to the loudspeakers depicted in FIG. 50 would cause the downward tilt of the RHS VPR to decrease while the upward tilt of the LHS VPR would also begin to decrease by nearly the same amount, depending on how much attenuation in phase unification is desired. As the tilts in the RHS and LHS VPR become similar, phase unification is attenuated.

The symmetric and asymmetric effective crossovers in the present art induce substantial output in between two individual loudspeakers as a basis to phase-unify. The vertical polar responses for other effective crossover orders in the present art are described in a related manner. For instance, symmetric odd effective crossover orders retain their downward tilt although the lobe structure changes as the crossover order changes.

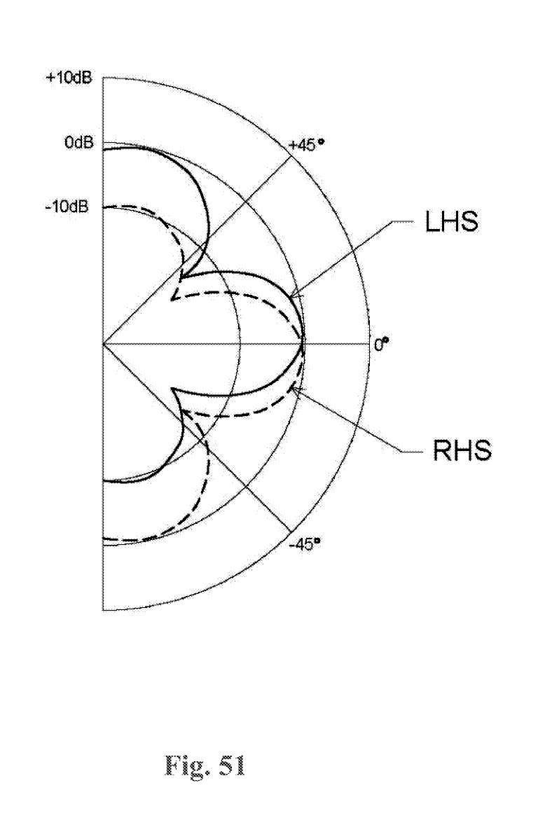

The vertical polar responses for symmetric even effective crossover orders in the present art tilt upward. The vertical polar responses for the latter loudspeaker systems nonetheless modify their lobe structures to generate phase-unification. FIG. 51 demonstrates this for an effective fourth-order two-way loudspeaker system according to the present art. Accordingly the LHS channel for this loudspeaker system has a symmetric effective fourth-order crossover and displays a vertical polar response at ν_{b} that tilts slightly upward. This crossover applies a slope of 24 dB/octave to each driver, a slope reflective of a 4^{th} order crossover, an even order. Of the two LHS drivers in this loudspeaker with a symmetric effective fourth-order crossover, the tweeter displays the higher VPR output. The RHS channel for a two-way has an asymmetric effective fourth-order crossover in the present art and displays a vertical polar response that tilts slightly downward. Of the two RHS drivers in this 2-way loudspeaker, the woofer displays the higher VPR output.

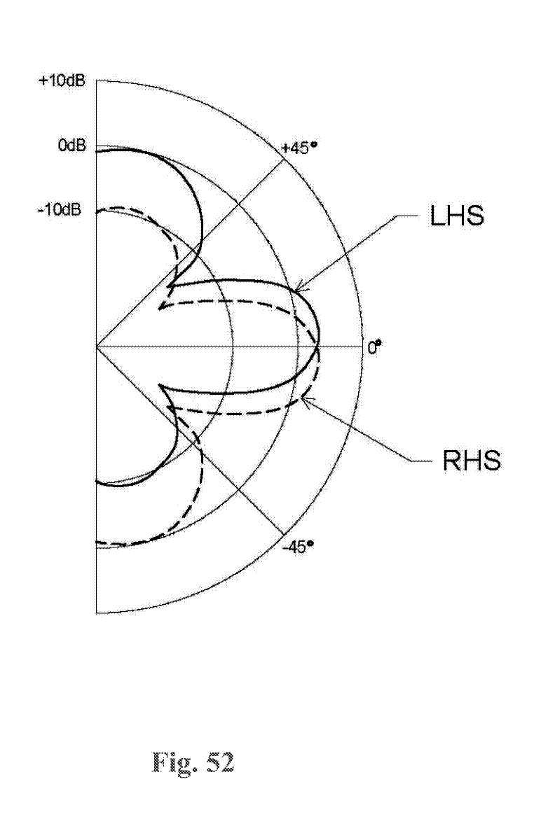

Accordingly the RHS channel for a two-way has an asymmetric effective second-order crossover in the present art and displays a vertical polar response at ν_{b} that tilts slightly downward (FIG. 52). Of the two RHS drivers in this 2-way, the woofer displays the higher VPR output. The lobe structure in FIG. 52 resembles the lobe structure in FIG. 51 except that the center lobe is slightly longer and narrower in FIG. 51. The LHS channel for this loudspeaker system has a symmetric effective second-order crossover and displays a vertical polar response that tilts slightly upward. Of the two LHS drivers in this 2-way, the tweeter displays the higher VPR output. The modified lobe structure in the present art enables different even effective orders with different numbers of drivers to phase-unify with each other to some extent because the VPR in the RHS channel will tilt downward slightly and the VPR in the LHS channel will tilt upward slightly so that complimentary substantial output in between two individual loudspeakers is achieved. A similar principle applies to loudspeakers with different odd effective orders and different numbers of drivers. Note that increasing the crossover order decreases lobing.

Shifting the effective order in the present art from odd to even shifts the vertical polar response for the symmetric crossover from tilted downward to tilted upward and shifts the VPR of the asymmetric crossover from tilted upward to tilted downward. This explains the change in handedness needed to phase-unify when one shifts from odd to even effective crossover orders. This also explains the shift in handedness to phase-unify when one shifts from connecting the negative tweeter terminal to the negative terminal of the power supply to connecting the positive tweeter terminal to the negative terminal of the power supply. FIG. 49 shows that reversing the polarity for a given loudspeaker and crossover shifts the tilt from down to up.

### Additional Concepts

Phase-unification can be applied to unusual baffle configurations that have become popular. For instance, the d'Appolito configuration is often applied to 2.5 ways and can be phase-unified in a straightforward manner. Two 2.5 way loudspeakers with the d'Appolito configuration would be phase-unified if the left-hand loudspeaker had an antisymmetric effective third-order crossover between its midwoofer and tweeter and the right-hand loudspeaker had a symmetric effective third-order crossover between its midwoofer and tweeter and if the tweeter negative terminals are connected to the negative terminals of the power supply, all as previously described. The preferred embodiments of the present art can be adapted to line array loudspeakers containing many drivers: tweeters as well as midranges and woofers. When applied to these novel configurations, the present art typically imparts performance over and beyond the performance of the respective configuration.

Finally the application of unusual baffle configurations foreshadows phase-unified home-theater and quadraphonic loudspeaker systems, wherein the number of and type of drivers in each loudspeaker can differ. For instance, it has been determined that a 2.5-way with a d'Appolito configuration and a 2^{nd} order electrical crossover will phase-unify to some extent with a RHS two-way, with a symmetric effective third-order crossover, if the tweeter negative terminals are connected to the negative terminals of the power supply. Phase-unifying this 2.5-way with a dissimilar loudspeaker implies a rule. Therefore a 2.5-way with a d'Appolito configuration and a 4^{th} order electrical crossover will phase-unify to some extent with a RHS two-way, with a symmetric effective fifth-order and so forth for higher RHS crossover orders. A rule exists for phase-unifying a RHS two-way using a symmetric effective crossover and an odd order with a 2.5-way loudspeaker using the d'Appolito configuration d′ and a definite even-order electrical crossover. The existence of this rule implies the existence of a rule for phase-unifying a RHS two-way using an asymmetric effective crossover and an even order with a 2.5-way loudspeaker using the d'Appolito configuration and a definite odd-order electrical crossover. The vertical polar response of the d'Appolito configuration is responsible for these rules. For instance, the symmetric vertical polar response at ν_{b} of the d'Appolito configuration for a 2.5-way simulates the symmetric vertical polar response at ν_{b} of a LHS two-way with an asymmetric crossover and an odd effective order, if the electrical crossover between the midwoofer and tweeter in the 2.5-way is even-ordered according to the aforementioned rules. Moreover implied is a rule for phase-unifying a RHS three-way using a symmetric effective crossover and an odd order with a 3.5-way loudspeaker using the d'Appolito configuration and a definite even-order electrical crossover, and a rule for phase-unifying the 3.5-way d'Appolitio that has an odd-order electrical crossover. Further implied are rules for phase-unifying a RHS n-way loudspeaker with a n.5-way d'Appolito loudspeaker, depending on the order of the electrical crossover in the latter.

### Review of the Underlying Concepts

### DESIGN EXAMPLES

A phase-unified effective 3^{rd} order crossover was applied to a two-way loudspeaker system, each using a cabinet with outer dimensions 22″(H)×12″(W)×9.5″(D). An Acoustic Research 8″ woofer, AR1210132-1A, was mounted on this cubic foot enclosure that was ported, along with a Vifa ring-radiator tweeter, XT25SC30-04. The baffle step was corrected using a larger shunt C, properly tuned in the RHS woofer and using an inductor in series with the LHS woofer. The R in parallel with the L in the typical RL circuit for such was omitted because the R merely reduces the slope of the L rolloff.

A phase-unified effective 4^{th} order crossover was applied to a two-way loudspeaker system, each also using a cabinet with outer dimensions 22″(H)×12″(W)×9.5″(D). An Acoustic Research 8″ woofer, AR1210132-1A, was mounted on this cubic foot enclosure that was ported, along with a Vifa ring-radiator tweeter, XT25SC90-04. The baffle step was corrected using a larger shunt C, properly tuned in either woofer.

A phase-unified effective 2^{nd} order crossover was applied to two-way loudspeaker system that used a cabinet with outer dimensions 20.5″(H)×9″(W)×11″(D). A Peerless 6.5″ woofer, TP165R, was mounted on this ported enclosure along with a Vifa tweeter, D19TD-00. The baffle step was corrected using a larger L than usual in series with the RHS woofer and replacing C_{z} on the LHS woofer with a larger capacitor than usual. A modified Zobel was used on the RHS woofer so that a resistor larger than R_{z} was connected in parallel (FIG. 23). The same resistor was connected in parallel to the LHS woofer.

A phase-unified effective 3^{rd} order crossover was applied to a three-way loudspeaker system, with each loudspeaker using a cabinet with outer dimensions 22″(H)×12″(W)×9.5″(D). An Acoustic Research 8″ woofer, AR1210132-1A, was mounted on this sealed enclosure, along with an Aura 3.5″ midrange, NS35-255-4a, and an Audax 0.375″ tweeter, AMTIW74A8. Zobel circuits were applied to each midrange and woofer, as recommended. The series L on the RHS midrange was omitted because this L is redundant with the midrange Zobel (FIG. 30?).

A phase-unified effective 3^{rd} order crossover was applied to only the woofer-midrange crossover in a three-way loudspeaker system, with each loudspeaker using a cabinet with outer dimensions 23.5″(H)×11.75″(W)×11.75″(D). An Acoustic Research 8″ woofer, AR1210131-2, was mounted on this ported enclosure, along with an unknown 3.5″ midrange and an Audax 0.375″ titanium tweeter, AMTIW74A8. Zobel circuits were applied to each midrange and woofer, as recommended (FIG. 34?).

A phase-unified effective 3^{rd} order crossover was applied to a 2.5-way loudspeaker system, using a d'Appolito configuration in a cabinet with outer dimensions 36.5″(H)×11″(W)×10.75″(D). An Acoustic Research 8″ woofer, AR1210131-2, and a Pioneer 8″ woofer were mounted on this 2 cubic foot enclosure that was ported, along with a Vifa 1″ tweeter, DX25TG0504. Zobel circuits were applied to each midwoofer, as recommended (FIG. 37?).

### CONCLUSION AND SCOPE

Complimentary crossover circuits to reduce phase distortion in groups of loudspeakers is described. In the fundamental embodiment, this technology is applied to a pair of loudspeakers, with each loudspeaker possessing two drivers, a woofer and a tweeter. The “effective third-order” crossover on the right-hand loudspeaker remains “symmetric,” but the “effective third-order” crossover on the left-hand loudspeaker is rendered “asymmetric,” as described. Other embodiments apply this principle to higher crossover orders and greater numbers of drivers. For example, in a loudspeaker system that possesses two drivers, a woofer and a tweeter, the “effective fourth-order” crossover on the right-hand loudspeaker is rendered “asymmetric,” as described, but the “effective fourth-order” crossover on the left-hand loudspeaker remains “symmetric”. This technology can be combined with other circuits like a Zobel, typically used for impedance correction. Some configurations of phase-unified loudspeakers require that a Zobel is applied to all drivers except the tweeter. Accordingly a rule combining effective crossover order and handedness is established.

Having described the invention in detail, those skilled in the art will appreciate that modifications may be made to the invention without departing from its spirit. Therefore, it is not intended that the scope of the invention be limited to the specific embodiments illustrated and described. Rather it is intended that the scope of this invention be determined by the appended claims and their equivalents.

What is claimed is:

1. A method of improving sound reproduction, reducing phase distortion, and improving polar response in a stereophonic or other audio reproduction system having two or more loudspeakers, each of which has two or more drivers including at least one driver reproducing lower frequencies and at least one driver reproducing higher frequencies, said method comprising forming two or more complementary crossover networks that are substantially series in combination with said loudspeakers.

2. The method of improving sound reproduction as claimed in claim 1, further comprising phase unifying said loudspeakers by utilizing an equivalent effective order in said crossover networks in a primarily series fashion, the steps comprising:
selecting a polarity for any of said drivers;
designating the same polarity for each of said drivers; and
designing said loudspeakers to have an approximately equivalent crossover frequency.

3. The method of improving sound reproduction as claimed in claim 2, further comprising phase-unifying a right hand and a left hand two-way loudspeaker, each having at least a woofer and a tweeter and a negative terminal of the tweeter connected to a negative terminal of a power supply, said right hand two-way loudspeaker having a symmetric effective third-order crossover and the left hand two-way loudspeaker having an asymmetric effective third-order crossover,
at least one of said right hand and left hand two-way loudspeakers optionally having at least one of the following:
(a) a Zobel circuit applied to one or both woofer(s) in either of the two-way loudspeakers;
(b) notch filters, twister circuits or circuits to correct a baffle step applied;
(c) Thevenin equivalences; or
(d) any combinations thereof.

4. The method of improving sound reproduction as claimed in claim 2, further comprising phase-unifying a right hand and left hand two-way loudspeaker, each having at least a woofer and a tweeter and a negative terminal of the tweeter connected to a positive terminal of a power supply, said right hand two-way loudspeaker having an asymmetric effective third-order crossover and the left hand two-way loudspeaker having a symmetric effective third-order crossover,
at least one of said right hand and left hand two-way loudspeakers optionally having at least one of the following:
(a) a Zobel circuit applied to one or both woofer(s) in either of the two-way loudspeakers;
(b) notch filters, twister circuits or circuits to correct the baffle step applied;
(c) Thevenin equivalences; or
(d) any combinations thereof.

5. The method of improving sound reproduction as claimed in claim 2, further comprising phase-unifying an effective fourth-order crossover for a right hand and a left hand two-way loudspeaker, each having at least a woofer and a tweeter and a negative terminal of the tweeter connected to a negative terminal of a power supply, said right hand two-way loudspeaker having an asymmetric effective fourth-order crossover and the left hand two-way loudspeaker having a symmetric effective fourth-order crossover,
at least one of said right hand and left hand two-way loudspeakers optionally having at least one of the following:
(a) a Zobel circuit applied to one or both woofer(s) in either of the two-way loudspeakers;
(b) notch filters, twister circuits or circuits to correct the baffle step applied;
(c) Thevenin equivalences; or
(d) any combinations thereof.

6. The method of improving sound reproduction as claimed in claim 2, comprising phase-unifying an effective fourth-order crossover for a right hand and a left hand two-way loudspeaker, each having at least a woofer and a tweeter and a negative terminal of the tweeter connected to a positive terminal of a power supply, with the right hand two-way loudspeaker having a symmetric effective fourth-order crossover and the left hand two-way loudspeaker having an asymmetric effective fourth-order crossover,
at least one of said right hand and left hand two-way loudspeakers optionally having at least one of the following:
(a) a Zobel circuit applied to one or both woofer(s) in either of the two-way loudspeakers;
(b) notch filters, twister circuits or circuits to correct the baffle step applied;
(c) Thevenin equivalences; or
(d) any combinations thereof.

7. The method of improving sound reproduction as claimed in claim 2, comprising phase-unifying an effective fifth-order crossover for a right hand and a left hand two-way loudspeaker, each having at least a woofer and a tweeter and a negative terminal of the tweeter connected to a negative terminal of a power supply, said right hand two-way loudspeaker having a symmetric effective fifth-order crossover and the left hand two-way loudspeaker having an asymmetric effective fifth-order crossover,
at least one of said right hand and left hand two-way loudspeakers optionally having at least one of the following:
(a) a Zobel circuit applied to one or both woofer(s) in either of the two-way loudspeakers;
(b) notch filters, twister circuits or circuits to correct the baffle step applied;
(c) Thevenin equivalences; or
(d) any combinations thereof.

8. The method of improving sound reproduction as claimed in claim 2, further comprising phase-unifying an effective fifth-order crossover for a right hand and a left hand two-way loudspeaker, each having at least a woofer and a tweeter and a negative terminal of the tweeter connected to a positive terminal of a power supply, said right hand two-way loudspeaker having an asymmetric effective fifth-order crossover and the left hand two-way loudspeaker having a symmetric effective fifth-order crossover,
at least one of said right and left hand two-way loudspeakers optionally having at least one of the following:
(a) a Zobel circuit applied to one or both woofer(s) in either of the two-way loudspeakers;
(b) notch filters, twister circuits or circuits to correct the baffle step applied;
(c) Thevenin equivalences; or
(d) any combinations thereof.

9. The method of improving sound reproduction as claimed in claim 2, further comprising phase-unifying a right hand and a left hand two-way loudspeaker, each having at least a woofer and a tweeter and a negative terminal of the tweeter connected to a negative terminal of a power supply, said right hand two-way loudspeaker having a symmetric effective second-order crossover and the left hand two-way loudspeaker having an asymmetric effective second-order crossover,
at least one of said right hand and left hand two-way loudspeakers optionally having at least one of the following:
(a) a Zobel circuit applied to one or both woofer(s) in either of the two-way loudspeakers;
(b) notch filters, twister circuits or circuits to correct a baffle step applied;
(c) Thevenin equivalences; or
(d) any combinations thereof.

10. The method of improving sound reproduction as claimed in claim 2, further comprising phase-unifying a right hand and left hand two-way loudspeaker, each having at least a woofer and a tweeter and a negative terminal of the tweeter connected to a positive terminal of a power supply, said right hand two-way loudspeaker having an asymmetric effective second-order crossover and the left hand two-way loudspeaker having a symmetric effective second-order crossover,
at least one of said right hand and left hand two-way loudspeakers optionally having at least one of the following:
(a) a Zobel circuit applied to one or both woofer(s) in either of the two-way loudspeakers;
(b) notch filters, twister circuits or circuits to correct the baffle step applied;
(c) Thevenin equivalences; or
(d) any combinations thereof.

11. The method of improving sound reproduction as claimed in claim 2, further comprising phase-unifying an effective third-order crossover for a right hand and a left hand three-way loudspeaker, each having at least a woofer, a midrange and a tweeter and a negative terminal of the tweeter connected to a negative terminal of a power supply, with the right hand three-way loudspeaker having a symmetric effective third-order crossover and the left hand three-way loudspeaker having an asymmetric effective third-order crossover;
at least one of said right hand and left hand three-way loudspeakers optionally having at least one of the following:
(a) a Zobel circuit applied to one or both woofer(s) in either of the three-way loudspeakers;
(b) notch filters, twister circuits or circuits to correct the baffle step applied;
(c) Thevenin equivalences; or
(d) any combinations thereof.

12. The method of improving sound reproduction as claimed in claim 2, further comprising phase-unifying an effective third-order crossover for a right hand and a left hand three-way loudspeaker, each having at least a woofer, a midrange and a tweeter and a negative terminal of the tweeter connected to a positive terminal of a power supply, said right hand three-way loudspeaker having an asymmetric effective third-order crossover and the left hand three-way loudspeaker having a symmetric effective third-order crossover,
at least one of said right hand and left hand three-way loudspeakers optionally having at least one of the following:
a) a Zobel circuit applied to one or both woofer(s) in either of the three-way loudspeakers;
(b) notch filters, twister circuits or circuits to correct the baffle step applied;
(c) Thevenin equivalences; or
(d) any combinations thereof.

13. The method of improving sound reproduction as claimed in claim 2, further comprising virtually phase-unifying an effective third-order crossover for a right hand and a left hand three-way loudspeaker, each having at least a woofer, a midrange and a tweeter and a negative terminal of the tweeter connected to a negative terminal of a power supply, with the right hand three-way loudspeaker having a symmetric effective third-order crossover applied near the baffle-step frequency and the left hand three-way loudspeaker having an asymmetric effective third-order crossover applied near the baffle-step frequency; the right hand and the left hand three-way loudspeakers preferably having, but not limited to, a parallel filter applied to the driver remote from the baffle-step frequency and a 1^{st} order electrical crossover applied at a remaining crossover frequency;
at least one of said right hand and left hand three-way loudspeakers optionally having at least one of the following:
(a) a Zobel circuit applied to one or both woofer(s) in either of the three-way loudspeakers;
(b) notch filters, twister circuits or circuits to correct the baffle step applied;
(c) Thevenin equivalences; or
(d) any combinations thereof.

14. The method of improving sound reproduction as claimed in claim 2, further comprising virtually phase-unifying an effective third-order crossover for a right hand and a left hand three-way loudspeaker, each having at least a woofer, a midrange and a tweeter and a negative terminal of the tweeter connected to a positive terminal of a power supply, with the right hand three-way loudspeaker having an asymmetric effective third-order crossover applied near the baffle-step frequency and the left hand three-way loudspeaker having a symmetric effective third-order crossover applied near the baffle-step frequency; the right hand and the left hand three-way loudspeakers preferably having, but not limited to, a parallel filter applied to the driver remote from the baffle-step frequency and a 1^{st} order electrical crossover applied at a remaining crossover frequency;
at least one of said right hand and left hand three-way loudspeakers optionally having at least one of the following:
(a) a Zobel circuit applied to one or both woofer(s) in either of the three-way loudspeakers;
(b) notch filters, twister circuits or circuits to correct the baffle step applied;
(c) Thevenin equivalences; or
(d) any combinations thereof.

15. The method of improving sound reproduction as claimed in claim 2, further comprising phase-unifying an effective third-order crossover for a right hand and a left hand 2.5-way loudspeaker, each having at least a woofer, a midwoofer and a tweeter and a negative terminal of the tweeter connected to a negative terminal of a power supply, with the output of the woofer for a given right hand or left hand 2.5-way loudspeaker about 12 dB below the midwoofer at the phase-unification frequency for that loudspeaker, but otherwise with the right hand 2.5-way loudspeaker having a symmetric effective third-order crossover and the left hand 2.5 loudspeaker having an asymmetric effective third-order crossover;
at least one of said right hand and left hand 2.5 loud speakers optionally having at least one of the following:
(a) a Zobel circuit applied to one or more midwoofer(s) in either of the 2.5-way loudspeakers;
(b) notch filters, twister circuits or circuits to correct the baffle step applied;
(c) Thevenin equivalences; or
(d) any combinations thereof.

16. The method of improving sound reproduction as claimed in claim 2, further comprising phase-unifying an effective third-order crossover for a right hand and a left hand 2.5-way loudspeaker, each having at least a woofer, a midwoofer and a tweeter and a negative terminal of the tweeter connected to a positive terminal of a power supply, with the output of the woofer for a given right hand or left hand 2.5-way loudspeaker about 12 dB below the midwoofer at the phase-unification frequency for that loudspeaker, but otherwise with the right hand 2.5-way loudspeaker having an asymmetric effective third-order crossover and the left hand 2.5-way loudspeaker having a symmetric effective third-order crossover;
at least one of said right hand and left hand 2.5-way loudspeakers optionally having at least one of the following:
(a) a Zobel circuit applied to one or more midwoofer(s) in either of the 2.5-way loudspeakers;
(b) notch filters, twister circuits or circuits to correct the baffle step applied;
(c) Thevenin equivalences; or
(d) any combinations thereof.

17. The method of improving sound reproduction as claimed in claim 2, further comprising phase-unifying an effective third-, fifth-, seventh-, ninth-, eleventh-, or higher odd-numbered order crossover for a right hand and a left hand N-way loudspeakers where N is an integer greater than 1, each having at least a woofer and a tweeter and a negative terminal of the tweeter connected to a negative terminal of a power supply, said right hand N-way loudspeaker having a symmetric effective crossover of the same odd order as the left hand N-way loudspeaker, said left hand N-way loudspeaker having an asymmetric effective crossover,
at least one of the right hand and left hand N-way loudspeakers optionally having at least one of the following:
(a) a Zobel circuit applied to one or both woofer(s) in either of the N-way loudspeakers;
(b) notch filters, twister circuits or circuits to correct the baffle step applied;
(c) Thevenin equivalences; or
(d) any combinations thereof.

18. The method of improving sound reproduction as claimed in claim 2, the steps further comprising phase-unifying an effective third-, fifth-, seventh-, ninth-, eleventh-, or higher odd-numbered order crossover for a right hand and a left hand N-way loudspeaker where N is an integer greater than 1, each having at least a woofer and a tweeter and a negative terminal of the tweeter connected to a positive terminal of a power supply, with the right hand N-way loudspeaker having an asymmetric effective odd order crossover and the left hand N-way loudspeaker having a symmetric effective crossover of the same odd order as the right hand N-way loudspeaker;
at least one of the right hand and left hand N-way loudspeakers optionally having at least one of the following:
(a) a Zobel circuit applied to one or both woofer(s) in either of the N-way loudspeakers;
(b) notch filters, twister circuits or circuits to correct the baffle step applied;
(c) Thevenin equivalences; or
(d) any combinations thereof.

19. The method of improving sound reproduction as claimed in claim 2, further comprising phase-unifying an effective second-, fourth-, sixth-, eighth-, tenth-, or higher even-numbered order crossover for a right hand and a left hand N-way loudspeaker where N is an integer greater than 1, each having at least a woofer and a tweeter and a negative terminal of the tweeter connected to a negative terminal of a power supply, with the right hand N-way loudspeaker having an asymmetric effective even order crossover and the left hand N-way loudspeaker having a symmetric effective crossover of the same even order as the right hand N-way loudspeaker;
at least one of the right hand and left hand N-way loudspeakers optionally having at least one of the following:
(a) a Zobel circuit applied to one or both woofer(s) in either of the N-way loudspeakers;
(b) notch filters, twister circuits or circuits to correct the baffle step applied;
(c) Thevenin equivalences; or
(d) any combinations thereof.

20. The method of improving sound reproduction as claimed in claim 2, further comprising phase-unifying an effective second-, fourth-, sixth-, eighth-, tenth-, or higher even-numbered order crossover for a right hand and a left hand N-way loudspeaker where N is an integer greater than 1, each having at least a woofer and a tweeter and a negative terminal of the tweeter connected to a positive terminal of a power supply, with the right hand N-way loudspeaker having a symmetric effective even order crossover and the left hand N-way loudspeaker having an asymmetric effective crossover of the same even order as the right hand N-way loudspeaker;
at least one of the right hand and left hand N-way loudspeakers optionally having at least one of the following:
(a) a Zobel circuit applied to one or both woofer(s) in either of the N-way loudspeakers;
(b) notch filters, twister circuits or circuits to correct the baffle step applied;
(c) Thevenin equivalences; or
(d) any combinations thereof.

21. The method of improving sound reproduction as claimed in claim 2, further comprising virtually phase-unifying an effective third-, fifth-, seventh-, ninth-, eleventh-, or higher odd-numbered order crossover for a right hand and a left hand N-way loudspeaker where N is an integer greater than 2, each having at least a woofer, a midrange and a tweeter and a negative terminal of the tweeter connected to a negative terminal of a power supply, with the right hand N-way loudspeaker having at least a symmetric effective odd order crossover applied at a crossover frequency near the baffle step frequency and the left hand N-way loudspeaker having at least an asymmetric effective crossover of the same odd order as the right hand N-way loudspeaker applied at a crossover frequency near the baffle step frequency; the right hand N-way loudspeaker and left hand N-way loudspeaker preferably having, but not limited to, parallel filters applied to the drivers remote from the baffle-step frequency and 1^{st} order electrical crossovers applied at remaining crossover frequencies;
at least one of the right hand and left hand N-way loudspeakers optionally having at least one of the following:
(a) a Zobel circuit applied to one or both woofer(s) in either of the pair of N-way loudspeakers;
(b) notch filters, twister circuits or circuits to correct the baffle step applied;
(c) Thevenin equivalences; or
(d) any combinations thereof.

22. The method of improving sound reproduction as claimed in claim 2, further comprising virtually phase-unifying an effective third-, fifth, seventh-, ninth-, eleventh-, or higher odd-numbered order crossover for a right hand and a left hand N-way loudspeaker where N is an integer greater than 2, each having at least a woofer, a midrange and a tweeter and a negative terminal of the tweeter connected to a positive terminal of a power supply, with the right hand N-way loudspeaker having at least an asymmetric effective odd order crossover applied at a crossover frequency near the baffle step frequency and the left hand N-way loudspeaker having at least a symmetric effective crossover of the same odd order as the right hand N-way loudspeaker applied at a crossover frequency near the baffle step frequency; the right hand N-way loudspeaker and left hand N-way loudspeaker preferably having, but not limited to, parallel filters applied to the drivers remote from the baffle-step frequency and 1^{st} order electrical crossovers applied at remaining crossover frequencies;
at least one of the right hand and left hand N-way loudspeakers optionally having at least one of the following:
(a) a Zobel circuit applied to one or both woofer(s) in either of the N-way loudspeakers;
(b) notch filters, twister circuits or circuits to correct the baffle step applied;
(c) Thevenin equivalences; or
(d) any combinations thereof.

23. The method of improving sound reproduction as claimed in claim 2, further comprising virtually phase-unifying an effective second-, fourth-, sixth-, eighth-, tenth-, or higher even-numbered order crossover for a right hand and a left hand N-way loudspeakers where N is an integer greater than 2, each having at least the corresponding number of drivers, including a tweeter, with its negative terminal connected to a negative terminal of a power supply, with the right hand N-way loudspeaker having at least an asymmetric effective even order crossover applied at a crossover frequency near the baffle step frequency and the left hand N-way loudspeaker having at least a symmetric effective crossover of the same even order as the right hand N-way loudspeaker applied at a crossover frequency near the baffle step frequency; the right hand N-way loudspeaker and left hand N-way loudspeaker preferably having, but not limited to, parallel filters applied to the drivers remote from the baffle-step frequency and 1St order electrical crossovers applied at remaining crossover frequencies;
at least one of the right hand and left hand N-way loudspeakers optionally having at least one of the following:
(a) a Zobel circuit applied to one or both woofer(s) in either of the N-way loudspeakers;
(b) notch filters, twister circuits or circuits to correct the baffle step applied;
(c) Thevenin equivalences; or
(d) any combinations thereof.

24. The method of improving sound reproduction as claimed in claim 2, further comprising virtually phase-unifying an effective second-, fourth-, sixth-, eight-, tenth-, or higher even-numbered order crossover for a right hand and a left hand N-way loudspeaker where N is an integer greater than 2, each having at least the corresponding number of drivers, including a tweeter, with its negative terminal connected to a positive terminal of a power supply, with the right hand N-way loudspeaker having at least a symmetric effective even order crossover applied at a crossover frequency near the baffle step frequency and the left hand N-way loudspeaker having at least an asymmetric effective crossover of the same even order as the right hand N-way loudspeaker applied at a crossover frequency near the baffle step frequency; the right hand and left hand N-way loudspeakers preferably having, but not limited to, parallel filters applied to the drivers remote from the baffle-step frequency and 1^{st} order electrical crossovers applied at remaining crossover frequencies;
at least one of the right hand and left hand N-way loudspeakers optionally having at least one of the following:
(a) a Zobel circuit applied to one or both woofer(s) in either of the N-way loudspeakers;
(b) notch filters, twister circuits or circuits to correct the baffle step applied;
(c) Thevenin equivalences; or
(d) any combinations thereof.

25. The method of improving sound reproduction as claimed in claim 2, further comprising virtually phase-unifying an effective third-, fifth-, seventh-, ninth-, eleventh-, or higher odd-numbered order crossover for a right hand and a left hand N.5-way loudspeaker where N is an integer greater than 1, each having at least the corresponding number of drivers, including a tweeter, and a negative terminal of the tweeter connected to a negative terminal of a power supply, with the output of the woofer(s) for a given right hand or left hand N.5-way loudspeaker about 12 dB below the driver(s) that manifest(s) the baffle-step at the phase-unification frequency for that loudspeaker unless the woofer(s) manifest(s) the baffle-step, but otherwise with the right hand N.5-way loudspeaker having at least a symmetric effective odd order crossover applied at a crossover frequency near the baffle step frequency and the left hand N.5-way loudspeaker having at least an asymmetric effective crossover of the same odd order as the right hand N.5-way loudspeaker applied at a crossover frequency near the baffle step frequency; the right hand and left hand N.5-way loudspeakers preferably having, but not limited to, 1^{st} order electrical crossovers applied at remaining crossover frequencies;
at least one of the right hand and left hand N.5-way loudspeakers optionally having at least one of the following:
(a) a Zobel circuit applied to one or more woofer(s), midwoofer(s) or midrange(s), whichever manifests the baffle step, in either of the N.5-way loudspeakers;
(b) notch filters, twister circuits or circuits to correct the baffle step applied;
(c) Thevenin equivalences; or
(d) any combinations thereof.

26. The method of improving sound reproduction as claimed in claim 2, further comprising virtually phase-unifying an effective third-, fifth, seventh-, ninth-, eleventh-, or higher odd-numbered order crossover for a right hand and a left hand N.5-way loudspeaker where N is an integer greater than 1, each having at least the corresponding number of drivers, including a tweeter, and a negative terminal of the tweeter connected to a positive terminal of a power supply, with the output of the woofer(s) for a given right hand or left hand N.5-way loudspeaker about 12 dB below the driver(s) that manifest(s) the baffle-step at the phase-unification frequency for that loudspeaker unless the woofer(s) manifest(s) the baffle-step, but otherwise with the right hand N.5-way loudspeaker having at least an asymmetric effective odd order crossover applied at a crossover frequency near the baffle step frequency and the left hand N.5-way loudspeaker having at least a symmetric effective crossover of the same odd order as the right hand N.5-way loudspeaker applied at a crossover frequency near the baffle step frequency; the right hand and left hand N.5-way loudspeakers preferably having, but not limited to, 1^{st} order electrical crossovers applied at remaining crossover frequencies;
at least one of the right hand and left hand N.5-way loudspeakers optionally having at least one of the following:
(a) a Zobel circuit applied to one or more woofer(s), midwoofer(s) or midrange(s), whichever manifests the baffle step, in either of the N.5-way loudspeakers;
(b) notch filters, twister circuits or circuits to correct the baffle step applied;
(c) Thevenin equivalences; or
(d) any combinations thereof.

27. The method of improving sound reproduction as claimed in claim 2, further comprising virtually phase-unifying an effective second-, fourth-, sixth-, eighth-, tenth-, or higher even-numbered order crossover for a right hand and left hand N.5-way loudspeaker where N is an integer greater than 1, each having at least the corresponding number of drivers, including a tweeter, and a negative terminal of the tweeter connected to a negative terminal of a power supply, with the output of the woofer(s) for a given right hand or left hand N.5-way loudspeaker about 12 dB below the driver(s) that manifest(s) the baffle-step at the phase-unification frequency for that loudspeaker unless the woofer(s) manifest(s) the baffle-step, but otherwise with the right hand N.5-way loudspeaker having at least an asymmetric effective even order crossover applied at a crossover frequency near the baffle step frequency and the left hand N.5-way loudspeaker having at least a symmetric effective crossover of the same even order as the right hand N.5-way loudspeaker applied at a crossover frequency near the baffle step frequency; the right hand and left hand N.5-way loudspeakers having, but not limited to, 1^{st} order electrical crossovers applied at remaining crossover frequencies;
at least one of the right and left hand N.5-way loudspeakers optionally having at least one of the following:
(a) a Zobel circuit applied to one or more woofer(s), midwoofer(s) or midrange(s), whichever manifests the baffle step, in either of the N.5-way loudspeakers;
(b) notch filters, twister circuits or circuits to correct the baffle step applied;
(c) Thevenin equivalences; or
(d) any combinations thereof.

28. The method of improving sound reproduction as claimed in claim 2, further comprising virtually phase-unifying an effective second-, fourth-, sixth-, eight-, tenth-, or higher even-numbered order crossover for a right hand and a left hand N.5-way loudspeaker where N is an integer greater than 1, each having at least the corresponding number of drivers, including a tweeter, and the negative terminal of the tweeter connected to the positive terminal of the power supply, with the output of the woofer(s) for a given right hand or left hand N.5-way loudspeaker about 12 dB below the driver(s) that manifest(s) the baffle-step at the phase-unification frequency for that loudspeaker unless the woofer(s) manifest(s) the baffle-step, but otherwise with the right hand N.5-way loudspeaker having at least a symmetric effective even order crossover applied at a crossover frequency near the baffle step frequency and the left hand N.5-way loudspeaker having at least an asymmetric effective crossover of the same even order as the right hand N.5-way loudspeaker applied at a crossover frequency near the baffle step frequency; the right hand and left hand N.5-way loudspeakers having, but not limited to, 1^{st} order electrical crossovers applied at the remaining crossover frequencies;
at least one of the right and left N.5-way loudspeakers optionally having at least one of the following:
(a) a Zobel circuit applied to one or more woofer(s), midwoofer(s) or midrange(s), whichever manifests the baffle step, in either of the N.5-way loudspeakers;
(b) notch filters, twister circuits or circuits to correct the baffle step applied;
(c) Thevenin equivalences; or
(d) any combinations thereof.

29. The method of improving sound reproduction as claimed in claim 1, further comprising phase unifying said loudspeakers, configured as line arrays, by utilizing an equivalent effective order in said crossover networks in a primarily parallel fashion, the steps comprising:
selecting a polarity for any of said drivers or driver arrays;
designating the same polarity for each of said drivers or driver arrays; and
designing said loudspeakers to have an approximately equivalent crossover frequency.

30. The method of improving sound reproduction as claimed in claim 29, further comprising phase-unifying an effective third-, fifth-, seventh-, ninth-, eleventh-, or higher odd-numbered order crossover for a right hand and a left hand N-way loudspeakers where N is an integer greater than 1, each having at least a woofer and a tweeter and a negative terminal of the tweeter connected to a negative terminal of a power supply, said right hand N-way loudspeaker having a symmetric effective crossover of the same odd order as the left hand N-way loudspeaker, said left hand N-way loudspeaker having an asymmetric effective crossover,
at least one of the right hand and left hand N-way loudspeakers optionally having at least one of the following:
(a) a Zobel circuit applied to one or both woofer(s) or woofer array(s) in either of the N-way loudspeakers;
(b) notch filters, twister circuits or circuits to correct the baffle step applied;
(c) Thevenin equivalences; or
(d) any combinations thereof.

31. The method of improving sound reproduction as claimed in claim 29, the steps further comprising phase-unifying an effective third-, fifth-, seventh-, ninth-, eleventh-, or higher odd-numbered order crossover for a right hand and a left hand N-way loudspeaker where N is an integer greater than 1, each having at least a woofer and a tweeter and a negative terminal of the tweeter connected to a positive terminal of a power supply, with the right hand N-way loudspeaker having an asymmetric effective odd order crossover and the left hand N-way loudspeaker having a symmetric effective crossover of the same odd order as the right hand N-way loudspeaker;
at least one of the right hand and left hand N-way loudspeakers optionally having at least one of the following:
(a) a Zobel circuit applied to one or both woofer(s) or woofer array(s) in either of the N-way loudspeakers;
(b) notch filters, twister circuits or circuits to correct the baffle step applied;
(c) Thevenin equivalences; or
(d) any combinations thereof.

32. The method of improving sound reproduction as claimed in claim 29, further comprising phase-unifying an effective second-, fourth-, sixth-, eighth-, tenth-, or higher even-numbered order crossover for a right hand and a left hand N-way loudspeaker where N is an integer greater than 1, each having at least a woofer and a tweeter and a negative terminal of the tweeter connected to a negative terminal of a power supply, with the right hand N-way loudspeaker having an asymmetric effective even order crossover and the left hand N-way loudspeaker having a symmetric effective crossover of the same even order as the right hand N-way loudspeaker;
at least one of the right hand and left hand N-way loudspeakers optionally having at least one of the following:
(a) a Zobel circuit applied to one or both woofer(s) or woofer array(s) in either of the N-way loudspeakers;
(b) notch filters, twister circuits or circuits to correct the baffle step applied;
(c) Thevenin equivalences; or
(d) any combinations thereof.

33. The method of improving sound reproduction as claimed in claim 29, further comprising phase-unifying an effective second-, fourth-, sixth-, eighth-, tenth-, or higher even-numbered order crossover for a right hand and a left hand N-way loudspeaker where N is an integer greater than 1, each having at least a woofer and a tweeter and a negative terminal of the tweeter connected to a positive terminal of a power supply, with the right hand N-way loudspeaker having a symmetric effective even order crossover and the left hand N-way loudspeaker having an asymmetric effective crossover of the same even order as the right hand N-way loudspeaker;
at least one of the right hand and left hand N-way loudspeakers optionally having at least one of the following:
(a) a Zobel circuit applied to one or both woofer(s) or woofer array(s) in either of the N-way loudspeakers;
(b) notch filters, twister circuits or circuits to correct the baffle step applied;
(c) Thevenin equivalences; or
(d) any combinations thereof.

34. The method of improving sound reproduction as claimed in claim 29, further comprising virtually phase-unifying an effective third-, fifth-, seventh-, ninth-, eleventh-, or higher odd-numbered order crossover for a right hand and a left hand N-way loudspeaker where N is an integer greater than 2, each having at least a woofer, a midrange and a tweeter and a negative terminal of the tweeter connected to a negative terminal of a power supply, with the right hand N-way loudspeaker having at least a symmetric effective odd order crossover applied at a crossover frequency near the baffle step frequency and the left hand N-way loudspeaker having at least an asymmetric effective crossover of the same odd order as the right hand N-way loudspeaker applied at a crossover frequency near the baffle step frequency; the right hand N-way loudspeaker and left hand N-way loudspeaker preferably having, but not limited to, parallel filters applied to the drivers remote from the baffle-step frequency and 1^{st} order electrical crossovers applied at remaining crossover frequencies;
at least one of the right hand and left hand N-way loudspeakers optionally having at least one of the following:
(a) a Zobel circuit applied to one or both woofer(s) or woofer array(s) in either of the pair of N-way loudspeakers;
(b) notch filters, twister circuits or circuits to correct the baffle step applied;
(c) Thevenin equivalences; or
(d) any combinations thereof.

35. The method of improving sound reproduction as claimed in claim 29, further comprising virtually phase-unifying an effective third-, fifth, seventh-, ninth-, eleventh-, or higher odd-numbered order crossover for a right hand and a left hand N-way loudspeaker where N is an integer greater than 2, each having at least a woofer, a midrange and a tweeter and a negative terminal of the tweeter connected to a positive terminal of a power supply, with the right hand N-way loudspeaker having at least an asymmetric effective odd order crossover applied at a crossover frequency near the baffle step frequency and the left hand N-way loudspeaker having at least a symmetric effective crossover of the same odd order as the right hand N-way loudspeaker applied at a crossover frequency near the baffle step frequency; the right hand N-way loudspeaker and left hand N-way loudspeaker preferably having, but not limited to, parallel filters applied to the drivers remote from the baffle-step frequency and 1^{st} order electrical crossovers applied at remaining crossover frequencies;
at least one of the right hand and left hand N-way loudspeakers optionally having at least one of the following:
(a) a Zobel circuit applied to one or both woofer(s) or woofer array(s) in either of the N-way loudspeakers;
(b) notch filters, twister circuits or circuits to correct the baffle step applied;
(c) Thevenin equivalences; or
(d) any combinations thereof.

36. The method of improving sound reproduction as claimed in claim 29, further comprising virtually phase-unifying an effective second-, fourth-, sixth-, eighth-, tenth-, or higher even-numbered order crossover for a right hand and a left hand N-way loudspeakers where N is an integer greater than 2, each having at least the corresponding number of drivers, including a tweeter, with its negative terminal connected to a negative terminal of a power supply, with the right hand N-way loudspeaker having at least an asymmetric effective even order crossover applied at a crossover frequency near the baffle step frequency and the left hand N-way loudspeaker having at least a symmetric effective crossover of the same even order as the right hand N-way loudspeaker applied at a crossover frequency near the baffle step frequency; the right hand N-way loudspeaker and left hand N-way loudspeaker preferably having, but not limited to, parallel filters applied to the drivers remote from the baffle-step frequency and 1^{st} order electrical crossovers applied at remaining crossover frequencies;
at least one of the right hand and left hand N-way loudspeakers optionally having at least one of the following:
(a) a Zobel circuit applied to one or both woofer(s) or woofer array(s) in either of the N-way loudspeakers;
(b) notch filters, twister circuits or circuits to correct the baffle step applied;
(c) Thevenin equivalences; or
(d) any combinations thereof.

37. The method of improving sound reproduction as claimed in claim 29, further comprising virtually phase-unifying an effective second-, fourth-, sixth-, eight-, tenth-, or higher even-numbered order crossover for a right hand and a left hand N-way loudspeaker where N is an integer greater than 2, each having at least the corresponding number of drivers, including a tweeter, with its negative terminal connected to a positive terminal of a power supply, with the right hand N-way loudspeaker having at least a symmetric effective even order crossover applied at a crossover frequency near the baffle step frequency and the left hand N-way loudspeaker having at least an asymmetric effective crossover of the same even order as the right hand N-way loudspeaker applied at a crossover frequency near the baffle step frequency; the right hand and left hand N-way loudspeakers preferably having, but not limited to, parallel filters applied to the drivers remote from the baffle-step frequency and 1^{st} order electrical crossovers applied at remaining crossover frequencies;
at least one of the right hand and left hand N-way loudspeakers optionally having at least one of the following:
(a) a Zobel circuit applied to one or both woofer(s) or woofer array(s) in either of the N-way loudspeakers;
(b) notch filters, twister circuits or circuits to correct the baffle step applied;
(c) Thevenin equivalences; or
(d) any combinations thereof.

38. The method of improving sound reproduction as claimed in claim 29, further comprising virtually phase-unifying an effective third-, fifth-, seventh-, ninth-, eleventh-, or higher odd-numbered order crossover for a right hand and a left hand N.5-way loudspeaker where N is an integer greater than 1, each having at least the corresponding number of drivers, including a tweeter, and a negative terminal of the tweeter connected to a negative terminal of a power supply, with the output of the woofer(s) or woofer array(s) for a given right hand or left hand N.5-way loudspeaker about 12 dB below the driver(s) that manifest(s) the baffle-step at the phase-unification frequency for that loudspeaker unless the woofer(s) or woofer array(s) manifest(s) the baffle-step, but otherwise with the right hand N.5-way loudspeaker having at least a symmetric effective odd order crossover applied at a crossover frequency near the baffle step frequency and the left hand N.5-way loudspeaker having at least an asymmetric effective crossover of the same odd order as the right hand N.5-way loudspeaker applied at a crossover frequency near the baffle step frequency; the right hand and left hand N.5-way loudspeakers preferably having, but not limited to, 1^{st} order electrical crossovers applied at remaining crossover frequencies;
at least one of the right hand and left hand N.5-way loudspeakers optionally having at least one of the following:
(a) a Zobel circuit applied to one or more woofer(s) or woofer array(s), midwoofer(s) or midwoofer array(s), or midrange(s) or midrange array(s), whichever manifests the baffle step, in either of the N.5-way loudspeakers;
(b) notch filters, twister circuits or circuits to correct the baffle step applied;
(c) Thevenin equivalences; or
(d) any combinations thereof.

39. The method of improving sound reproduction as claimed in claim 29, further comprising virtually phase-unifying an effective third-, fifth, seventh-, ninth-, eleventh-, or higher odd-numbered order crossover for a right hand and a left hand N.5-way loudspeaker where N is an integer greater than 1, each having at least the corresponding number of drivers, including a tweeter, and a negative terminal of the tweeter connected to a positive terminal of a power supply, with the output of the woofer(s) or woofer array(s) for a given right hand or left hand N.5-way loudspeaker about 12 dB below the driver(s) that manifest(s) the baffle-step at the phase-unification frequency for that loudspeaker unless the woofer(s) or woofer array(s) manifest(s) the baffle-step, but otherwise with the right hand N.5-way loudspeaker having at least an asymmetric effective odd order crossover applied at a crossover frequency near the baffle step frequency and the left hand N.5-way loudspeaker having at least a symmetric effective crossover of the same odd order as the right hand N.5-way loudspeaker applied at a crossover frequency near the baffle step frequency; the right hand and left hand N.5-way loudspeakers preferably having, but not limited to, 1^{st} order electrical crossovers applied at remaining crossover frequencies;
at least one of the right hand and left hand N.5-way loudspeakers optionally having at least one of the following:
(a) a Zobel circuit applied to one or more woofer(s) or woofer array(s), midwoofer(s) or midwoofer array(s), or midrange(s) or midrange array(s), whichever manifests the baffle step, in either of the N.5-way loudspeakers;
(b) notch filters, twister circuits or circuits to correct the baffle step applied;
(c) Thevenin equivalences; or
(d) any combinations thereof.

40. The method of improving sound reproduction as claimed in claim 29, further comprising virtually phase-unifying an effective second-, fourth-, sixth-, eighth-, tenth-, or higher even-numbered order crossover for a right hand and left hand N.5-way loudspeaker where N is an integer greater than 1, each having at least the corresponding number of drivers, including a tweeter, and a negative terminal of the tweeter connected to a negative terminal of a power supply, with the output of the woofer(s) or woofer array(s) for a given right hand or left hand N.5-way loudspeaker about 12 dB below the driver(s) that manifest(s) the baffle-step at the phase-unification frequency for that loudspeaker unless the woofer(s) or woofer array(s) manifest(s) the baffle-step, but otherwise with the right hand N.5-way loudspeaker having at least an asymmetric effective even order crossover applied at a crossover frequency near the baffle step frequency and the left hand N.5-way loudspeaker having at least a symmetric effective crossover of the same even order as the right hand N.5-way loudspeaker applied at a crossover frequency near the baffle step frequency; the right hand and left hand N.5-way loudspeakers having, but not limited to, 1^{st} order electrical crossovers applied at remaining crossover frequencies;
at least one of the right and left hand N.5-way loudspeakers optionally having at least one of the following:
(a) a Zobel circuit applied to one or more woofer(s) or woofer array(s), midwoofer(s) or midwoofer array(s), or midrange(s) or midrange array(s), whichever manifests the baffle step, in either of the N.5-way loudspeakers;
(b) notch filters, twister circuits or circuits to correct the baffle step applied;
(c) Thevenin equivalences; or
(d) any combinations thereof.

41. The method of improving sound reproduction as claimed in claim 29, further comprising virtually phase-unifying an effective second-, fourth-, sixth-, eight-, tenth-, or higher even-numbered order crossover for a right hand and a left hand N.5-way loudspeaker where N is an integer greater than 1, each having at least the corresponding number of drivers, including a tweeter, and the negative terminal of the tweeter connected to the positive terminal of the power supply, with the output of the woofer(s) or woofer array(s) for a given right hand or left hand N.5-way loudspeaker about 12 dB below the driver(s) that manifest(s) the baffle-step at the phase-unification frequency for that loudspeaker unless the woofer(s) or woofer array(s) manifest(s) the baffle-step, but otherwise with the right hand N.5-way loudspeaker having at least a symmetric effective even order crossover applied at a crossover frequency near the baffle step frequency and the left hand N.5-way loudspeaker having at least an asymmetric effective crossover of the same even order as the right hand N.5-way loudspeaker applied at a crossover frequency near the baffle step frequency; the right hand and left hand N.5-way loudspeakers having, but not limited to, 1^{st} order electrical crossovers applied at remaining crossover frequencies;
at least one of the right and left N.5-way loudspeakers optionally having at least one of the following:
(a) a Zobel circuit applied to one or more woofer(s) or woofer array(s), midwoofer(s) or midwoofer array(s), or midrange(s) or midrange array(s), whichever manifests the baffle step, in either of the N.5-way loudspeakers;
(b) notch filters, twister circuits or circuits to correct the baffle step applied;
(c) Thevenin equivalences; or
(d) any combinations thereof.
